(19) United States
(12) Patent Application Publication
(10) Pub. No.: US 2025/0095261 A1
(43) Pub. Date: Mar. 20, 2025

(54) SYSTEM AND METHOD FOR RUNTIME RETARGETING

(71) Applicant: Take-Two Interactive Software, Inc., New York, NY (US)

(72) Inventors: Eray MOLLA, London (GB); Peter James SANDILANDS, Edinburgh (GB); James Stuart MILLER, New York, NY (US); Ahmad ABDUL KARIM, Edinburgh (GB); Mark William TENNANT, Toronto (CA); Frank David KOZUH, Georgetown (CA); Colin John GRAHAM, Burlington (CA)

(21) Appl. No.: 18/885,149

(22) Filed: Sep. 13, 2024

Related U.S. Application Data
(60) Provisional application No. 63/583,144, filed on Sep. 15, 2023.

(51) Int. Cl. G06T 13/40

(52) U.S. Cl. CPC G06T 13/40

(57) ABSTRACT

The runtime retargeting approaches discussed herein can enable real time adaptation of character and object motion. In particular, fixed-source motion can be dynamically adjusted to variable situations encountered during runtime. In this way, the runtime retargeting approaches discussed herein can preserve the intent, visual quality, and essence of such fixed-source motion, while modifying it to meet new physical constraints or goals.

### CROSS-REFERENCE TO RELATED APPLICATIONS

This application claims priority to U.S. Provisional Patent Application No. 63/583,144 entitled “SYSTEM AND METHOD FOR RUNTIME RETARGETING,” which was filed on Sep. 15, 2023, the disclosure of which is herein incorporated by reference in its entirety and for all purposes.

### FIELD

The present disclosure relates generally to video games, including methods and systems to implement the same, and, more specifically, but not exclusively, to video game systems and methods for rendering in-game objects, including characters, and controlling animation of characters and non-player characters.

### BACKGROUND

Computer games often comprise a graphically rendered three-dimensional (3D) space that represents a virtual world in which the players play the game. This virtual world is typically filled with objects, e.g., characters, rooms, vehicles, items, and environments that are used to create the scene for the game. For example, a game set in a modern-day city would have a virtual world populated with objects like buildings, cars, people, etc. Similarly, a game set in medieval Europe might be populated with knights, serfs, castles, horses, etc. As the 3D spaces that these games inhabit have become larger and more complex, the task of controlling their motion has become challenging, both computationally and in terms of the effort required to design and individually manage the movement of a large variety of objects.

The way a character or a non-player character (NPC) moves around in the game world is one of the most important aspects of a smooth gaming experience and, often, is the foundation for all other animations added to the character. Fluid, responsive, and natural movements go unnoticed. However, jittery, slow, and unrealistic motions can take users out of the virtual experience and ruin an otherwise good game.

According to conventional approaches, a developer takes an animation in a runtime and alters it for application to multiple differently sized/proportioned characters, different object configurations (e.g., car or weapon models), or different environmental situations. To the extent that conventional animation authoring packages provide approaches for basic offline retargeting (for example, of character proportions), these approaches are too expensive to use in a real-time or online environment. Also, such conventional approaches typically require iterative manual interaction from an animator to refine generated retargeted output motion. In at least this way, these conventional approaches are not applicable to in-game use cases, where the motion generated for a given novel dynamic situation is to be displayed immediately. Further still, to the extent that certain existing games include runtime retargeting functionality, such functionality is very basic, highly limited/piecemeal in its scope, and yields poor quality results in contrast to the runtime retargeting approaches discussed herein.

Further still, while existing approaches, at best, provide for retargeting in isolated contexts (e.g., for melee retargeting), the runtime retargeting approaches discussed herein provide for comprehensive and large scale retargeting, and as part of a whole production solution. As just some examples, the approaches discussed herein provide not only for melee retargeting, but for all necessary and complex interactions. As such, the approaches discussed herein allow retargeting to be applied to scenarios including but not limited to melee, weapon aiming, item interaction, vehicle ingress, locomotion, and swimming. Moreover, the approaches discussed herein provide a uniform production pipeline and gameplay interfaces, without, for instance, requiring bespoke pipelines, solutions, or solvers.

Also, to the extent that conventional approaches use constraints, such constraints are used differently and more restrictively than the constraints discussed herein. For example, these conventional constraints are generally limited in application to inverse kinematics (IK) and attachments. In particular, such conventional constraints, at best, are merely fixed relationships between bones and certain specific spaces (e.g., world or parent) that can be precomputed/baked. In contrast, according to the functionality discussed herein, constraints can provide dynamically computed relationships (e.g., between surface shapes, bones, and/or entity transforms). Moreover, such conventional constraints do not appear to support trajectories or dynamically varying relationships captured from interactions with other entities providing such degree of flexibility and fidelity, especially for precise interactions concerning volume surfaces. Further still, such conventional constraints fail to provide priority systems, and fail to provide the flexibility of the deepest ascendent. Accordingly, when using such conventional constraints, the ability to resolve and arbitrate competing constraints is significantly lowered. Further still, because such conventional constraints lack offline calculation and trajectory storage capabilities, the ability to dynamically retarget at runtime is significantly lowered for complex situations.

In view of the foregoing, a need exists for an improved system for animating and controlling the motion of in-game objects in an effort to overcome the aforementioned obstacles and deficiencies of conventional video game systems.

### SUMMARY

The runtime retargeting approaches discussed herein can enable real time adaptation of character and object motion. In some embodiments, fixed-source motion can be dynamically adjusted to variable situations encountered during runtime. In this way, the runtime retargeting approaches can preserve the intent, visual quality, and essence of such fixed-source motion, while modifying it to meet new physical constraints or goals.

Also, the runtime retargeting approaches discussed herein, when compared to conventional approaches, can allow for far fewer base animations to be captured or authored. As such, a substantial development productivity boost can be realized. Further still, the runtime retargeting approaches discussed herein can allow dynamic variation encountered in a game to be accounted for. Accordingly, a significant increase in visual realism for a game can be realized. For instance, much more natural variation can be possible in a game, compared to conventional approaches that are forced to restrict themselves to limited sets of pre-defined configurations for characters and objects. Further, the runtime retargeting approaches discussed herein can provide in a runtime game engine a constraint solver/arbitration mechanism that provides complex functionality while still being performant real time. Further still, the runtime retargeting approaches discussed herein can provide, in assets, tools, and pipelines, a large collection of specialized metadata markup. Such specialized metadata markup can yield benefits including but not limited to: a) enabling developers and automated processes to ascertain original intents of motion and situation; and b) providing artistic control over how any adaptations are performed.

In an aspect, the runtime retargeting approaches discussed herein use animation constraints. Animation constraints can be used for purposes including in game pose adaptation. Animation constraints can provide a rich language usable for expressing semantics of ongoing in game interactions. In this way, spatial and temporal relationships between interacting entities and their body parts can be reproduced and enforced on entities with varying sizes, thicknesses, and proportions. Likewise, variation in interacted environment geometric properties can be supported. The language provided by animation constraints can express both interacting entities and their body parts in an explorable way. As such, benefits include allowing for the introduction of improved solutions for: a) multicharacter interactions; and b) efficient storage and posing of interaction bounds (discussed below) can be realized. Also discussed herein are approaches for authoring animation constraints. According to these approaches, constraints for complex interactions can be authored and produced at scale and in consistent ways. More generally, the language provided by animation constraints is a generic and explorable language that can describe interactions and their corresponding constraint coordinates and trajectories.

In another aspect, the runtime retargeting approaches discussed herein use interaction bounds. Tackling close contact interactions typically requires knowledge of the volume surface characteristics of the interacted entities. For instance, to retarget a belly touch animation from an overweight character to a slimmer one, there is typically call for knowledge of the belly surface on the overweight character to identify the contact between its hand and belly, and also knowledge of the matching belly surface on the slimmer character to be able to map the interaction. These issues can be addressed via use of the noted interaction bounds. As just an example, interaction bounds (and the organisation thereof) is applicable to asset production scaling.

Further, via the use of interaction bound archetypes and instances, solutions are provided to both produce interchangeable assets consistently, and also to identify them easily in game. Moreover, as discussed herein, interaction bounds can have both: a) ids that provide unique identifiers; and b) affordance descriptors that can be shared across multiple bounds of an entity. In this way, interaction bounds can be referred to by animation constraints as a part of the constraint language. The organization of interaction bounds and their use through the noted animation constraints allow not only for flexible sharing of animation assets across different entities, but also for their efficient storage and posing. In at least this way, interaction bounds are distinguished from, for instance, conventional bounds used by physics systems.

In an aspect, animation constraints can, as discussed herein, make use of constraints spaces to refer to parts of an entity using interaction bounds. In a further aspect, circumstances can arise where: a) there is call to handle sections of environment geometry (e.g., ground); or b) there is call to handle an entity that is not known in advance and whose definition is flexibly left to the game (e.g., a general handle). Such interactions can be addressed via the use of alias entities, as discussed hereinbelow. This abstraction can yield benefits including allowing gameplay development teams to make in-game choices that drive the state of these alias entities, without limiting the interactions to predefined entities such as human-like-characters.

To be able to compute the spatiotemporal relationships that animation constraints enforce in a game, there is typically a call to reproduce a corresponding original interaction in a tools pipeline so that the computed relationship offsets can be precomputed/baked. As discussed herein, such can be achieved via the use of clip environments. A clip environment can define: a) the entities involved in an interaction (e.g., their skeletons, corresponding interaction bounds information, and/or the animation scripts (e.g., AnimScript—a scripting language to modify the pose and parameters of animations offline or at runtime) to play on them); b) their role IDs; and c) the animations they are playing (and any attachment relationships).

The runtime retargeting approaches discussed herein can also provide interaction groups and default interaction groups. Here, retargeting an original interaction fully in a game can utilize the role ids presented in the corresponding clip environment. Further, these role ids can be defined in the game as the members of the same interaction group (or the default interaction group) of the entities to retarget. In this way, the participants of the ongoing interactions can be disambiguated, and the necessary pose adjustments can be done for retargeting purposes in the game.

The runtime retargeting approaches discussed herein can additionally provide a runtime constraints solver to enforce animation constraints in a game. The runtime constraints solver can validate the constraints based on conditions such as animation systems level of detail (LOD) in the game. The runtime constraints solver can further ensure that constraint spaces and normalized coordinates are mapped onto involved characters correctly. Then, based on this, the constraints can be arbitrated taking their priorities into account, and the resulting pose adaptations can be computed without compromising resulting motion continuity. It is noted that the runtime constraints solver is not limited to human-like characters and animals. Instead, as just some examples, the runtime constraints solver can also be used in the retargeting of attachment props, entity movers, and cameras.

Moreover, the runtime retargeting approaches discussed herein can provide interaction island functionality. In particular, the runtime retargeting approaches discussed herein can handle multi-character interaction by making use of interaction islands and their simultaneous solves. An interaction island can involve a set of characters whose pose computations depend on each other based on relationships explored through animation constraints. Interaction islands can be computed based on animation constraints, and can then be used to organize solve scheduling. In this way, the runtime constraints solver can be extended to multi-character, simultaneous pose adaptation, and also used with runs of individual blend trees on involved entities.

The animation constraints discussed herein can be used in conjunction with offline authoring. Further, these animation constraints can be added by gameplay systems. Having animation constraints added by gameplay systems can be useful, for instance, where game state knowledge is called for to inject bespoke constraints. As discussed herein, gameplay systems can use a provided API to add new animation constraints.

Further still, the runtime retargeting approaches discussed herein can provide constraint label and constraint query functionality. In this way, gameplay systems can query existing animation constraints based on specified conditions, and can block or intervene in constraint processing.

Various aspects of runtime retargeting will now be discussed in greater detail. These aspects include: a) offline processing, which can offer benefits including fostering understanding; b) online processing, which can offer benefits providing for specialisation and application; and c) testing and quality assurance (QA). It is noted that, as used herein throughout, the terms “user” and “users” (and like terms) can variously refer to either and/or both of human users (e.g., developers) and process users, as just some examples.

### BRIEF DESCRIPTION OF THE DRAWINGS

FIG. 1 is an exemplary diagram illustrating an embodiment of standard and high precision interaction bounds.

FIG. 2 is an exemplary flow diagram illustrating an embodiment of a method which authored script inputs, skeleton pose inputs, and retargeting constraint inputs can lead to interaction bounds updates that are used by a retargeting resolver.

FIG. 3 is an exemplary graphical user interface illustrating one embodiment of a clip environment file viewer.

FIG. 4 is an exemplary flowchart illustrating an embodiment of a tools pipeline used for in-game animation.

FIG. 5 is an exemplary diagram illustrating a constraint lifespan in a clip where the constraint's begin phase and end phases are expressed as a percentage of the clip's duration.

FIG. 6 is an exemplary top-level diagram illustrating one embodiment of a clip with multiple constraints.

FIG. 7 is an exemplary diagram illustrating an embodiment of ease-in and ease-out phases on a sample constraint.

FIG. 8 is an exemplary diagram illustrating an embodiment of decomposition of aim coordinates in a source interaction and its composition on a target interaction to retarget.

FIG. 9 is an exemplary diagram illustrating an embodiment of different deviations between the goal position to aim at and the aim parent space's origin.

FIG. 10 is an exemplary diagram illustrating an embodiment of normalised surface coordinates mapping on boxes and spheres.

FIG. 11 is an exemplary diagram illustrating an embodiment of axis coordinates mapped from one box to another.

FIG. 12 is an exemplary diagram illustrating an embodiment of projection coordinates obtained by computing the closest point from a point to the surface of the given primitive.

FIG. 13 is an exemplary diagram illustrating an embodiment of customisable coordinates computation and mapping steps.

FIG. 14 is an exemplary diagram illustrating an embodiment of decomposition steps of a given position trajectory based on the surface volume of a given shape.

FIG. 15 is an exemplary diagram illustrating an embodiment of position trajectory composition steps.

FIG. 16 is an exemplary diagram illustrating an embodiment of Trajectory storage steps.

FIG. 17 is an exemplary diagram illustrating an embodiment of a trajectory querying and composing example for phase value 0.35.

FIG. 18A is an exemplary graphical user interface illustrating an embodiment of a ClipEditor metadata authoring tool.

FIG. 18B is an exemplary graphical user interface illustrating another embodiment of a ClipEditor metadata authoring tool.

FIG. 19 is an exemplary graphical user interface illustrating an embodiment of a tag template authoring tool.

FIG. 20 is an exemplary graphical user interface illustrating an embodiment of a camera screen space authoring tool.

FIG. 21 is an exemplary flow diagram illustrating an embodiment of a process for scheduling interaction islands solve and individual blend trees.

FIG. 22 is an exemplary flow diagram illustrating an embodiment of an interaction Island solve.

FIG. 23 is an exemplary flow diagram illustrating an embodiment of a pose adaptation algorithm flow.

FIG. 24 is an exemplary flow diagram illustrating an embodiment of a pose adaptation flow for a human like character.

FIG. 25 is an exemplary diagram illustrating an embodiment of cyclic constraints between left and right hands.

FIG. 26 is an exemplary diagram illustrating an embodiment of desired error-based constraint activation.

FIG. 27 is an exemplary diagram illustrating an embodiment of attachment bone offset fixup for the left hand.

FIG. 28 is an exemplary diagram illustrating an embodiment of progressive activation constraints within resistance zone explained on a half space constraint where the arrow points at the valid side of the constraint.

FIG. 29 is an exemplary flow diagram illustrating an embodiment of a process for mover retargeting operations.

FIG. 30 is an exemplary diagram illustrating an embodiment of transitions between the animated state of an end effector and the desired, retarget state.

FIG. 31 is an exemplary flow diagram illustrating an embodiment of a process for using continuous input to result in temporarily consistent poses.

FIG. 32 is an exemplary state diagram illustrating an embodiment of the state transitions of temporal data to provide the pose adaptation algorithm with continuous inputs.

FIG. 33 is an exemplary diagram illustrating an embodiment of error for a position constraint.

FIG. 34 is an exemplary diagram illustrating an embodiment of error for a position region constraint.

FIG. 35 is an exemplary diagram illustrating an embodiment of error for an orientation constraint.

FIG. 36 is an exemplary diagram illustrating an embodiment of error for an orientation region constraint.

FIG. 37 is an exemplary diagram illustrating an embodiment of error for an aim constraint.

FIG. 38 is an exemplary diagram illustrating an embodiment of error for an aim region constraint.

FIG. 39 is an exemplary diagram illustrating an embodiment of error for a limb length constraint error on an arm.

FIG. 40 is an exemplary flow diagram illustrating an embodiment of the data disambiguation process using interaction groups on a melee example.

FIG. 41 is an exemplary diagram illustrating an embodiment of a network gaming environment including at least one peer device for implementing the runtime retargeting system.

It should be noted that the figures are not drawn to scale and that elements of similar structures or functions are generally represented by like reference numerals for illustrative purposes throughout the figures. It also should be noted that the figures are only intended to facilitate the description of the preferred embodiments. The figures do not illustrate every aspect of the described embodiments and do not limit the scope of the present disclosure.

### DETAILED DESCRIPTION OF THE PREFERRED EMBODIMENTS

Because conventional video game systems cannot enable real time adaptation of character and object motion, an improved video game system that can dynamically adjust fixed source motion to variable situations encountered during runtime can prove desirable and provide a way to introduce a variety of unique character movements without the additional computational complexity. This result can be achieved, according to one embodiment disclosed herein, by a runtime retargeting system.

### Offline Processing

### Interaction Bounds

Interaction bounds are 3-dimensional shapes attached to the skeleton of characters, props, vehicles, or parts of the map. These bounds have names, hereinafter referenced as ‘ids’. These ids allow a mapping of interaction between different entities of the same archetype. For example, all drinking bottles can have bounds named ‘Lid’ and ‘Base’, and when attempting to perform the same interaction between them, the relationship between the animated entities can be preserved for these identified bounds. Sets of known ids are called archetypes herein. Archetypes can be used between entities that are interchangeable.

Interaction bounds are used for expressing volume information of something a user interacts with in game. In games, animations rely on ‘skeletons’. In other projects, skeleton bones are used to indicate the location of an interaction. For example, in the case of a ped (e.g., a player character or an NPC character) holding the collar of another ped, helper bones are added that move to the place being held, and those bones are animated so they move along the surface as expected. However, this does not scale well as additional bones are added to the skeleton for more different contact points. Also, continuous contact across a surface isn't supported at all. The disclosed systems and methods handle large variety in terms of outfit, body type, and situation, and for example handle ped interactions between peds of different sizes and body thicknesses. If body thickness changes, it is difficult for animators to handle different archetypes in a scalable way. Interaction with objects, like props and vehicles is the same. Peds will be interacting with props and vehicles of different sizes. Animated bones for these different scales do not help any more. Similar to peds of varying size, a ped can also need to interact with objects of different sizes (e.g., cleaning a small or large window causes a combinatorial problem). There are many things that can change, and making bespoke assets/animations is not feasible. The solution for this is the use of interaction bounds, as laid forth herein.

Interaction bounds are volumes based on primitive shapes. The main supported shapes are, but are not limited to: boxes, tapered boxes, spheres, capsules, tapered capsules, cones, cylinders, and tapered cylinders. These primitive shapes can be used to build more complex shapes to give us varying volume information about peds. As an example, a ped flexing a muscle will change the volume of the bound. Primitives are used because they are easy to access through identifiers. A ped can contain 100 s of interaction bounds. Where each interaction bound is given a unique name or ID, that ID is used to refer to a particular bound.

As an illustration, suppose there is one ped pushing the chest of another ped. To retarget the animation using peds of different sizes, the interaction bounds of the hands of ped A and the bounds of the chest of Ped B are known based on interaction bounds ids. Secondly, shapes are used where use of normalized coordinates is straightforward. If Ped A is animated touching a prop, the same animation can be used on a prop of a different size using normalized surface coordinates. Normalized coordinates can be determined by measuring from the centre of the bound. Then, those points can be converted based on the new size of the object (e.g., spheres use spherical coordinates which scale accordingly).

Meshes are not used for this purpose because the referenced mathematical conversion cannot be used to locate the same coordinates on the mesh of two separate peds. Simple shapes and identifiers allow us to use normalized representations on them.

Interaction bounds are different than physics bounds. In previous solutions, the concept of a ragdoll with physics bounds to prevent interpenetrations with the environment was used. The issue with this is the bounds physics system uses are crude. With physics bounds we do not have the degree of detail that we need where fine contact is called for (e.g., in the case of fingers). We get higher detail with retargeting and interaction bounds. Physics bounds can be used for physical simulation purposes in game. If a ped needs to collide with something in game, we make use of physics bounds. In contrast, interaction bounds are useful for animation interaction purposes. Typically speaking, interaction bounds would not be used for physics purposes, as trying to do physics computations with interaction bounds could result in inefficiencies in the physics system.

Regarding performance, in some interactions not all interaction bounds are used. Clapping hands is one example. Here, we are only interested in the transformation of the hand bounds, and we are not interested in the bounds in the lower body at all. Interaction bounds are typically treated differently than other bounds. Their transformation are generally updated lazily, based on the request (e.g., if there is a constraint that needs the updated state of a bound, update the bound state; otherwise, do not). This can save processing costs.

Interaction bounds give us detail about the volume of the peds we are interacting with. For instance, when we change the size or surface of peds, we can adjust the dimensions and positions of the interaction bounds. As such, larger peds have interaction bounds with bigger volumes so their body surfaces match, and lighter peds have bounds with smaller volumes.

Interaction bounds can lay on the body surface of peds. As an example, they can all be separate bounds with different identifiers. On the chest, for instance, there are multiple bounds which capture the features of the surface. Tech Art and Animation teams create these bounds. Animation can request a certain level of fidelity on, say, a body part in terms of surface details. Tech art can subsequently add/adjust bounds, positions, and volumes to accommodate.

The use of interaction bounds is not limited to retargeting. Instead, interaction bounds have wide applicability, and can be used in a general manner for a variety of purposes. As just some examples, interaction bounds can be employed (e.g., by secondary motion systems and/or other systems) as useful primitives that can: a) approximate (e.g., closely approximate) the surfaces of entities (e.g., characters, objects, and/or vehicles); and/or b) identify and/or describe meaningful (e.g., semantically meaningful) parts of entities (e.g., characters, objects, and/or vehicles). As such, interaction bounds can, for instance, create mappings between multiple entities that identify and/or describe those sections on each entity that have similar meanings.

### Bounds Level of Detail—Standard and High Precision Bounds

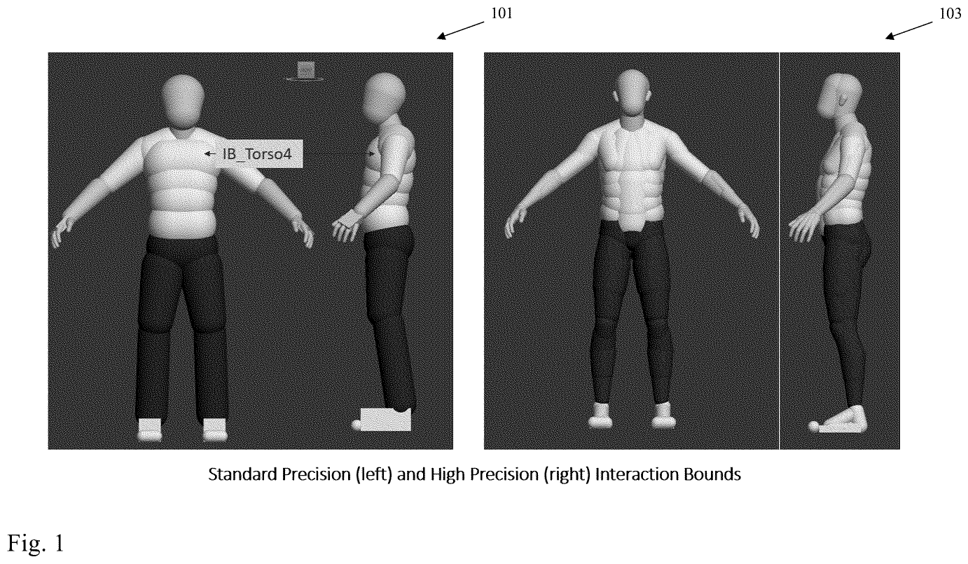

With reference to FIG. 1, in an aspect, fewer, more crude bounds are used in lower levels of detail. More generally, we can use “standard precision” bounds 101 and “high precision” bounds 103.

Standard precision bounds tend to be larger and cover areas which can vary independently. For example, the whole of the forearm can have a standard precision bound to approximate the overall shape of the forearm. For constraints that are rough or distant, the standard precision bounds can be used effectively. They can be: a) easier for use by animators, as a relationship between just one bound can be created; and b) cheaper to compute.

High precision bounds tend to be used when, say close cinematic-quality contacts are required between characters. These bounds tend to be smaller, and can represent the fine detail on a character. For example, in the forearm there can be multiple high precision bounds representing different segments of the forearm that may change due to outfit variation (e.g., rolled up sleeves).

Authored constraint metadata can be used to tell us which bounds we are interested in. For example, when there is hand or finger interaction with something, they typically do not move based on the surface of interaction bounds. Instead, it typically is animated data. We understand what bound the finger is interacting with from the metadata animators author. As an example, there can be a constraint where the right hand on a character is interacting with the chest of another ped. Here, if there is another bound near the bound being interacted with, it is typically ignored. As such, having identifiers which uniquely identify bounds can be important, as it allows animators to refer to a bound precisely. Also as such, working instead with meshes can be difficult (e.g., 1 to 1 matches can not readily be made between characters and surface triangles). Considering interaction bounds for clothing, it is noted that if a ped is wearing bulky clothing, the interaction will also change.

Beyond being used on peds, interaction bounds can be used for props and vehicles. As an illustration, there can be an in game interaction between a hammer and a bottle). In this case both props can have interaction bounds with different IDs. As an illustration, in this way animators can build an interaction between a ped hand and a prop, and the bound on the prop with a bound on another prop.

We are creating a language of interactions that we can signify things with. We can describe interactions with a language. Interaction bounds are an element of the language, so we can describe things in a unique way. Clip environments, interaction groups, constraints, and role ids are building an interaction language. Retargeting builds these language primitives which can describe interaction which can be mapped on to different case. Interaction bounds are a part of it, and need to be able to reproduce a given normalized point for general logic across teams.

In general, interaction bounds existing on a single hierarchy need to have unique identifiers. For instance, two bounds cannot share the same ID. Instead, we want to refer to them in a unique way. Retargeting can desire to retarget an interaction between two things. Suppose that we wanted to express the interaction between a ped and a seat. Here, the ped's bottom could be on the top of the seat, and the foot bottoms could be on the ground. Where there were multiple seats (e.g., where the ped is in a bus), there would be call to know what the different seats were. Further, as described in further detail below, by using ‘affordances’ we can use animation assets so as to end up with the same interaction of a ped with a second seat as with a first seat.

### Animscript to Adjust Bounds to Match Surface (e.g., Following Surfaces with Pose Change)

Interaction bounds are, in an aspect, the crude surface approximation for characters in game. They can represent the body surfaces of various in game entities (e.g., peds, vehicles, and props). The volumes that make up a character are animated along with the character itself. The characters' interaction bounds can follow the surface of the character as it is posed. Further, as character pose changes impact the surface mesh of the character, the bound surfaces typically need to match it closely. Also, when the mesh of the surface changes, the bound surface needs to follow it closely. If bounds are just animated rigidly based on skeleton animation, non-rigid deformation of the surface of the characters typically cannot be captured. Some non-rigid deformation examples include: a) Kneecaps—Their movement is impacted by the thigh and calf bone movement (e.g., the position of the kneecap is computed from the position of the thigh and calf relative to one another); and b) Scapula—its motion is coupled with multiple bone movement around the shoulder complex.

Some bounds do not only change their transformation, position, and orientation, but also their volume. For example, muscles are able to contract and retract (i.e., flex and unflex), which pushes the skin away from (or toward) the character. Given the pose of the arm, we then recompute the pose of the bicep bound. Interactions with other bounds can be retargeted from this. An illustration of this is a self-interaction where a character is holding its bicep muscle while flexing. Here, hand and finger bounds follow the volume of the bicep as the arm is flexed.

Interaction such as these can be handled by AnimScript, a tool that can be used by artists to animate in an artistic way (in other embodiments, another animation scripting tool can be used). Artists can author scripts to express the pose deformation of bounds based on the change to: a) the skeleton pose; b) the bound volume; c) the bound orientation with other bounds relative to each other; or d) any combination of these.

AnimScript is written in C#, which is compiled to a binary that can brought into the game. Once the binary is brought into the game, the code can be run to pose the interaction bounds. However, this typically raises an issue with performance as AnimScript is written in C# and costly to run. Another shortcoming arises because game entities (e.g., peds) typically contain hundreds of bounds. This sheer number of bounds increases the cost of posing an entity (e.g., ped) when these bounds need to be updated.

A solution to this inefficiency is to pose only a subset of bounds, thereby keeping the performance hit down. According to various embodiments, this can be done in two ways. Firstly, AnimScript can be configured to restrict the operations artists can author. These operations have native implementations in C++ which are executed in that code instead of AnimScripts standard pipeline. Secondly, pose can be implemented so as to only pose those bounds that are going to be used for retargeting. Here, use can be made of authored retargeting constraints. These constraints can be explored in game, and used to retarget the body pose of the character. From those constraints, the set of bounds that retargeting operations are to depend on can be explored.

As an example, consider clapping hands. Here, constraints are used to together bring the hands together. Specifically, if there are only constraints to bring the hands together, and the interaction bounds on the palm area are used, it is typically sufficient to update just the bounds needed to pose the hand of the character. In this way, updating of the pose of the other bounds on the character can be avoided.

As another example, consider bicep interaction. Here, an update of the rigid pose of any bound that is updated based on the parent bone of the bound is performed. Subsequently, AnimScript can be run through the native interface to finalize the pose of the bound that is depended on.

Further, according to various embodiments a set of instructions of how bounds move relative to, say, character, prop, or vehicle bones can be included in the description of the interaction bounds used for an entity. When the skeleton changes, the bounds can move rigidly to the single bones that they are each attached to. Subsequently, these AnimScript instructions are followed to determine the final location and bound parameters (e.g., scale, length, and radius) for each bound. This allows for complex interactions between the bounds dimensions and the character skeleton, for instance having the knee patella move out and back depending on the skeleton configuration.

AnimScript can also take as input further aspects of an entity beyond just the skeleton configuration. For instance, AnimScript has access to an animation blackboard where any named information can be placed.

AnimScript can also be used to adjust the proportions of human characters based on their height. For instance, the head is roughly the same size for adults regardless of the overall height of the human. As such, AnimScript can be used to counter-scale the head bounds (and the head skeleton itself) to ensure the head preserves this concept, whilst still uniformly scaling the rest of the body.

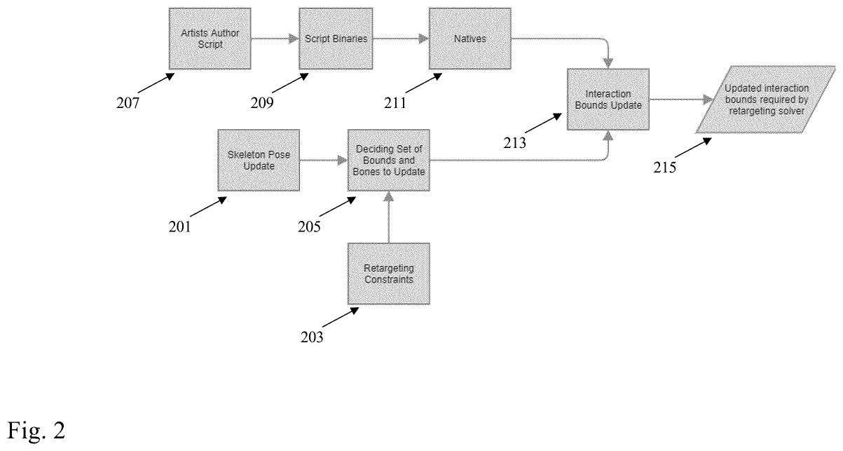

Shown in FIG. 2 is an example process by which authored script inputs, skeleton pose inputs, and retargeting constraint inputs can lead to interaction bounds updates that are used by a retargeting resolver. As depicted by FIG. 2, the process can include receiving (201) skeleton pose inputs, receiving (203) retargeting constraint inputs, and deciding upon a set of bounds and bones to update (205). As also depicted by FIG. 2, the process can further include receiving (207) authored script inputs, generating script binaries (209), and generating natives (211). Then, as additionally depicted by FIG. 2 the process can also include preforming interaction bounds update s (213) and generating updated interaction bounds that are called for by the retargeting solver.

### Interaction Groups

Interaction groups store sets of group members, and each member has a unique role id. In an example of an attacker and defender in melee, we can have an interaction group in that case. There can be two participant group members: one with a role ID attacker, and one with a role ID defender. For each member, we can refer to the bounds in a unique way. Therefore, bound IDs typically must be unique. A constraint can refer to a bound by talking about a group member with a role ID attacker and bound ID left hand; when querying that interaction group, we can find a unique bound.

Note that interaction groups are further detailed hereinbelow when discussing interaction groups as a part of online processing.

### Affordances

Generally speaking, bound IDs are not sufficient for handing all interaction cases, as they can be difficult to generalize in more complicated cases. For example, such potential difficulty can arise when retargeting a character sitting on a bus seat, where the bus has multiple seats, and for each seat in the bus there is a bottom and a back. Here, there can be call to assign unique bound IDs to the seat bottoms and backs. Each seat bottom will be identified (i.e., IB_SEAT_BOTTOM). Here, it can be problematic to author assets with retargeting constraints which we can re-use for sitting on all these bus seats. If we author constraints based on bound IDs, our authored constraint will refer to a single bound ID. Accordingly the constraint cannot be used to sit on a different seat, as each seat has a different identifier.

As discussed herein, affordances can be used to solve generalization issues such as these. Affordances can provide metadata that describes the abilities or purposes of corresponding bounds (as such they are in certain ways similar to social media hash tags). Affordances are not unique, so for the bus example, two seats can share the same affordance of SEAT_BOTTOM to say that bound is the bottom of that seat.

### Disambiguation in the Asset Pipeline

If affordances were naively applied, difficulties could still arise. For example, an authoring problem could arise with regard to processing in the tools pipeline, and a problem in the gameplay could arise with regard to accessing what is authored. If the animators want to, say, author a constraint on an animation asset on a single seat, they can refer to the affordance in a unique way using SEAT_BOTTOM, as there would not typically be need to disambiguate anything in the tools pipeline. However, when that affordance is brought to the game and sitting animation originally used for a single seat is used, a first problem surfaces: that of how to know which seat is going to be used in the game.

Then, a second problem is: if the animator authors, say, a sitting animation by using a bus, and then by using just the affordance, how can the tools pipeline know which bound the animator wanted to author for? As such, there is ambiguity in this case. A solution for this is to enforce that users provide the ID of the bound that they are referring to in the tools pipeline. As such, we separate the authoring/referral of the interaction bound in the tools pipeline and in the desired case in the game. The ID allows us to do the computations on the original asset in the asset build pipeline.

### Disambiguation in Game

For solving the second problem for disambiguation of the bound we want to refer to in the game, we ask, from the animators on the authoring side, for a particular bound ID that will have that affordance in the source animation in the game—we need some additional information to disambiguate the affordance that we want to make use of. For this, we propose two solutions which work together.

The first solution involves introducing design constraints on skeletal hierarchies. Here, the data of the Tech Art team can be organized so as to create hierarchy for the bounds that we have. It can be enforced that these developers create a root bone, which in the example of the bus seat where each bus seat would have a Root Bone (Seat1, Seat2 or Seat3), would have all bounds corresponding to seat 1 go under the bone Seat1.

When gameplay creates an interaction group with the group member with a seat, they pass the corresponding bus entity, plus the Root Bone ID under which we can search the corresponding affordances or related references to the constraint tags.

The second solution does not rely on changes on the skeletal hierarchies and is perhaps more production friendly. Continuing with the bus example, according to the second solution asset production team can add a new affordance to all bounds which belong to each individual seat. For instance, all bounds of Seat1 would have an additional affordance Seat1. When gameplay creates an interaction group with the group member with a seat, the corresponding bus entity is passed, plus the affordance(s) which are added to all subsequent affordance queries. For instance, if the gameplay creates a member with entity Bus to involve the affordance “Seat1”, all the subsequent bound queries would be restricted to the bounds with the affordance “Seat1” which would discard the bounds of the other seats.

Note that we also allow the creation of a group member both with a bone id and affordance(s) simultaneously. When this is the case, subsequent affordance queries would be restricted to the bounds descendants to the given bone with those specific affordances(s).

Turning to TABLE 1, shown is an example for the first solution:

TABLE 1
Legend- (1)- Entity id; (2)- Bone ids;
(3)- Bound ids; (4)- Affordances

```
• SchoolBus (1)
  • SKEL_SEAT1 (2)
    • IB_SEAT1_BOTTOM (3)
      • SEAT_BOTTOM (4)
    • IB_SEAT1_BACK (3)
      • SEAT_BACK (4)
  • SKEL_SEAT2 (2)
    • IB_SEAT2_BOTTOM (3)
      • SEAT_BOTTOM (4)
    • IB_SEAT2_BACK (3)
      • SEAT_BACK (4)
  • SKEL_SEAT3 (2)
    • IB_SEAT3_BOTTOM (3)
      • SEAT_BOTTOM (4)
    • IB_SEAT3_BACK (3)
      • SEAT_BACK (4)
```

For the first problem of using a single seed for authoring retargeting in the game and making use of the asset (and continuing with the bus example), when an animator needs to refer to a particular bound through its affordance, it can be enforced that the users provide an authoring role ID (i.e., Seat) and authoring bound ID (IB_SEAT), plus the role ID of that entity in the game (i.e., Seat), and the affordance that will be used in the game (i.e., SEAT_BOTTOM). Typically, this data used for authoring; it will not be used in the game but used in the tools pipeline instead. Typically, the authoring role ID is referred to in the ClipEnv file, as that is how the tools pipeline knows about what is being interacted with.

Continuing with the bus example, the bus in the ClipEnv file can still be exported as a role ID Bus, or any other role ID the animator chooses. Then, as the bus can have multiple seats, it can be enforced that the user to give the direct role ID, such as where the ped is sitting in the given animation asset. In general, the authoring role ID and the authoring bound ID are only used for the asset pipeline purposes. As such, necessary data can be baked in. The data used by the gameplay can be the same as the first example, where the role ID is Seat, and the affordance is SEAT_BOTTOM. We typically retarget based on the affordance, not the bound ID. We typically still need the bound ID to disambiguate things in the tools pipeline. But, that data does not come to the game as it is not used.

Given, say, a constraint for sitting on a seat with affordance SEAT_BOTTOM, implementation can handle this on the gameplay side. First, a semantic hierarchy can be used. Continuing with the bus example (and taking the bus to be a school bus), school bus can be the name of the entity (i.e., Entity ID). That school bus can have root bones for each seat (e.g., SKEL_SEAT1, SKEL_SEAT2, SKEL_SEAT3, etc.) on the bus. Each seat can have a set of bounds with unique identifiers. In the example, there are bound IDs (IB_SEAT1_BOTTOM, IB_SEAT1_BACK), and affordances (SEAT_BOTTOM, SEAT_BACK) for each root bone. Each seat can have a list of affordances. But for this example, we are only considering single affordances; IB_SEAT1_BACK could have another affordance, like SUPPORT_HANDLE, for example. Each seat has a root bone, under each root bone. As such there can be a multitude of bounds, and each bound can have a set of affordances.

Continuing with the example, reference is now made to TABLE 2 below wherein, for example, SchoolBus and SKEL_SEAT2 of TABLE 1 are further considered. Here, the constraint referring to Role ID Seat and affordance SEAT_BOTTOM can be found in Group Member. For creating that group member, there can be creation of one with role ID Seat and what entity represents it, which would be SchoolBus in this case. Then there can be provision of SKEL_SEAT2 as the Root Bone ID. As such, there is specification that the seat in the interaction group is seat 2 inside the school bus. As such, tech art can create a bus model with Entity ID SchoolBus. Then, in the hierarchy, there can be creation of a group member with role ID Seat out of this entity by using SKEL_SEAT2. This allows us to restrict the bounds we are going to search for that affordance.

TABLE 2
Legend- (1)- Entity id; (2)- Bone ids; (3)- Bound ids; (4)- Affordances
Group Member

```
- Role Id
  - Seat
- Entity
  - SchoolBus (1)
- Root Bone Id
    • SKEL_SEAT2 (2)
      • IB_SEAT2_BOTTOM (3)
        • SEAT_BOTTOM (4)
      • IB_SEAT2_BACK (3)
        • SEAT_BACK (4)
```

To disambiguate what the constraint refers to, with reference to TABLE 3 below we can search for SEAT_BOTTOM under SKEL_SEAT2 bone. Then, by referring to the affordance SEAT_BOTTOM, we can refer to IB_SEAT2_BOTTOM on the retargeting side.

TABLE 3
Legend- (1)- Entity id; (2)- Bone ids; (3)- Bound ids; (4)- Affordances
Group Member

| | - Role Id |
|---|---|
| Constraint refers to | |
| - Role Id: Seat --> | - Seat |
| | - Entity |
| | - SchoolBus (1) |
| | - Root Bone Id |
| | • SKEL_SEAT2 (2) |
| - Affordance: | • IB_SEAT2_BOTTOM (3) |
| SEAT BOTTOM --> | • SEAT_BOTTOM (4) |
| | • IB_SEAT2_BACK (3) |
| | • SEAT_BACK (4) |

### Interaction Bound Archetypes

We can create animations that are intended to work across groups of objects we want to be able to interact with in the same way. To ensure that constraints can work across these groups of objects, interaction bound archetypes can be defined. An interaction bound archetype can specify the:

Name (also known as BoundId);

Shape; and

Affordances

of a set of bounds. These are the superset of bounds we expect to exist on an entity of this archetype. By animating on one entity belonging to this archetype, we can expect the same BoundIds, Shapes, and Affordances to be found across other entities belonging to this archetype, and therefore be able to use constraints made to bounds of this archetype across all other entities that share the same Interaction Bound Archetype.

An example of a clothing archetype is below:

```
  <InteractionBoundSetArchetype>
    <name>Clothing</name>
    <bounds>
      <Item>
        <name>IB_TBOX_Cap</name>
        <parentBone></parentBone>
        <boundType>TaperedBox</boundType>
        <affordances>
          <Item>SP</Item>
          <Item>HP</Item>
        </affordances>
        <parentBoundId></parentBoundId>
      </Item>
      <Item>
        <name>IB_TBOX_Face_Guard_Extents</name>
        <parentBone></parentBone>
        <boundType>TaperedBox</boundType>
        <affordances>
          <Item>SP</Item>
          <Item>HP</Item>
        </affordances>
        <parentBoundId></parentBoundId>
      </Item>
  ...// Further bounds have been removed from this example but follow
the pattern above
    </bounds>
  </InteractionBoundSetArchetype>
  A specific instance of an InteractionBoundSet would refer to this
archetype, as well as a set of actual bounds which define the:
  BoundId;
  Shape;
  Parent Bone in the Skeleton;
  Transform offset from the Parent; and
  Shape parameters.
  An example InteractionBoundSet for a motorcycle helmet is:
  <InteractionBoundSetInstance>
    <name>IB_Motorcycle_Helmet</name>
    <archetypeName>Prop_Archetype_Clothing</archetypeName>
<archetypePath>$(export)/anim/interaction_bounds/Props/Archetypes/Prop_Archet
ype_Clothing.meta</archetypePath>
    <category>Helmets</category>
<primitiveSetName>Prop_Clothing_Helmets_IB_Motorcycle_Helmet</primitiveSetNam
e>
<primitiveSetPath>$(export)/anim/interaction_bounds/Props/Bounds/Prop_Clothin
g_Helmets_IB_Motorcycle_Helmet.meta</primitiveSetPath>
  </InteractionBoundSetInstance>
  Further according to the example, the referenced ‘PrimitiveSet’ can
be:
  <PrimitiveSet>
    <properties type=″BoundSetProperties″>
      <collisionType>INTERACTION</collisionType>
      <enableOnPed value=″true″ />
    </properties>
    <primitives>
      <Item type=″PrimitiveTaperedBox″>
        <name>IB_TBOX_Cap</name>
        <position x=″0.000000″ y=″−0.098450″ z=″0.084411″ />
        <orientation x=″0.8262363″ y=″0″ z=″0″ w=″0.5633237″ />
        <parentName>rsBone_IB_Motorcycle Helmet</parentName>
        <parentGuid>...</parentGuid>
        <properties type=″BoundProperties″>
          <boundFlags value=″8192″ />
          <boundFlagNames>anim_interaction</boundFlagNames>
          <material>DEFAULT|0|0|0|0</material>
        </properties>
        <widthA value=″0.075445″ />
        <widthB value=″0.176515″ />
        <heightA value=″0.156000″ />
        <heightB value=″0.112000″ />
        <length value=″0.045000″ />
      </Item>
      <Item type=″PrimitiveTaperedBox″>
        <name>IB_TBOX_Face_Guard_Extents</name>
        <position x=″0.000000″ y=″−0.058248″ z=″−0.085584″ />
        <orientation x=″0.156157687″ y=″0″ z=″0″ w=″0. 9877322″ />
        <parentName>rsBone_IB_Motorcycle_Helmet</parentName>
        <parentGuid>...</parentGuid>
        <properties type=″BoundProperties″>
          <boundFlags value=″8192″ />
          <boundFlagNames>anim_interaction</boundFlagNames>
          <material>DEFAULT|0|0|0|0</material>
        </properties>
        <widthA value=″0.227482″ />
        <widthB value=″0.049404″ />
        <heightA value=″0.074684″ />
        <heightB value=″0.074683″ />
        <length value=″0.179466″ />
      </Item>
  ...
    </primitives>
  </PrimitiveSet>
```

### Efficient Posing and Storage of Interaction Bounds

The poses of the interaction bounds typically need to be recomputed based on the changing skeletal pose of the character. However, implementing this in a naive way—such as by posing all the bounds as is done for physics bounds for collision purposes—generally results in significant computation and storage cost due to the number of interaction bounds an entity can have (e.g., a single entity instance can have hundreds of High Precision bounds).

We can overcome this problem by selectively posing the bounds, via exploration of the subset of those bounds that are actively used by the animation constraints. As the retargeting system receives a set of constraints driving the ongoing interactions, we can identify the set of bounds whose pose is needed for retargeting purposes, and can query only the poses of those bounds to be computed. We identify this technique as on-demand-posing.

We can alleviate the storage cost problem by storing the local transform or the dimensions of a bound only when they vary with respect to their values in the primitive set of the instance they belong to for an entity. For instance, the kneecap bound of a character can be driven by AnimScript and not move rigidly attached to a parent bone. If the kneecap pose is required for an animation constraint computation, first the dependent AnimScript can be run to deform the kneecap pose correctly, and this pose stored locally on the corresponding entity's bounds storage. However, in various embodiments if the local transform or the dimensions of a bound is not changed by AnimScript, no local storage is necessary as the storage in the primitive set can be used as is.

### Alias Entities

### Defining Entities

In an aspect, retargeting is an interaction between entities. Usually those entities are well-defined. As such, when considering a melee example, we can have an attacker and a defender where both characters are bipeds. Further, each biped can have interaction bounds such that we can author constraints between, say, the right hand of the attacker and the head of the defender. Continuing with the example, the right hand of the attacker can have an interaction bound called IB_RightHand, and the head can have an interaction bound called IB_Head. We can write a constraint between these two interaction bounds. However, not every entity authored in-game is well-defined. An example of this is the map of the game itself, the terrain, stairs, and benches, for instance, do not have well-defined meanings because they are part of the map geometry and not entities themselves. Further, there are entities we can consider with some abstraction. An example of this is the ground where there typically is a SelfGround definition for every character. For these situations where we lack well-defined entities, alias entities (which can also be referred to as alias shapes) can be used. It is noted that an alias entity need not utilise or be attached to a skeleton. It is further noted that alias entities can be created at any world point.

For melee example, alias entities can be used for the left and right feet of the characters, and the definition of the ground can change depending on the surface (e.g., whether the character on the pavement, whether the pavement has inclination, or whether the ped is on a vehicle). Defining the ground can be a difficult case, as it is a dynamically changing entity that the character interacts with. Flexibility can be called for when taking the assets authored for a specific case and making use of them for other cases. A representative example of this involves aiming. For instance, there can be an aim clip where a ped is aiming at a target's head, and an ability to make use of the same asset on similar example (e.g., aiming at a different target, or at another interaction bound of that ped). Here, there is no single entity to specifically interact with, as the entity itself can also change depending on the interaction. For this, an alias entity SelfAimTarget can be used.

Also, from at least the vantage point of scalability, it is noted that the definition of such aliases can typically not be known at the system level. In particular, keeping track of such aliases at the system generally involves bespoke code for each, whereas the retargeting system should typically be general enough to not be serve as a barrier between animators and the gameplay programmers whenever they want to create a new object.

### Alias Entities Overview

Alias entities are abstract entities that the retargeting system can interact with, such as geometry primitives or transforms. The geometry primitives can include spheres, capsules, boxes, and other such single, convex shapes. A transform can be a three-dimensional point and its orientation. Such an abstract entity can be assigned an alias entity, and can be part of an interaction group. They can be created from: a) an interaction bound; b) a bone; and an c) offset from an interaction bound, bone, or parent transform.

Creation of alias entities begins in the asset pipeline, where animators can export a clip environment, the clip environment being a file that contains alias entities that the interaction will be working with. In the aiming example, the animators can specify what the SelfAimTarget is when exporting the clip environment. Further, alias entities can be auto generated by code. For example, the SelfGround alias entity can be (or largely be) hard-coded and maintained by the Gameplay team. After a clip environment is exported, it can be referred to by any constraints that the animator is authoring. After the authoring process is done, the assets can be built just like any other asset. Our Process Constraints tool can explore the clip environment and access the alias entity through its interaction group member role ID.

### Usage In-Game

Alias entities are typically maintained by the Gameplay team, as they have the knowledge of semantics of ongoing interactions. They can create an alias entity depending on changing circumstances. If, say, a gameplay situation aiming at a peds head, the gameplay team can pass the corresponding information. Further, the Gameplay team typically knows the surroundings of the characters better than what is interpreted at the system level. Those created alias entities are added to interaction groups just like any other group member.

When considering a melee example, there can be an interaction group with an attacker member, a defender member, and a member called, say, AimTarget. Specifically, AimTarget can be added into the interaction group as an alias entity. These can be added both into: a) a default interaction group containing information of the entities that the characters can interact with all the time; or b) one or more standard interaction groups that are added and removed depending on the ongoing interaction. Ultimately, the retargeting system can access the alias entities through those interaction groups within interaction groups just like we add the attacker and the defender.

As an example, alias entities can be used as part of a scenario to make peds sit on benches, as these benches are part of the map and not real entities. The scenario system can create some aliases, such as seat back and seat bottom, by creating matching aliases in the game, with the system not knowing whether or not a bench is present. In this way, the names of those aliases (e.g., seat back and seat bottom) can be of concern only where the containing interaction group is sent. Another example is SelfGround, an alias entity maintained by the Gameplay team. The alias entity Left Foot Ground and Right Foot Ground for the ground under each foot respectively can be used, alongside Common Ground (the ground shared by multiple characters for cases of multiple character interaction, such as the melee example).

### Clip Environment Files

### Clip Environment Files—Overview

Having the retargeting system run in-game does not, in all embodiments, necessarily mean that everything required in the tools pipeline is accessible. There can be some operations in the tools pipeline that are reproduced in the game environment. As examples, the reproduced operations can include animation aspects such as the pose of the character, kneecap motion, and biceps altering/changing volume based on pose. To compute these operations and bake-in the data, there can be call to reproduce the game environment on the tools side.

First, in the animation system, the animation data is baked per entity that plays that animation. Before Clip Environment files, there was no notion of what interactions occur as there was no way to synchronize them and get them aware of each other in the tools pipeline. In a simple case, such as a handshake between characters, we can store the relationship between the hands of each character. This relationship is not just about the contact; it involves the whole relative motion of the characters in the scene. To make computations, we typically need to know in the original animations which paths were used, which clips those paths play, if there were some AnimScripts running on those peds, which Animscripts those were, and if in that interaction, were there any other props around (i.e., weapon, cup, etc.) that the characters were interacting with. In that interaction, if there are some alias entities, those are typically abstract geometries or bounds created by gameplay. If we need to compute those relationships between a ped and alias entity, we typically need to know about those in the tools pipeline as well.

This is an example of where Clip Environment files are beneficial to the workflow. A Clip Environment file contains a combination of all the necessary data required (e.g., which entities interact, which clips they were playing, which scripts they were playing, if there were other alias entities, and any attachment events such as grabbing a weapon). Further, the Clip Environment file also carries information about the camera, such as where it was placed when the scene was shot. This camera information can be useful for camera retargeting. From one point of view, the Clip Environment file is a concept that we can store in a text file in some sort of metadata of its own. Then, when computations of trajectories and relationships between interacting entities are required, the Clip Environment file can be used. It is, in an aspect, a contract tells the terms and conditions of an interaction. Based on these, accurate computations can be made.

Animators can create Clip Environment files, exporting them out of, for instance, using any digital content creation (DCC) tool. They can first create animations in the DCC tool and tune the scene, then export the Clip Environment file when they export the corresponding animations and clips. Animators can author animations in the DCC tool, export the animations and Clip Environment file, then they use Clip Editor to load those clip files and author constraints into them. That clip has the metadata that is ready to be processed by Process Constraints. The Clip Environment file is passed to Process Constraints, which will know which clips were being played in the interaction, and then within those clips, the metadata authored by the animators is known. Operations are then run to compute the necessary data needed to be able to retarget in the game. An input clip with tags is acquired and Process Constraints iterates through all the tags, putting necessary information into them, then in tools pipeline it is baked, then the baked entity goes into game, and we retarget accordingly. To be able to retarget in the game, the gameplay team is responsible for creating the interaction group with which those clips that they are going to play will have a meaning.

A Clip Environment file can, for example, be a hex or text file that uses the extension .clipenv. This file can hold entity information, including camera entities. For instance, the camera has a list of events that the corresponding camera is responsible for.

For the handshaking example, it is known which clip is playing on ped entities, and which ped was used when authoring those interactions. For instance, we can use two peds, where ped 1 is 182 cm tall and ped 2 is 172 cm tall. In an aspect, if mismatched peds are used the hands would not be in correct positions. The Clip Environment file outlines the original interaction that can be processed to achieve accuracy. When exporting Clip Environment files from the DCC tool, AnimScene files are typically exported as well. AnimScenes are in some ways parallel to Clip Environment files, but they are run in the game. Further, an AnimScene can provide a single timeline for animations and other events that are shared across multiple entities. Continuing with the handshaking example, when an AnimScene file is run in the game, with those two peds with correct size and proportions, exactly what the animators authored on the DCC tool can be reproduced. Also, there can be ability to identify any problems in the tools pipeline. If in the game and running the 1:1 match AnimScene and the Clip Environment File and things do not align, the retargeting system can incorrectly compute trajectories when we go through the tools pipeline. For this reason, the Clip Environment viewer can be beneficial. This viewer reads the Clip Environment file and plays the clips, showing what the clip truly provides.

As an example, consider a scene wherein one can see the two cameras that were represented in that Clip Environment file, with these being represented in the UI as Camera1 and Camera2. According to the example, they are clickable and will highlight what is selected. This, for instance, allows us to see how each camera sees the world via clicking on View from Camera2. This tool can be useful to ensure correctness (e.g., perfect correctness or near perfect correctness) of the tools in the tools pipeline. According to various embodiments, implementation being through computation can mean that there is no visual feedback for on the Code side without this tool. When something goes wrong in the game (e.g., Process Constraints failing, Clip Environment file not matching what is in the AnimScene file etc.), one of the first things a user can do is utilize the Clip Environment viewer and verify that the right aspects are being used for the computations. The Clip Environment viewer is, from one point of view, essentially an inspection tool to see what we have in the meta file; we can see which scripts are running in that selected entity as well.

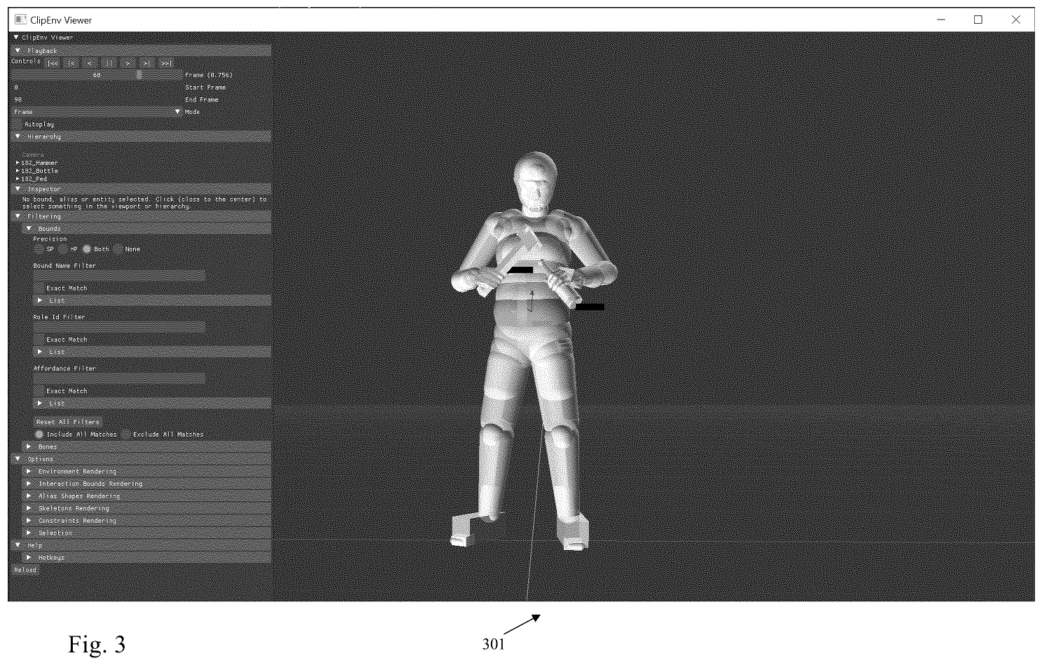

Continuing with the example, in this specific scene verifying correctness can involve confirming that hands are matching. If hands are not matching properly, one of the characters is perhaps incorrect in the Clip Environment file. And, if they are matching, there can be performance of a check on the scripts running on the character, as perhaps the correct scripts are not running. If everything matches perfectly, the issue will likely reside in Process Constraints. Shown in FIG. 3 is a screenshot 301 of the ClipEnvViewer.

### Clip Environment File Specification

```
  <!-- Events -->
    <structdef type=“::” name=“”>
      <float name=“startTime” description=“start time of the event
(usually in seconds relative to the beginning of the whole interaction)”/>
      <float name=“endTime” description=“end time of the event
(usually in seconds relative to the beginning of the whole interaction)”/>
    </>
    < type=“::Animation” name=“EnvironmentAnimationEvent” base=“::”>
      <string name=“clip” type=“” description=“clip name in the same
directory as the environment”/>
    </>
    < type=“::Attachment” name=“EnvironmentAttachmentEvent” base=“::”>
      <string name=“attachParent” type=“” description=“parent name”/>
      <string name=“attachParentBone” type=“” =“Id”
description=“attach parent bone, can be null if attached to entity matrix”/>
      <string name=“attachSelfBone” type=“” =“Id” description=“attach
bone on the entity being atttached, can be null if it is the entity matrix”/>
    </>
    < type=“::List” name=“List”>
      <array name=“list” type=“”>
        <pointer type=“::” policy=“owner” />
      </array>
    </>
  <!-- Shapes -->
    < type=“::” name=“”>
      < name=“transform” description=“Local transform of the shape
relative to its parent”/>
      <pointer name=“shape” type=“::ShapeData” policy=“owner”
description=“The shape description”/>
    </>
  <!-- Skeletons -->
    < type=“::SkeletonAttachPoint” name=“SkeletonAttachPoint”>
      <string name=“skeletonName” type=“” description=“name of the
<map name=“attachBone” type=“atBinaryMap” key=“” =“atBinaryMap<crId,crId>“>
<!-- the key is the name of the bone on this skeleton to attach, and the
entry skeletonRoot is the root on the base skeleton to attach to (or 0u if
attaching to entity matrix) -->
      <string name=“skeletonRoot” type=“” =“crId” description=“root
attachment (crId for where to attach this skeleton).”/>
      </map>
    </>
    <!-- AnimScript -->
    < type=“::” name=“”>
      <string name=“dictionary” type=“” description=“name of the
AnimScript dictionary, e.g. ‘AnimScript’”/>
      <string name=“animScript” type=“” description=“name of the
actual AnimScript class, e.g. ‘WiggleArms’”/>
    </>
    < type=“::” name=“”>
    </>
    <!-- Model Definition -->
    < type=“::ModelDefinition” name=“ModelDefinition”>
      <!-- Designed so that TechArt can just maintain one model
definition that individual clipenvironments point to describe how a model is
setup -->
      <array name=“animScripts” type=“” description=“vector of
AnimScripts to be ran for this model”>
        <struct type=“::”/>
      </array>
      <map name=“AnimScriptInterfaceVariables” type=“atBinaryMap”
key=“” description=“Map of AnimScript values that can be edited.”>
        <pointer type=“::” policy=“owner” />
      </map>
      <array name=“skeletons” type=“”>
        <struct type=“::SkeletonAttachPoint”/>
      </array>
      <array name=“boundInstances” type=“”>
        <string name=“boundsInstanceName” type=“” description=“name of
the interaction bound instance in the asset dir relative to the
interactionbounds root (e.g.
Characters/Instances/ZZ_Peds/InteractionInstance_ZZPed_LongArms05.meta).
Internally the instance points to the Archetype too.”/>
      </array>
    </>
    < type=“::ModelDefinitions” name=“ModelDefinitions”>
      <map name=“models” type=“atBinaryMap” key=“”> <!-- the key is
the same as the id -->
        <pointer type=“::ModelDefinition” policy=“owner” />
      </map>
    </>
    < type=“::ModelDefinitionId” name=“ModelDefinitionId”>
      <string name=“modelDefinitionName” type=“” description=“Id of
the model definition. 0 by default and if not used. This is the base of this
animated entity, any skeletons, bound instances, or animscripts here are in
addition to the base.”/>
      <string name=“modelDefinitionDictionary” type=“” description=“Id
of the model definition dictionary. 0 by default and if not used. This is the
dictionary file the model definition name is found in.”/>
    </>
    <!-- Entities -->
    < type=“::” name=“”>
        < name=“offset” description=“transform from the origin or
attach parent (clip starts here if animated)”/>
      <struct name=“events” type=“::List” description=“the timeline of
events for this entity”/>
      <array name=“animScripts” type=“”> <!-- these should only be
included as overrides, so would usually be an empty array in favour of using
the modeldefinitionid on animated entities -->
        <struct type=“::”/>
      </array>
    </>
    < type=“::Camera” name=“Camera” base=“::”>
      <bool name=“firstPerson” init=“false” description=“is this
camera used as the first-person camera?”/>
    </>
    < type=“::Animated” name=“Animated” base=“::”>
      <struct name=“modelDefinitionId” type=“::ModelDefinitionId”
description=“Id and dictionary of the model definition, if any. 0 by default
and if not used. This is the base of this animated entity, any skeletons,
bound instances, or animscripts here are in addition to the base.”/>
      <array name=“skeletons” type=“”> <!-- these should only be
included as overrides, so would usually be an empty array in favour of using
the modeldefinitionid -->
        <struct type=“::SkeletonAttachPoint”/>
      </array>
      <array name=“boundInstances” type=“”> <!-- these should only be
included as overrides, so would usually be an empty array in favour of using
the modeldefinitionid -->
        <string name=“boundsInstanceName” type=“” description=“name of
the interaction bound instance in the asset dir relative to the
interactionbounds root (e.g.
Characters/Instances/ZZ_Peds/InteractionInstance_ZZPed_LongArms05.meta).
Internally the instance points to the Archetype too.”/>
      </array>
    </>
    < type=“::Alias” name=“Alias” base=“::”>
      <struct name=“shapeTransform” type=“::” description=“the
transformed shape this alias entity defines”/>
    </></>
    < type=“::ClipEnvironment” name=“ClipEnvironment”>
      <map name=“entities” type=“atBinaryMap” key=“”> <!-- key is the
handle of the entity, which is how constraints will refer to the entity.
These keys/names are unique inside a single environment -->
        <pointer type=“::” policy=“owner” />
      </map>
      <array name=“geometry” type=“”>
        <string name=“geometryObjPath” type=“” description=“name of
the collision environment relative to the geometry assets dir root”/>
      </array>
      <!-- tools and versioning information, defined by tools team. -
->
      <!-- <export date> -->
      <!-- <export tools version>-->
    </>
```

### Tools Pipeline

Retargeting is based on .clip and .anim files (e.g., as exported from a DCC tool), along with any Clip Environment .anim files which contain baked animation data like bone transformations. The clip files are for metadata, to express the properties of the baked data. As examples, clip files can include retargeting constraints, corresponding skeleton files, and any meta data including retargeting constraints. Retargeting metadata can also contain information regarding relative motion and displacement between body parts with respect to other entities. The displacements are typically time sequenced. Also, time computations can be performed and stored in clip files.

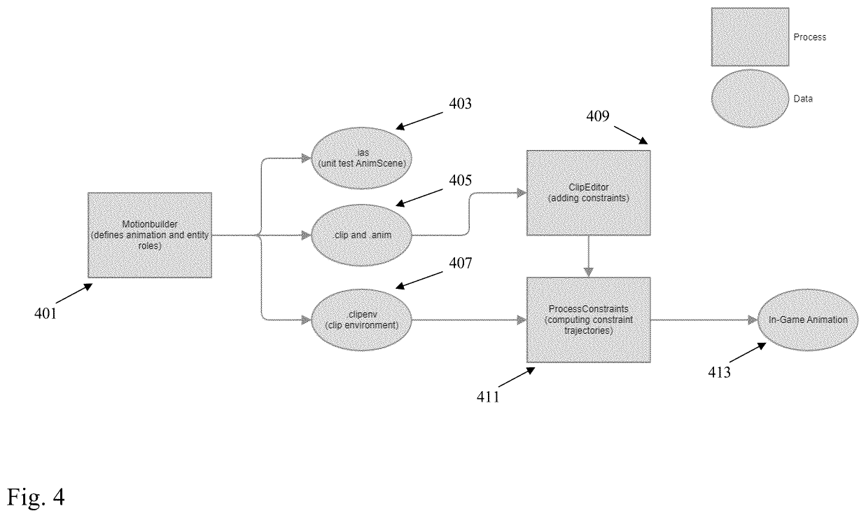

Animators can author retargeting constraints using the ClipEditor, a tool for metadata authoring. It is noted that, in some embodiments, with regard to authoring in the ClipEditor, animators can author retargeting constraints, but there are computations that need to happen behind the scenes (e.g., the baked data explained before). After constraints are authored with the ClipEditor, the corresponding clip environment file (which contains info of all clips that need to be played on all different entities) can be output. Process Constraints are then computed as a separate executable which observes what animators authored on the tags. Based on what was authored, if further computations are needed (e.g., based on the pose of a char, or on time sequence data), such computations are performed and baked into the clip file as well. An authored clip file can be received from animators. Then, there can be output of another .clip file which contains the trajectory information and other information that needs to be baked in (e.g., the environment, objects, or peds they are interacting with). As depicted by FIG. 4, Motionbuilder can be used (401) to define animation and/or entity roles, yielding .ias data 403, clip and .anim data 405, and .clipenv data 407. The .clip and .anim data 405 can be used (409) by ClipEditor (e.g., to add constraints). Also, the .clipenv data 407 and output of step 409 can be used (411) by ProcessConstraints (e.g., to compute constraint trajectories), thereby generating in-game animation data 413.

In the animation pipeline we run Process Constraints on possessed ClipEnv files. A clip that is authored can be referred to from the ClipEnv files. As examples, operations performed in the Tools Pipeline can include Process Constraints, loading clips, checking on what animators have authored, and determining any data that needs to be baked in. Process Constraints can include taking clipenv files that access the related clips, and outputting new clipenv file(s) with corresponding baked data. With reference to the figure, Process Constraints can include computing constraint trajectories.

According to various embodiments, retargeting is not performed with raw clip files. In these embodiments, the raw clip files that animators author are instead processed by Process Constraints before coming into the game. The processing of the raw clip files by Process Constraints can yield benefits including preventing retargeting from using corrupt data.

After Process Constraints, an output data compression step can be performed for constraints. This step can apply, for instance, to metadata that contains time or trajectory data. As an illustration, there can be a clip in which a ped idles and for which an animator wants to add a constraint to measure the relative displacement of the feet of the character with respect of the ground. As this relative displacement can typically be constant for the clip, at least some redundancy in those stored values can often ensue. Accordingly, it can be beneficial to de-duplicate redundant data. For this reason, data can be compressed after Process Constraints. As such, there can be reduction in the size of data that goes into the game. Where, say, there are very repetitive actions, the compression achieved can be particularly pronounced. In some embodiments the output data compression step is not performed.

When trajectories are expressed, they are typically stored in a normalized coordinate systems. As an example, consider a ped moving their hand around a spherical object. If we want to measure the displacement of the hand with respect to the sphere surface, we can refer to stored normalized spherical coordinates. It is noted that these spherical coordinates differ from xyz (Euclidian) coordinates, and are not calculated as if the hand were moving freely in space; we know we are interacting with a sphere and therefore opt to implement functionality based on stored normalized sphere coordinates. When we want to compress trajectories, the compression algorithm employed can be informed of the type of the trajectory. In this way the compression algorithm can apply different compression techniques for each type of normalized coordinate we have. This can be complicated by the fact that we have different coordinates for other shapes than spheres (e.g., boxes, capsules, and tapered capsule)

At the time of storing data trajectories into the clip files, we can do a small trick: together with the normalized coordinates, we can also store the xyz coordinates of the trajectories. As such, for the ped moving hand example, together with the spherical coordinates we can store the corresponding xyz coordinates. This allows the compression executable to work with a standard data format based on xyz coordinates so it can measure the distance based on a consistent metric.

As such, in the tools pipeline we can carry two coordinates, such as spherical and xyz for the hand movement example. These two coordinates map 1:1, with one (the xyz) being a helper for the compression algorithm. And, we can decide on the redundant data based on the xyz coordinates, and then remove the data from the normalized coordinates. Once the compression has completed, we throw away the xyz coordinate because it is not needed in game, but rather only for the purpose of compression. Because we want to keep the compression algorithm independent from Process Constraints) when we express trajectories, we typically store some normalized coordinate which the compression algorithm cannot understand. It is noted that Process Constraints are typically only for retargeting constraints, where the compression executable is typically able to compress any data, and avoiding creation of a dependency in between can be beneficial. Further, we can remove redundant data from the spherical coordinate trajectory.

The pipeline can also contain a step to run scripts. Animators can author constraints, and the resulting clips can be processed by the noted Process Constraints. Subsequently, the clip goes to an AnimScript stage where operations based on AnimScript can be performed. Of these, Process Constraints are typically the more complex of the just noted actions. This AnimScript stage typically involves simple operations and minor changes. Compression can be run afterwards, and the output data can be brought into the game like any other clip. In summary, operations can proceed in the following way: DCC tool>Clip editor (which runs bespoke scripts for UI purposes)>script (pre process)>Process Constraints>script (post process)>compression>into game.

Retargeting constraints can be quite complex, for at least the reason that oftentimes animators do not author the same repetitive inputs. The reasons for this are due to there being several different types of constraints (e.g., position, orientation, aim, and limb length). And, apart of from those main constraints, there being many sub-types of constraints. Further, constraint tags can contain many optional parameters, and these optional parameters are at times not used correctly by animators.

In view of this, embodiments can provide a UI to facilitate various of the aforementioned (e.g., the use of optimal parameters) for animators. The main tool for animators is typically AnimScript, with clip editor being used for authoring retargeting constrains. The UI can provide a hook to be able to run AnimScript therewithin. Based on user selection by an animator, the animator can be shown a different contextually accurate UI on the fly (e.g., displaying compatible options for what the animator is currently working with). When running a clip in ClipEditor with constraints, the UI is updated to help the animator user distinguish constraints in an easy way. The constraints can be highlighted by type, and errors/missing information can be identified with steps to correct being provided. Further, available properties can change to match what is available to be used. Implementation of the UI can include having AnimScript run on top of ClipEditor. Conventionally, a tool such as ClipEditor would have merely a static UI.

With regard to running an AnimScript in the pipeline, the following is noted. When a user authors constraints, saves their clip and builds it, the clip goes into Process Constraints via the corresponding Clip Environment file. The Clip Environment file is subsequently fed into Process Constraints by the tools pipeline. When UI operation are occurring with AnimScript, additional data is being added to clip that will typically not be needed in game (e.g., UI colour information). This additional data is deemed unnecessary at the script stage and stripped out of the file by queries that decide what data should and should not be kept for the game. This differs from the compression discussed above that (in general) deals with temporal data. In particular, script compression is less complex, hardcoded, and predetermined (e.g., to remove input property).

As a side note regarding cinematics, the following is pointed out. Retargeting's point of view does not change based on the files being used. And, the same pipelines can be used. Typically, the only factor that changes is that the processes that use the assets (e.g., in the game) can be different. Also, clips can be played through some other gameplay systems, like AnimScenes or scenarios. Although these are different processes that are using the assets, they go through the same steps. Such processes can be given well-defined interfaces with which to interact. As such, if, say, an interaction bound is being specified to the system, it does not matter what process that interaction bound if coming from; it is the same pipeline for everyone.

In summary, the DCC tool can export clip environments, clips and animation. Clip editor can import those clips and can run AnimScript for UI purposes. Subsequently, a user can author constraint tags into a clip. Next, the clip can be associated to a clipenv file. Process Constraints can then import the clipenv file, and can learn therefrom about (say) a ped's playing clips. On those clips the user's authored tags can be learnt. Then, for those clips that need additional bake data, Process Constraints add such. Next, a new clip is output with additional metadata from Process Constraints. A script can then be run to remove unused properties. Next, a run compression algorithm can be applied to the output of the script that compresses data exploiting redundancies so it can be stored in a more compact way.

The tools pipeline then continues on. It is noted that, in other embodiments, the run compression stage can come ahead of the stage that removes unused properties.

Conventional tools pipelines are typically bottlenecked by building assets for a game. Although archive files such as Rockstar Advanced Game Engine package format files (RPFs) can be built, such is typically a time-consuming process. Further, although hot loading can be used, the corresponding files typically need to be staged in order for the system to use them when the game is loaded. Also, if there are files in the hotload folder, they will override the RPFs.

In various embodiments, Livestreaming functionality can be implemented. Livestreaming can allow for a user to see changes made in the ClipEditor, and/or to see the outcome immediately in game. Further, Livestreaming can offer benefits including: a) preventing the need to complete a full build to see changes; and b) allowing users to bring constraints into the game without building. Livestreaming can also allow users to stream tagged data that those users author into the game. Before livestreaming uses constraint tags, Process Constraints are run on the tags through a script. Once a user has enabled the “game livestream service” in the clip editor, the Clip Editor UI can reflect changes in the game immediately after they occur in the editor. The way we are able to run un-process-constrained data is by running the livestreaming pipeline on tags before they are brought into the game. Process Constraints can be run in the background when enabled, and tags in the editor can be loaded into the game for a faster iteration for users. Livestreaming has a hook to run a script which makes calls to Process Constraints without requiring the Process Constraints executable (e.g., .exe). The script is run to process the constraints before streaming them to the game.

### Animation Constraints

The retargeting system can use constraints added to animation metadata containers (e.g., clips) in the form of constraint tags, which are constraints metadata. These constraints allow users to express the spatio-temporal relationship between interacting entities and their interacting body parts. Moreover, the constraints reflect the interaction semantics and the users' intent by providing the users with a rich and expressive language.

This generic language allows us to explore animation constraints in an easy and consistent way to identify interacting entities and their body parts. This allows animation systems to access information which was not previously available, and permits new solutions relying on that information, such as:
automatically computing interaction islands to schedule and to deal with multi-character interactions retargeting (see below discussion of Interaction Islands); and
posing only necessary subsets of interaction bounds for efficiency purposes (Recall above discussion for efficient posing and storage of interaction bounds).

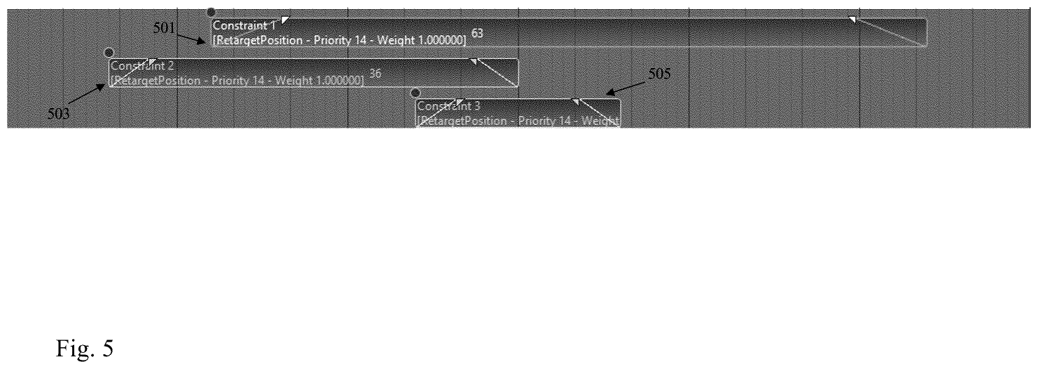

Constraints can describe a variety of relationships. For instance, in an interaction where a character touches its forehead with its right hand, the relationship between the right hand and the forehead can be expressed with a constraint. In case of a weapon aiming interaction, the relationship between the aim direction of the gun and the aimed entity can also be expressed by a constraint. Likewise, the grasp interaction between the hands and the fingers of the character, and the weapon's surface can be expressed by other constraints. In other words, different meaningful aspects of an interaction can be expressed by multiple constraints (see FIG. 5). Those constraints can be used to map the given interactions to characters with different body size and proportions. And, simultaneous satisfaction of those constraints allows the system to preserve those aspects in runtime. This eliminates the necessity of bespoke animations, and therefore the same animation asset can be used for a variety of interactions.

The constraints are not limited to human-like characters. For instance, the users can control how the camera in a scene captures the interacting entities, how the trajectory of a frisbee needs to be adapted depending on the variation in interaction, or how a predator animal devours a victim.

Retargeting constraints are designed to express a variety of relationships. We have four main classes of constraints: position, orientation, aim and limb length. Note that each main class of constraint type has a variety of sub-types to enrich the constraints language. For instance, positional region constraints, which ensure that a body part is contained within a designated region in space, are listed as a subset of position constraints. These are detailed further below.

FIG. 5 depicts a clip with constraint 501, constraint 503, and constraint 505, each with distinct lifespans and easing attributes.

### Constraint Tag Lifespan and Easing

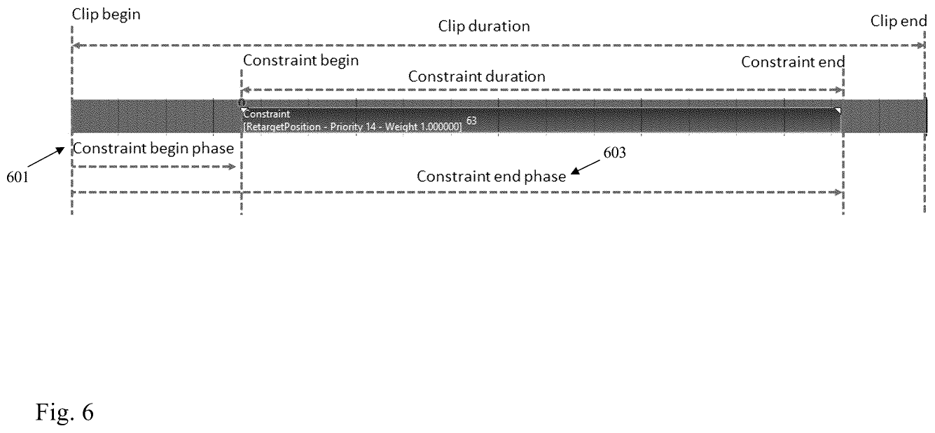

Animation constraints are contained in a metadata container, called clip in our animation systems. A clip can contain multiple constraints, as explained previously. Each constraint tag has a starting and ending phase, each within [0, 1], which indicates the span that the constraint is active within the containing clip. A phase value of 0 means the beginning of the clip, 1 means the end of the clip, and any value in between expresses a point in clip phase coordinates. FIG. 6 illustrates this. In particular, FIG. 6 depicts constraint lifespan in a clip where the constraint's begin phase 601 and end phase 603 are expressed as a percentage of the clip's duration.

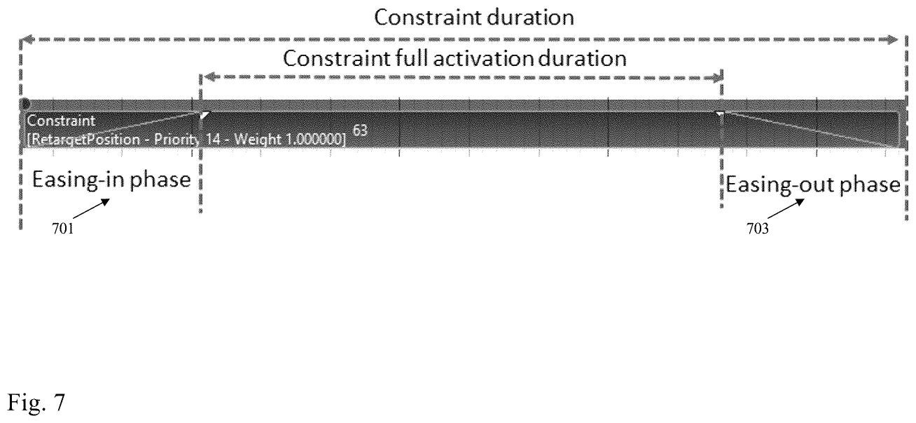

It can be desirable that the constraints in a clip are activated in a graceful manner, instead of an instant full activation. Each constraint stores an ease-in and an ease-out phase which determines the duration where the constraint will be partially or fully activated. Those values are expressed within [0, 1] where 0 is the beginning of the constraint, 1 is the end of the constraint, and any value in between expresses a point in constraint phase coordinates. The ease-in and ease-out behaviours are controlled by different types of easing curves. FIG. 7 illustrates ease-in phase 701 and ease-out phase 703 on a sample constraint. Depicted in FIG. 7 is constraint easing where both ease-in and ease-out types are linear.

Each constraint can also have a maximum weight attribute. This defines the arbitration weight the constraint retains during its full activation period. During the easing-in phase, the constraint's activation gradually increases from zero to maximum weight value, and decreases back to zero during easing-out phase.

### Constraint Priorities for Discrete Arbitration

Under certain circumstances, conflicts can arise when attempting to satisfy multiple constraints simultaneously. As an example, imagine a human-like character standing in front of a deep pit. Imagine further that the character is supposed to reach at a floating object while keeping its feet in contact with the ground. If the floating object is too high for the character, the feet-ground contact constraints conflict with the object reaching constraint, as they cannot be fully satisfied simultaneously. Continuing with the example, approaches by which processes can arbitrate the constraints conflicts include:
(1) Having the character keep its feet in contact with ground while trying to reach at the object as much as possible
(2) Having the character reach at the object while compromising the feet contact so that the character floats in the air
(3) Having the character neither reach at the object nor keep its feet in contact with ground

Each of these alternatives can make sense in different interaction contexts. The first alternative is a conservative choice to keep the character safe, as here the character does not float on top of the pit. The second choice can be desirable, if, say, the character achieving contact with the object is relevant to a gameplay narrative (e.g., where the narrative involves the character reaching at a part of an air vehicle which will subsequently carry the character). Third choice can, in various embodiments, be a default choice (e.g., for circumstances in animation systems when proper layering techniques are not applied).

A user can be allowed to choose a priority value to arbitrate constraints in discrete ways. Continuing with the example, by assigning a higher priority to feet contact constraints, the user can achieve the first result. In contrast, by assigning a higher priority to reaching constraint, the user can achieve the second result. If all constraints have the same priority, the third result is obtained.

By choosing appropriate priorities for constraints, the users can decide on the behaviour of the character in conflicting scenarios. Our system satisfies lower priority constraints without compromising the satisfaction of higher priority constraints (see priority layers solve discussion, hereinbelow).

The priority values can also be used to determine a sequence in the order of constraints resolution, owing to our constraints solving technique. As we handle lower priority constraints prior to higher priority constraints, a user can control the sequence of operations by authoring priorities accordingly. It is noted that this differs from traditional animation layering approaches (see priority layers solve discussion, hereinbelow). Moreover, the priorities can have a global meaning. In other words, they are, in general, not used to assess the constraints of a single character only. In case there is a multi-character interaction, the constraint priority of constraints which impact the poses of all characters are arbitrated altogether (see discussion of simultaneous pose adaptation for multi character interaction, hereinbelow).

The priorities are data driven, thereby facilitating the addition/removal of new priorities depending on the needs of the project. Priorities can have expressive names. Some example priorities we use in our system are (numbered from the least important to most important):
OptionalInteraction
OptionalContact
SecondaryInteraction
SecondaryContact
PrimaryInteraction
PrimaryContact
WeightBearingContact
PhysicalViolation

Between each of the priorities, in various embodiments sub-priorities for facilitating the authoring process can be defined. As examples, sub-priorities are named as:
Lowest
Low
Mid
High
Highest

It is noted that the generic priority names presented above may not have a meaning in every context. As an illustration, the semantics of entering a vehicle can be very different than a character swimming in the sea. Our system allows users to define priority aliases which have mappings to core priorities. Therefore, different systems and interaction scenarios can be arbitrated within the same semantic language, whereas they can be named and in a meaningful way depending on their context using priority aliases.

### Constraint Labels

Despite constraint tags being metadata (expressing the interaction semantics), due to the complexity of the constraints language they carry, circumstances can arise where constraint tags are not easily explored by systems other than the retargeting system itself. To address this, in various embodiments additional metadata can be attached to a given tag. This additional metadata can describe the intent in a generic way. We call such metadata constraint labels. Constraint labels can be added both manually by a user and automatically within the pipeline. An example of an appropriate use case for constraint labels is the constraints filtering performed by game and animation systems. For instance, the user can label a constraint tag “First Person,” which indicates that this constraint is considered only when the characters in the first-person view. Another example use case is for marking up the body parts of a character the constraint will affect. In this way, other systems can filter the constraint tags affecting a particular body part and block those constraints, if necessary, to free those body parts from retargeting operations.

### Constraint Level of Details (Lods)

Each constraint can contain the range of LoDs for which it is to be active. In various embodiments, the LoD retargeting system that runs in the game can be provided by the animation system. The retargeting system can filter out a constraint if the animation LoD in the game is out of the LoD range of that constraint. If that constraint was active previously, (e.g., if the animation system LoD has just changed), the constraint is typically eased out automatically to ensure graceful transitions.

### Constraint Spaces

For being able to describe ongoing interactions, it can be useful for our constraints to refer to any part of an entity, environment or geometry. As just some examples, the entity part can be the belly of a dog, the forehead of a human, a door's handle, different steps of stairs, or an arbitrary geometry whose details are not known in advance. Likewise, the owner of that part can be described in a generic way. For instance, when a constraint refers to the belly of a dog, it is helpful for it to mean the same semantic body part on different dog species. We make use of constraint spaces for this purpose.

A constraint space has three main components (in various embodiments, fewer than all three components can be used):
Owner Role Id
Space Type
Space Identifier (Space Id)

### Owner Role Id

This is the identifier of the owner entity of the referred part within the associated interaction group or default interaction group.

### Space Type

This is the type of the space describing the part. We support the following options:

BoundSurface: The space is constrained by the surface of a bound and is associated with the dimensions of that bound

BoundLocal: The space is expressed in local coordinates of a bound

AliasSurface: The space is constrained by the surface of an alias entity and is associated with the dimensions of that bound

AliasTransform: The space is expressed in local coordinates of an alias entity

AffordanceSurface: The space is constrained by the surface of a bound described by affordances and is associated with the dimensions of that bound

AffordanceTransform: The space is expressed in local coordinates of a bound described by affordances

BoneLocal: The space is expressed in local coordinates of a bound described by affordances

Limb: The space is expressed in a coordinate frame whose origin is the root bone of a limb and the coordinates are normalized based on the extended limb length

Object: The space is expressed in local coordinates of the entity

World: The space is expressed in global world coordinates

Customisable: This is a special space type whose origin, orientation and scaling components are given by the user separately. This space type is the primary type for expressing constraint goal trajectories explained later.

### Space Id

This is the identifier of the space which has its meaning on the entity with given owner role id. The space ids have different types based on the corresponding space type. Table 4 below summarises required space ids for each space type and presents example constraint space types.

TABLE 4
Listing of constraint spaces with examples

| Owner | | | | |
|---|---|---|---|---|
| Role Id | Space Type | Space Id | Example Tuple | Example note |
| Mandatory | BoundSurface | Unique | <Attacker, | Surface of right hand |
| | | Bound Id | BoundSurface, | bound of the attacker |
| | | | IB_R_HAND> | entity |
| Mandatory | BoundLocal | Unique | <Attacker, | Local coordinates of |
| | | Bound Id | BoundLocal, | right hand bound of |
| | | | IB_R_HAND> | the attacker entity |
| Mandatory | AliasSurface | N/A | <SelfGround, | Surface of |
| | | | AliasSurface, -> | SelfGround alias |
| | | | | driven by gameplay |
| | | | | code |
| Mandatory | AliasTransform | N/A | <AimTarget, | Local coordinates of |
| | | | AliasTransform, -> | SelfGround alias |
| | | | | driven by gameplay |
| | | | | code |
| Mandatory | AffordanceSurface | Affordance | <Arm, | Surface of the bound |
| | | | AffordanceSurface, | with Hand |
| | | | Hand> | affordance on Arm |
| | | | | entity driven by |
| | | | | gameplay code |
| Mandatory | AffordanceTransform | Affordance | <Arm, | Local coordinates of |
| | | | AffordanceTransform, | the bound with Hand |
| | | | Hand> | affordance on Arm |
| | | | | entity driven by |
| | | | | gameplay code |
| Mandatory | BoneLocal | Unique | <Defender, BoneLocal, | Local coordinates of |
| | | Bone Id | SKEL_HEAD> | head bone of the |
| | | | | defender entity |
| Mandatory | Limb | Limb Id | <Self, Limb, R_ARM> | Local coordinates of |
| | | | | right arm of the |
| | | | | entity this constraint |
| | | | | is attached to |
| Mandatory | Object | N/A | <Self, Object, -> | Local coordinates of |
| | | | | the entity this |
| | | | | constraint is attached |
| | | | | to |
| N/A | World | N/A | <-, World, -> | Global world |
| | | | | coordinates |
| N/A | Customisable | N/A | <-, Customisable, -> | Origin, orientation |
| | | | | and scaling space |
| | | | | types are given |
| | | | | separately |

### Constraint Coordinates

Each constraint space type has its own orientation, scaling and position characteristics (in various embodiments, fewer than all three characteristics can be used).

### Orientation

Orientation coordinates are stored as a rotational offset with respect to a given parent rotational frame. This parent frame's rotation is computed based on the state of the given space type (recall Table 4). If the space type is not related to a surface, we make use of the rigid body orientation of the given space. If the space type is related to a bound, we require an additional point on the surface from the user and compute the surface orientation by making one of the orientation axes align with the surface's normal.

### Scaling

Different space types can have different scaling factors. For space types associated with a bound surface, the bounding box dimensions are typically used. The other space types typically have their own scaling behaviours. Those are listed in Table 5.

TABLE 5
Listing of scaling behaviours of different space types

| Space Type | Scaling factor |
|---|---|
| BoundSurface | Bounding box dimensions |
| BoundLocal | Bounding box dimensions |
| AliasSurface | Bounding box dimensions |
| AliasTransform | If there is an associated shape, bounding |
| | box dimensions. Otherwise scaling |
| | coefficient of the alias transform. |
| AffordanceSurface | Bounding box dimensions |
| AffordanceTransform | Bounding box dimensions |
| BoneLocal | Bone length |
| Limb | Limb's extended length |
| Object | Body scaling of the entity |
| World | No scaling is applied |
| Customisable | Scaling factor is computed from the scaling |
| | type chosen for the customisable space |

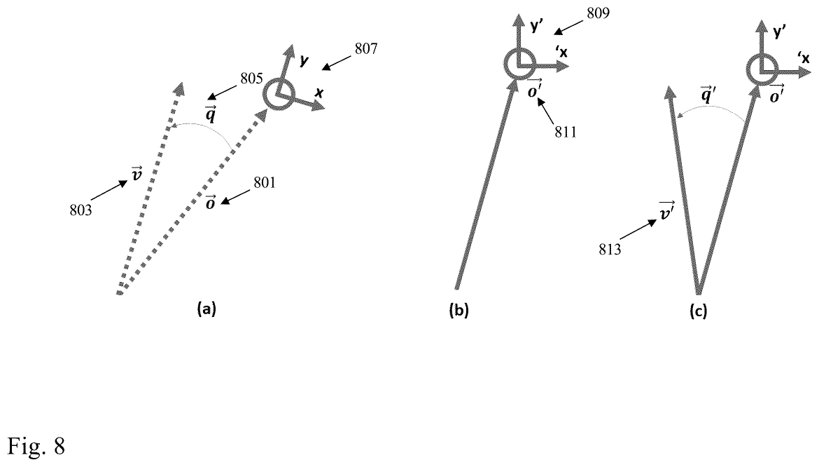

It is usually the case that retargeting constraints do not express a static relationship to aim exactly at a given point. They are rather used to express a changing offset with respect to the point to be aimed at. It is for this reason that various embodiments utilise aim coordinates. Utilising aim coordinates, we can express this deviation in a systematic way and make use of it to retarget aiming at different targets. The aim coordinates are expressed with respect to an aim parent space. The origin of that space is the centre of the aimed target and, the orientation and scale components of the parent space determine the offsets with respect to that origin. We express an aim axis with respect to that aim parent space to be able to reproduce the relationship in between for retargeting purposes. Thanks to that reproduction, we can infer the desired positions to aim at given the origin of a new aim axis and aim parent space. The decomposition of aim coordinates in a source interaction and its composition on a target interaction to retarget is summarised in FIG. 8.

Aim coordinates are typically stored as angular deviations between the vector connecting the aim origin and the origin 801 (o in FIG. 8-a) of the aim parent space, and the aim axis 803 (v in FIG. 8-a). This angular deviation is computed from the direct rotation 805 (q in FIG. 8-a) aligning these two vectors, from o to v, within the local coordinates of aim parent space, (depicted as x-y axes 807 in FIG. 8-a). This offset is used later to determine where to aim at when a new aim parent space is given (x′-y′ axes 809 in FIG. 8-b). This offset is used to rotate the new vector connecting the aim origin and the origin of the aim parent space 811 (o′ in FIG. 8-b). We compute the point to aim at by adding that rotated vector 813 (v′ in FIG. 8-c) to the origin of the aim axis.

FIG. 8 depicts aim coordinates decomposition and composition steps. The dashed arrows show the original aim interaction from which the aim axis offset is computed. Turning to FIG. 8-a, the direct rotation, q (805), to align the vector connecting the aim origin and the origin of aim parent space, o (801), and the aim axis, v (803). This direct rotation is stored as a local offset in the aim parent space. Given a new aim parent space, the direct rotation offset is used to rotate the vector connecting the aim origin and the origin of the aim parent space is rotated with the stored direct rotation offset q (805) to compute the retargeted aim axis v′ (813). Note that this operation is done in local orientation space of the aim parent space so that that parent space's orientation impacts the aim offset.

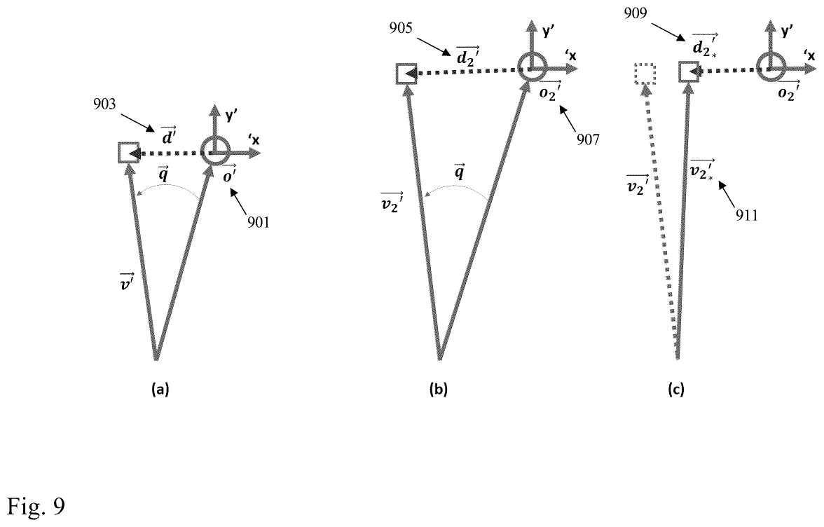

It is noted that mapping angular deviation results in different deviations between the goal position to aim at and the aim parent space's origin, depending on the distance between the aim axis origin's distance to the aim parent space origin as illustrated in FIG. 9. This is not always desired. For instance, imagine a case where a character sprays some water to the surface of a window to clean. In this case, it would be undesirable to preserve the angular deviation where doing so would result in the displacement being beyond the window, as the outcome would be the character spraying the water out of the window boundaries. To combat this, we store the length of the vector from the aim origin to the origin of the aim parent space in the original interaction 901 (o′ in FIG. 9-a). In this way we can adjust the length of the vector from the aim space origin to the aim target accordingly (FIG. 9-c).

FIG. 9 depicts the distance between the aim origin and aim parent space origin impacts the distance between the point to aim at (shown as square) and the aim parent space. Aiming based on a closer aim parent space (FIG. 9-a) results in a shorter variation than aiming at a further aim parent space (FIG. 9-b), d′ 903 and d′₂ 905 respectively. Accordingly, we have an option to adjust the length of vector d′₂ 905 based on the ratio between the original distance between the aim origin and aim parent space origin, o′ 901 and o′_{2*} 907. We end up with the final point to aim at, d′_{2*} 909, and its corresponding retargeted aim axis v′_{2*} 911.

To summarise, the system follows the following steps for the mapping of the aim coordinates:

The vector connecting the aim axis origin and the aim parent space origin is rotated by stored angular deviation:

$$\vec{{v}_{2}^{′}} - Rotate ( \vec{q} , \vec{{o}_{2}^{′}} )$$

The displacement vector between the aim parent space origin and the transformed aim target is calculated:

$$\vec{{d}_{2}^{′}} - \vec{{v}_{2}^{′}} - \vec{{o}_{2}^{′}}$$

This displacement vector is scaled inversely proportional to the distance between the aim axis origin and aim parent space origin:

$$\vec{{d}_{2 *}^{′}} = \vec{{d}_{2}^{′}} \frac{\vert \vec{o} \vert}{\vert \vec{{o}_{2}^{′}} \vert}$$

Finally, the target aim axis is calculated by adding that scaled displacement vector to the aim parent space origin:

$$\vec{{v}_{2 *}^{′}} = \vec{{o}_{2}^{′}} + \vec{{d}_{2 *}^{′}}$$

Note that between step 3 and step 4, the scaling of the aim parent space can also be applied. This allows the displacement offset d′_{2*} to be adjusted to the dimensions of the window, in the example of spraying the window.

### Position Coordinates

According to the functionality discussed herein, position coordinates are generally stored in three forms. If the space type is not associated with a bound surface, the coordinates are stored in Euclidean form expressed with respect to the coordinate frame centred at the given space. For instance, if the space type is World, the position is a displacement with respect to the world's origin expressed in world coordinates. If the space type is associated to the surface of a bound primitive, the coordinates are stored in different types of shape surface coordinates depending on the choice of the user. We will first present three shape surface coordinates to express a point on surface prior to customisable position coordinates.

### Normalised Surface Coordinates

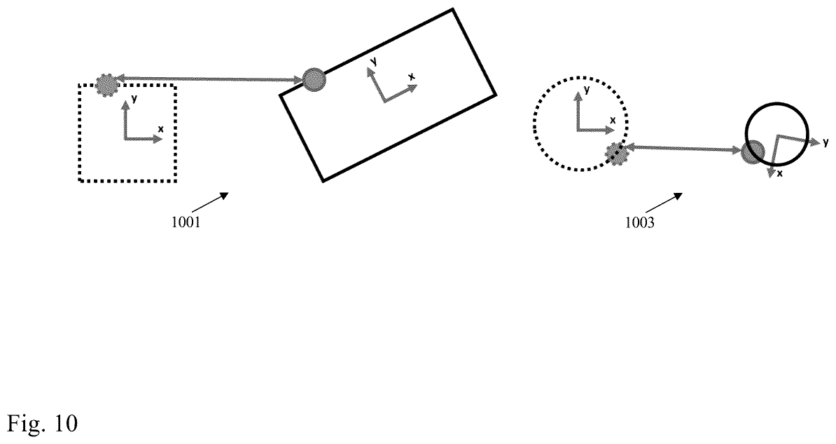

Normalised surface coordinates depend on the type of the shape primitive representing the surface. If the surface is a sphere, we store the coordinates in spherical coordinates. If the primitive is a box, we store them in normalized box coordinates. This allows us to have a one-to-one mapping between the shapes of same type with varying dimensions by reproducing the points on the surfaces (FIG. 10). We support normalized surface coordinates for all bound primitives used in our system.

FIG. 10 depicts normalised surface coordinates mapping on boxes (1001, left) and spheres (1003, right). The stored points are affected by the rotation of the shape. Note that coordinate axes (x-y) are placed in the centre of the shapes to highlight the rotation.

### Axis Coordinates

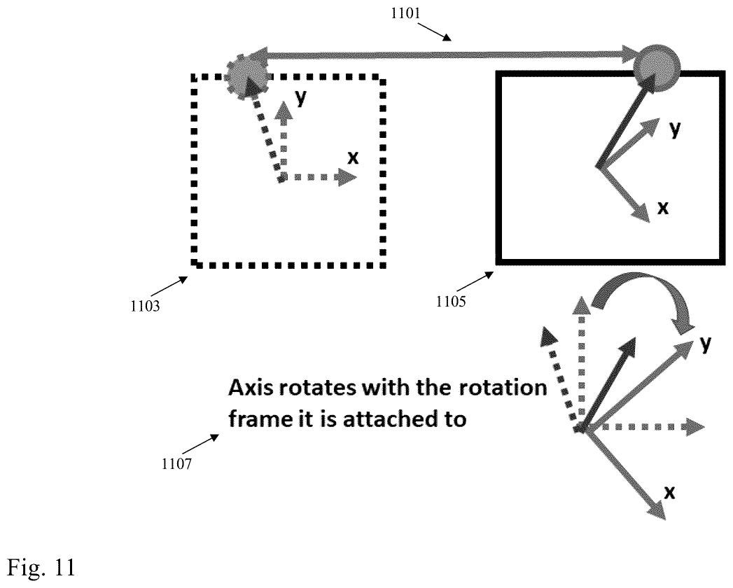

Given an axis centred at the origin of the shape, axis coordinates are converted to a point on that shape's surface by casting the directed ray corresponding to that axis on the surface (FIG. 11). Axis coordinates are flexible, because the axis can be expressed in another rotational frame, and therefore the axis' orientation can be decoupled from the shape's orientation. Moreover, unlike normalized surface coordinates, axis coordinates can be reproduced on any given shape easily, as they are independent from the shape types.

FIG. 11 depicts axis coordinates mapped (1101) between box 1103 and box 1105. The stored points are affected by the rotational frame axis is attached to (1107). Note that rotational frames (x-y) are placed in the centre of the shapes to highlight it rotates independently than the shape.

We, optionally, normalise the axis' dimensions by the bounding box of the original shape, and scale it with the target shape's dimensions before casting the corresponding ray. This allows axis coordinates to be reproduced considering the shape dimensions. This option is useful when axis is not associated with another rotational frame.

### Projection Coordinates

Projection coordinates can be obtained by projecting a given point onto the surface of another shape. The resulting projected point can be converted to other shape surface coordinate types to preserve particular aspects, depending on a user's choice.

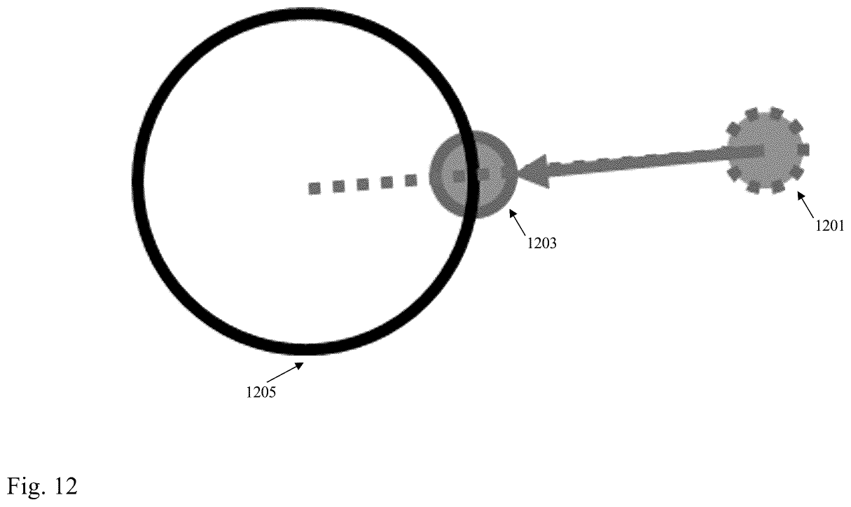

As depicted by FIG. 12, projection coordinates are obtained by computing the closest point 1201 from a point 1203 to the surface of the given primitive 1205.

### Customisable Coordinates

To express the relationship between a point and a surface, we make use of customisable coordinates. These coordinates have separate origin, orientation and scaling components where:
origin is either the origin of any space type which is not associated with a surface, or one of the shape surface coordinates
orientation and scale components are set up by selecting the options presented above

Any given point in space can be expressed in customisable coordinates, and stored as a normalized displacement offset with respect to the origin. Note that the origin's computation can depend on this given point, and this dependency handled properly. The normalization operation takes place based on the selected orientation and scaling components.

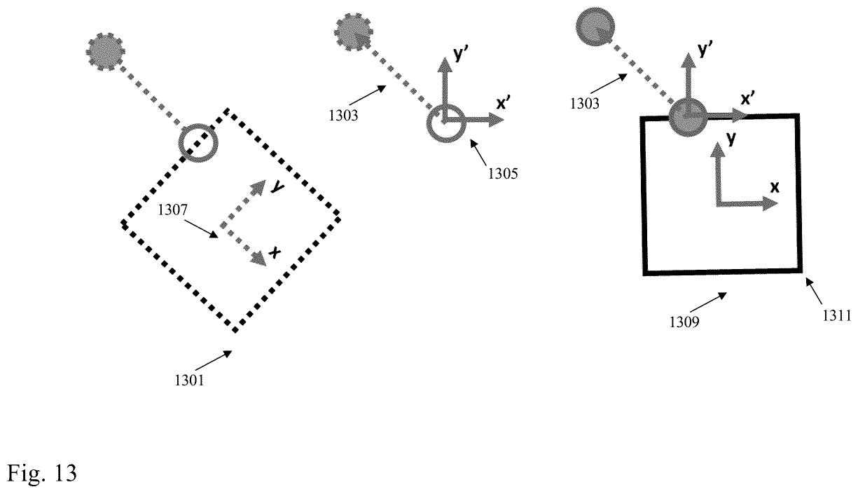

FIG. 13 explains the expression of a point in customisable coordinates where origin is given as projection coordinates (with normalization type of normalized surface coordinates) of the given position, orientation and scaling components as expressed in world. At the first step, the given point is projected to the surface to compute the origin component of the customisable space. The resulting displacement vector is computed by connecting the origin to the given point. At the second step, the displacement vector is stored in local coordinates of the given orientation space and these local coordinates are normalized by scaling coefficients associated with the scaling component. Note that in this example world space is used to keep the displacement vector as is, for ease of illustration. At the last step, we first reproduce the origin point on the target shape. After scaling the normalized displacement vector with the scaling component of the customisable space and orienting it depending on the state of the orientation component, we add it to the origin to finish mapping of the given point.

FIG. 13 depicts customisable coordinates computation and mapping steps. Shown is origin computation step 1301. Also shown is the resulting displacement vector 1303 with respect to the customisable space 1305 whose orientation is noted (x′, y′), which is distinct from the box's orientation 1307 (x, y). At 1309 the origin is reproduced on another box 1311, and the displacement vector 1303 is added to it to complete the mapping.

### Constraint Trajectories

In discussing constraint spaces and constraint coordinates above we expressed how a single position and orientation can be expressed in our system. However, retargeting problems can regard spatio-temporal relationships which require expressing sequences of positions and orientations in time. We call those sequences constraint trajectories, and our animation retargeting techniques can utilise them.

Constraint trajectories allow us to store and map moving relationships. The trajectory of a moving part's position and orientation can be expressed with respect to constraint spaces. Note that the parent constraint spaces can also be moving as a part of the moving relationship, and there can even be cyclic dependencies between moving parts; the relationship between hands clapping is an example of this. There are several considerations when expressing such relationships.

First, a continuous trajectory in an original (source) interaction should typically still be continuous when it is mapped on a target interaction to preserve temporal properties. Constraint coordinates present a way to express, positions, orientations and aim trajectories in a continuous way, as all space types we present are built in a continuous way, given that our bound primitives are convex.

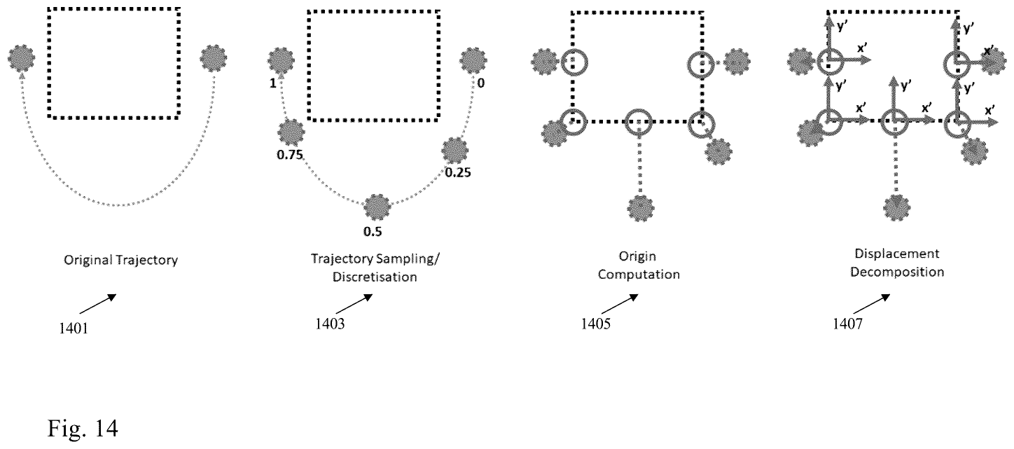

Second, a position trajectory should typically not present artefacts such as penetration into volumes. Expressing a trajectory in customisable coordinates whose origin is associated with the surface of such a volume allows the users to achieve this. FIG. 14 presents the decomposition steps of a given position trajectory based on the surface volume of a given shape. Shown in FIG. 14 is original trajectory 1401. At 1403, trajectory sampling/discretisation is performed. Further, at 1405 origin is computed. Also, at 1407 displacement decomposition is performed.

### Position Trajectory

The original trajectory is first discretized based on a sampling strategy, and each sample is associated with a phase value within a range [0, 1] expressed in relation to a tag's begin and end phases (recall above discussion of Constraint tag lifespan and easing, where a sample with 0 corresponds to the beginning of the trajectory and a sample with 1 corresponds to the end of the trajectory). Then, the corresponding origin is computed on the surface for each such sample and their displacement vectors are decomposed with respect to the origin point based on the orientation and scale spaces selected by the user. In this example: a) projection coordinates expressed in normalized surface coordinates are used for origin; b) the bound local space of the box is used for the orientation; and c) the world space is used for scaling to keep the displacement vectors unchanged when they are mapped. This gives us two trajectory sequences, one for the origin and another one for the displacement vectors, both associated with the sample phases. Depicted in FIG. 14 are trajectory decomposition steps.

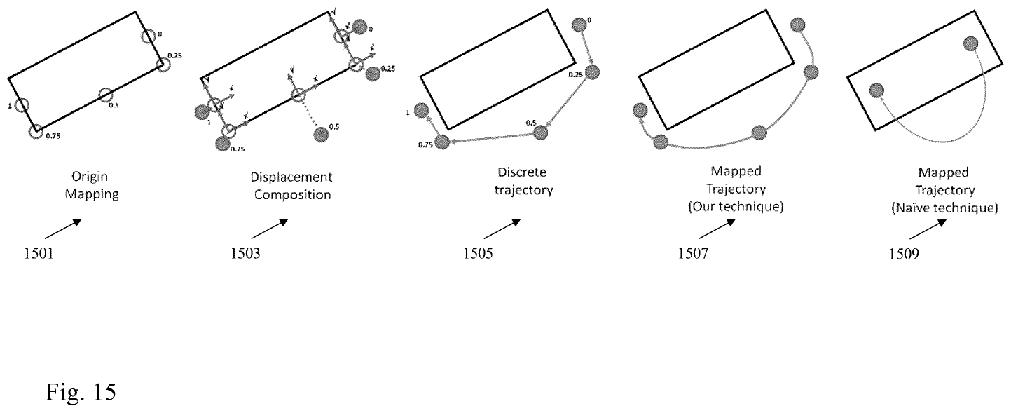

The reproduction of the trajectory on another shape starts with mapping the normalized shape coordinates stored for origins. By adding the displacement vectors after composing them based on the mapping context, a series of points results, in particular a series of points which forms a discrete trajectory upon connecting those points. With a sufficient number of such samples, a high-resolution trajectory is obtained. Using this technique we prevent the trajectory from penetrating into the shape, unlike a naive approach which stores and maps the trajectory based on the shape's orientation. Depicted in FIG. 15 are position trajectory composition steps. Included in FIG. 15 are origin mapping 1501, displacement composition 1503, and discrete trajectory 1505. Also shown in FIG. 15 is a mapped trajectory according to the approaches discussed herein 1505 versus a mapped trajectory according to a naive approach 1505.

### Orientation Trajectory

An orientation trajectory can be expressed as a changing quaternion offset measured with respect to the parent space's orientation. Likewise for position trajectory, these offsets are each paired with their corresponding tag phase value and stored as a phase-key pair. These orientation trajectories can then be adapted for retargeting purposes by adding those measured offsets on top of the parent space's orientation.

We also give a user the option to store those offsets in a different parent space. This functionality can prove helpful in dealing with additive constraints. For instance, an orientation constraint can be set up to compute the orientation offset of a bone with respect to its base pose. Then this offset's rotation axis can be transformed and stored in another space without changing the angle of rotation. In the game, this rotation offset is adjusted based on its parent space, and can either be added on top of the current state of the end effector if the user marked that constraint additive, or otherwise on top of the current rotation of the parent space.

### Aim Trajectory

As referenced above when discussing aim coordinates, aim trajectories are typically expressed as a sequence of the angular deviation in quaternion form. Further, the distance value for each stored key can be saved, for instance when requested by a user. The saved distance value can be used for adaptation purposes as explained above when discussing aim coordinates. As an example, the user can make this request where they would like to map trajectories Independently from the Distance to the Aim Parent Space.

### Trajectory Storage, Compression and Interpolation

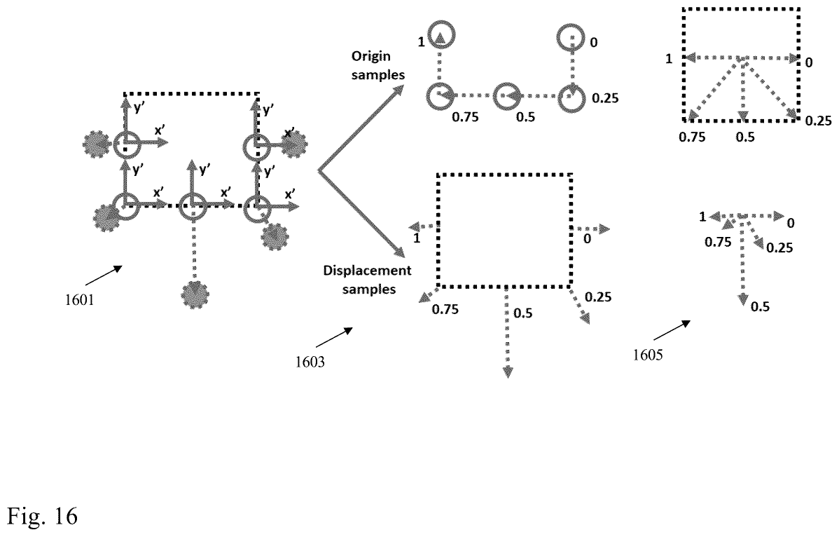

As discussed, each sample point on a given trajectory can be decomposed to its origin and displacement vector components. These two components are stored separately based on their corresponding phase values. In this way, two trajectories are made: one for the origin, and one for the displacement vectors (see FIG. 16). In various embodiments, these two trajectories are then compressed using the Ramer-Douglas-Peucker algorithm to decimate redundant samples, prior to storing them separately.

At step 1601 a set of points 1601 after origin computation and displacement vector decomposition. FIG. 16 also depicts origin and displacement samples being grouped (1603) in two different tracks with their corresponding phase values. FIG. 16 additionally depicts origin samples being stored (1605) in normalized coordinates (in this example, box coordinates displaced on a unit box). Displacement vectors are shown by making them share the same origin.

The stored origin and displacement vector tracks can be queried separately using the phase values. Given the phase value, we first find samples with the closest phase values for both the origin and displacement vector components. Then, each component is interpolated based on the phase proximity. The interpolated displacement vector is added to the origin to compute the resulting mapped point for that phase. In this way, a continuous trajectory can be formed by computing the points corresponding to the varying phase values.

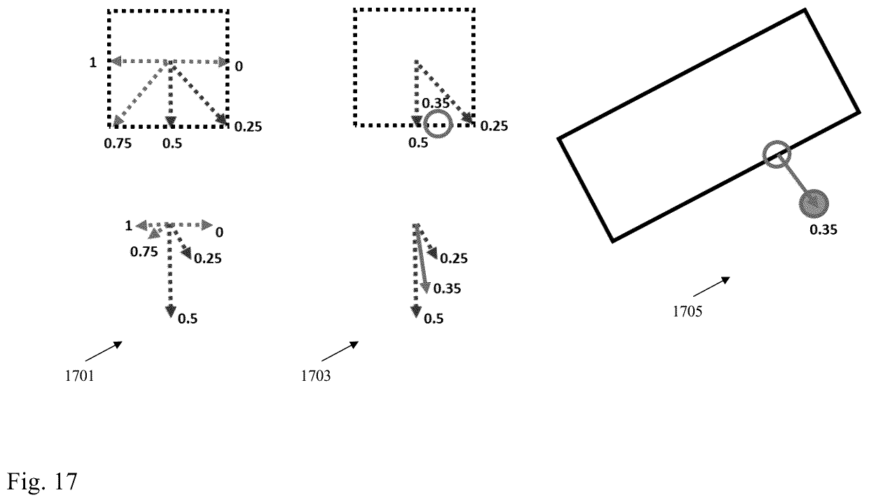

FIG. 17 depicts a trajectory querying and composing example for phase value 0.35. At 1701, closest samples from the origin (top) and displacement vector (bottom) trajectories are queried. At 1703, those samples are interpolated based on phase value proximity, and origin coordinates are interpolated on the surface of the shape. Further, at 1705, the interpolated origin vector is mapped on a target shape, and by adding the displacement vector the mapped point for the given phase is computed.

### Constraint Types, Goals, End Effectors, and Skeletal Chain

The retargeting system supports four main constraint types. The four main constraint types are:

Position constraints, to express positional relationships, such as holding an object

Orientation constraints, to express orientation relationships, such as the alignment between objects

Aim constraints, to express the deviation between an aim axis and its target

Distance constraints, to keep body parts at desired distances with respect to each other

A constraint typically has three main components defining what the constraint wants to achieve and how it should be carried out. In generic terms, a constraint is achieved when the state of its end effector is aligned with the goal, and typically only the desired skeletal chain is used for this purpose. These components are used for position, orientation and aim constraints.

The end effector is the interacting part and the goal is the interacted part. For instance, a constraint can be set up to bring the right hand of a character onto a door handle. In this case, the right hand is the end effector and the door handle is the goal. The bones which are responsible for the satisfaction of this constraint are given by the skeletal chain.

The skeletal chain is defined by the ids of the first and last bone on the chain. For instance, in the example of right hand/door handle interaction, if we want only the arm bones to join the interaction, the first bone is described by the id of the right upper arm bone and the last bone is described by the id of the right hand.

The end effector and the skeletal chain do not necessarily belong to the same character. This is common for constraints dealing with the pose of the character based on a prop attached to that character. For instance, an aim constraint can be set up to pose the character to point the weapon the character is carrying at a target.

It is also possible that the bone that an end effector is rigidly attached to is a descendant of the distal bone of the skeletal chain. This is the case when the constraint demands to keep the pose of the bones between the distal bone of skeletal chain and the end effector. In our system, we call such constraints parented constraints.

With reference to the following table, the data coordinates carried by the end effector and the goal vary depending on the type of the constraint.

TABLE 6
Constraint types and their end effector and goal data

| Constraint Type | End Effector | Goal |
|---|---|---|
| Position | Position | Position |
| Orientation | Orientation | Orientation |
| Aim | Aim axis and its origin | Position |
| Length | Skeletal chain | Distance |

The internal data carried by an end effector and goal is determined through sub-selections made by the user. We support six main sub-selections which are chosen separately for the end effector and the goal:
1) Is it static or a trajectory? This determines if the internal data represents a static point invariant to the phase of the tag, or if it is a trajectory whose value changes over the phase of the tag as discussed hereinabove in connection with constraint trajectories.
2) Is it baked or dynamically computed in retargeted interaction in game? This determines if the data is computed offline and baked in metadata based on the source interaction, or if it is computed dynamically based on the interaction to retarget in the game. If it is dynamically computed in the game, the user is presented with the options to decide when this relationship is computed and baked. We allow the user to choose the options of.

Based on input pose

Based on the state of the constraints solve, by specifying the main solve step and the priority layer for which it takes place.
3) Is it valid on a single point or on a region? This indicates whether only a data sample is accepted, or whether the definition is relaxed based on a range or region.
4) Region boundaries and valid side (applicable when the data is a region): If the data is a region, there is call to define the valid range of data samples. This is done in different ways depending on the type of the data:

If it is a position region, there is call to define the boundary type and the valid side. We support all primitive shape types to indicate the region boundary. The valid side of the boundary can be selected among three options: surface, inside and outside.

If it is an orientation region, the valid region is defined by an angular variation.

If it is a distance region, the valid region is defined by minimum and maximum allowed distance values.

5) Is the constraint applied additively? This indicates if the displacement components computed for the goal are added to the current state of the end effector, or if it is added to the parent orientation space.

6) Are trajectory displacement offsets captured in another space? If true, the displacement offsets are measured with respect to another space, but transformed and stored in the parent space they will be applied.

### Constraints Processing and Automation

Constraints are processed in the animation build pipeline. In it we perform:
Computation of missing information
Basic information, such as bound types
Trajectory computation
Computation of supplementary metadata
Labels—to make constraints easily understandable by other game systems
IK chain labels
Mover labels
Beyond the trajectory computation, this involves the addition or removal of properties based on conditions (e.g., IKC_* labels are added based on the end effector and deepest ascendant).

### Additives

Certain interactions work based on offsets to be added on top of the current pose of the character. An example of this is the recoiling motion that happens after a gun is shot. Handling additives can require special care. In particular, handling additives is not only about computing an offset based on a parent constraint space, and adding the offset aligning the end effector to a position/orientation offset from a parent space. Instead, handling offsets involves adding the offset on top of the current state of the end effector in the game during the solve.

We allow the computation of additive offsets in our tools pipeline in two ways:

The animators can export the base animation on a separate entity with a dedicated role id

We have a reserved role id SelfBase in our tools which refers to the first frame pose of the entities, so that the rest of the animation can be expressed additively based on the special SelfBase pose.

The additive constraints are set up by capturing the end effector's deviation with respect to corresponding bone's state in base animation or SelfBase. The application of that offset in the game can also be based on a changing dynamic. For instance, it can be desirable to adjust the direction of recoil in the game based on the shooting direction. Therefore, the user is also allowed to choose an additive application space so that the additive offsets can be adjusted to the application parent space.

Note that additives are not specific to animation constraints authored offline by animators. They are useful for in-game systems to demand additive changes to the pose, as well. An example use of this is to deal with secondary motion. For instance, the secondary motion system can run a physics simulation to determine the desired changes to be applied to the input pose of the character during a bike ride. Then the simulation results can be translated to additive animation constraints to be applied additively by the run time retargeting solver.

### Constraints Authoring

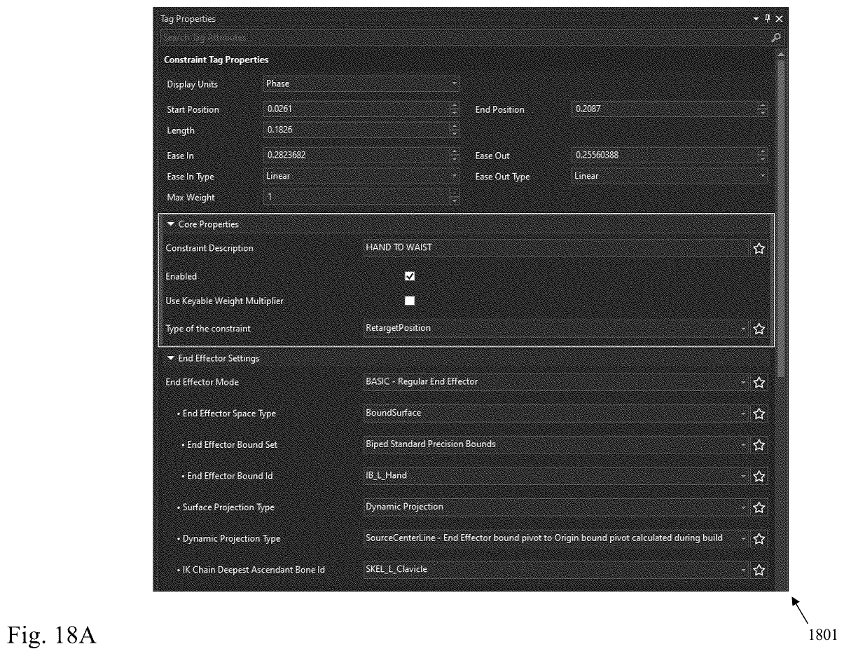

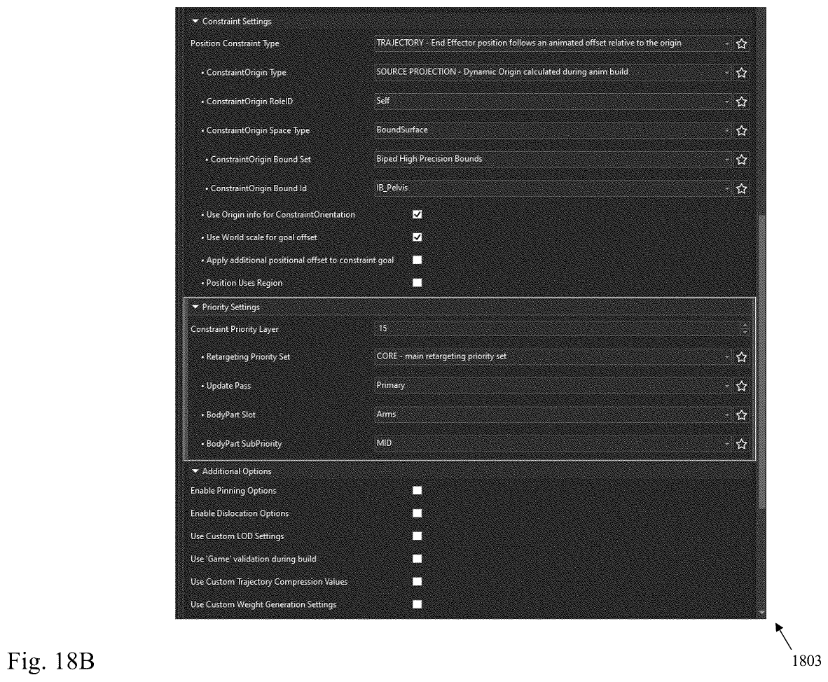

With reference to FIG. 18A and FIG. 18B, retargeting constraints can be authored using the ClipEditor metadata authoring tool. The animators can mark up the constraints associated with the corresponding animation assets so that they can be enforced in the game. The ClipEditor saves the constraints as constraint tags which are saved in clip metadata files bundled with the corresponding animation asset.

As retargeting mark-up can be complicated and can have many optional properties, it can be a challenge to code the mark-up so as to result in a meaningful constraint. As such, according to various embodiments a dynamic user interface to channel the animators to mark constraints up correctly can be provided. This dynamic user interface is typically controlled by AnimScript. Further, the dynamic user interface can, as just an example, be maintained by animation and code teams collaboratively. FIGS. 18A and 18B present screenshots 1801 and 1803 of the ClipEditor UI when used for constraint authoring purposes.

It can be the case that complex interactions require many constraints, as multiple aspects of the interaction can need to be preserved when retargeting the animation assets. Moreover, it can be the case that assets which are related to each other need to be marked up consistently, especially to make sure that they can blend together in a natural way. Likewise, it can also be the case that some modifications are needed for retargeting already authored constraints to multiple related assets. Under such circumstances, it can be non-trivial to apply the same modification on all related assets. For these reasons, authoring and maintenance problems that can hamper the production of retargeting assets at scale can arise. We tackle these problems in the following two ways (it is noted that these two ways are discussed in greater detail below):

We make use of tag templates, which are used to share complex constraints setups across multiple animation assets

We make use of constraints automation techniques to facilitate authoring by generating and automatically filling in properties of constraints

### Tag Templates

Tag templates are used to share constraint set ups, such as complex constraint set ups, with a wide range of users.

Tag templates are a collection of animation tags that have meaning, and that have been given a reference name. A user can add a tag template in the same way a tag is added, by selecting the name from a list and clicking on a timeline to place it thereon. Similar to a tag, the start and end time can be modified, as well as any ease in or out values.

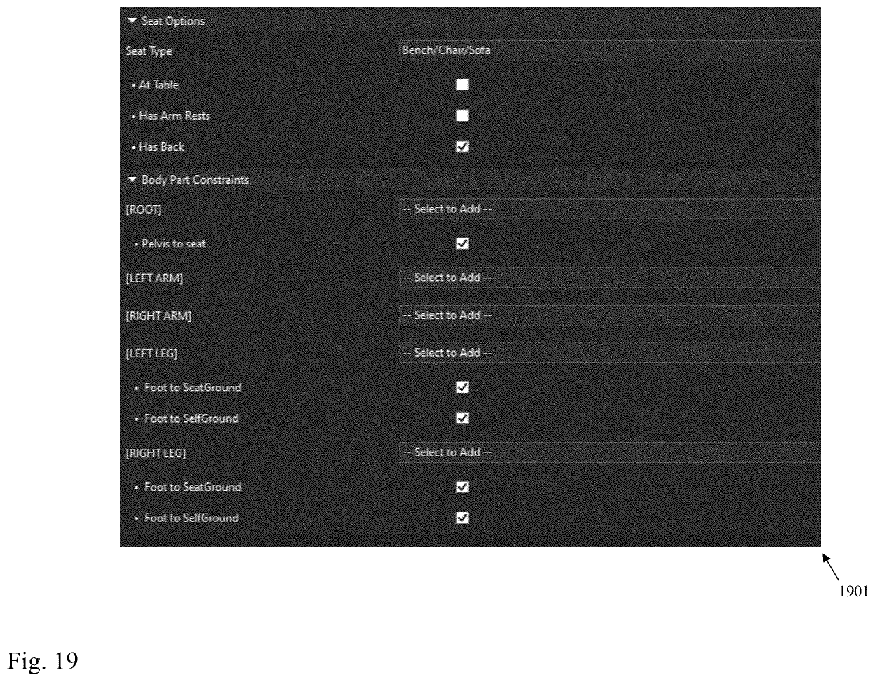

These tag templates can be wide collections of constraints used to mark up whole situations in one pass. For instance, we have a single tag template setup for seated conditions that has over 20 individual possible constraints that can be brought in and out. A single animator is not, for example, required to create these 20 different sets of settings each time they tag a seated situation. Instead, with constraints, they can bring a single tag template in and work at a higher level. As just some examples, such work at a higher level can include the setting of activation start and end times for semantically meaningful concepts, such as “Right Arm on Armrest” or “Left Hand on Left Thigh”. Such functionality is depicted via screenshot 1901 of FIG. 19.

Aside from the benefit to the animators' time, there is also the benefit of there being interface to these groups of situational constraints, thereby allowing for improvements in the application of this intent over time. For instance, suppose that a new low-level retargeting feature is added to the system and that it is useful for the seated case. Here, instead of having to individually address each seated situation and change the tagging to make use of the new feature, change can be done once to the corresponding template, and then that update can propagate through all animation clips that make use of the template.

Template functionality can be highly beneficial, for example, under a circumstance where complex data is to be marked up in potentially hundreds-of-thousands of clips while maintaining at least some consistency. As another benefit, template functionality can also makes it more straightforward for more senior users to assist more junior members of the team, as the templates can be set up and validated by the senior users. The senior users can be given access in the interface to advanced constraint tag interface options. Further, the interface exposed to the junior users can be more straightforward and streamlined, thereby facilitating the more junior users making fewer mistakes.

Tag template functionality can include:
Being able to take a snapshot of one or more tags in a timeline, including all the current settings on those tags
Being able to store the relative timings of those tags in a normalised fashion.
Being able to name the template.
Allowing for template storage in XML format, with a version number. The version number allows backward compatibility of previously saved tag template instances once a template is updated and associated with a new version number. Likewise, the users can update those previously tagged clips to newer versions automatically with the option of batch processing all related assets.

In various embodiments, additional template functionality can include:
AnimScript—a C#based scripting language as detailed above—can be used to read properties from a template tag, perform operations on them, and apply new properties based on those operations to the child tags. Such functionality can be used, for instance, for complex relationships between attributes on the Template Tag and the constituent tags in the template (known as child tags), Also in this way, drop-down combo boxes can be populated and filtered by the existence of values in other attributes.
Hiding and displaying of optional attributes.
Addition of support for keyable attributes, the keyable attributes being keyed animation curves with tangents that can be used to describe the weight of child constraints at each moment. This can provide benefits including simplifying markup for general animators, as these developers typically are experienced in working with animation curves.

### Constraints Authoring Automation and Constraints Generation

Tag templates offer a great convenience for the animation team to mark up their contents with animation constraints in a consistent and scalable way. However, it typically still requires manual input from the users. According to various embodiments, the process can be automated.

According to a first approach, there is automatic generation of keyed weight curves for template child tags to enable and disable only subsets of them, with easing based on the context of the interaction. A template has a set of child tags, which are sub-groups of tags where each sub-group is controlled through the same weight curve for simultaneous activation and deactivation of these constraints. For instance, in an interaction where a character is riding a bike, a tag template can be created with separate sub-groups of constraints for the interaction of the left hand and the right hand with the handles of the bike, together with corresponding finger constraints for grip interaction. Here, we can generate the weight curves for each hand based on the asset that the template is using, by making use of a proximity evaluation between interaction parts of the entities. For instance, for a bike ride entry animation where the character holds only the right handle of the bike with the right hand, our automated analysis can gradually enable right hand sub-group of constraints to ensure contact and its timing, whereas left hand constraints can remain deactivated until there is left hand interaction. We make that proximity analysis for position, orientation and aim constraints. Different types of constraints can be stored within the same sub-groups of tags, as well. As such, we arbitrate the measured proximities of different types of constraints. The proximity analysis relies on heuristics controlled through pre-defined thresholds which can be overwritten within the template by a user depending on the use case. In this way, different thresholds can be used to tackle different assets using the same template.

The second approach facilitates authoring end effector and goal origin offset computations, so that a user need not enter any normalized offsets manually. An authoring set up can be provided so as to allow the user to enter a normalized position offset manually, such as for defining the end effector's location on its parent space. We offer an option to pick these offsets automatically relying on proximity evaluations. These evaluations are done by measuring the displacement between interacting volumes where interaction happens between bound primitives. Subsequently the system chooses those offset value(s) that it determines to be best, thereby ensuring the contact between those bound primitives.

According to a third approach, interaction analysis applications can be extended to automatically offer constraints to facilitate the creation of tag templates. In this way, the user can automatically be presented with a set of constraints which can be further fine-tuned by the user. Note that this does not require the use of existing authored assets, and can be accomplished based on introduced heuristics (e.g., akin to approaches followed for authoring automation techniques as discussed summarised earlier).

According to a fourth approach, machine learning techniques can be applied to assets authored with animation constraints to learn and model our expressive language. This allows us to extend the use of animation constraints to interactions which have never been seen or used before by the system, and will require minimal interaction by users (e.g., with such users only needing to interact where fine tuning is necessary).

It is noted that this machine learning approach is different than various machine learning approaches used for animation retargeting purposes. In particular, those approaches differ at least insofar as they attempt to learn how to model ongoing interactions in an unstructured way using unsupervised learning techniques, or based on pre-defined heuristic features or parameters. As such, those approaches results in black box models whose application is limited to subsets of interactions which are both difficult for users to understand, and unaccommodating to intervention by those users. Those approaches therefore can result in high production risks when producing, say, a large-scale game (e.g., a large-scale sandbox game).

In contrast, the machine learning of the fourth approach can leverage, for instance, the functionality described herein wherein animation constraints provide a working language for expressing interactions in human-understandable ways. The machine learning techniques of the fourth approach can therefore advantageously work with respect to animation constraints. From this, benefits can accrue including but not limited to machine learning outputs expressing generated interactions in terms of the animation constraints language, the outputs therefore being straightforward and readily controlled by users by modification of the resulting generated assets (e.g., animation constraints generated by a machine learning model).

### Camera Retargeting

There can be call that retargeting be performed for the cameras in the game, such as when the subject(s) of a shot can vary. In this case, we have two approaches:

Camera screen space constraints—Describe one or more points on one or more subjects in screen space, and then preserve them at runtime.

Camera mover constraints—Describe the transform of the camera with respect to other entities in the game world, and then preserve this at runtime.

### Camera Screen-Space Constraints

ScreenSpace is a common representation of points in a 3d world relative to a virtual camera.

ScreenSpace has three dimensions:

X—The position on screen in the horizontal axis. On screen it typically ranges from 0 (fully left) to 1 (fully right), but this coordinate system typically continues on outside of the visible region of space.

Y—The position on screen in the vertical axis. On screen it typically ranges from 0 (full up) to 1 (full down). Similarly to X, it typically continues on past 0 and 1 outside of the visible region of space.

Z—The distance into the screen. This is a projection onto the forward vector of the camera of a point in the game world.

To preserve a point, we can:
1) Define the point in a generic way such that we can discover it again at runtime
2) Calculate the ScreenSpace coordinates.
3) Store and retrieve the ScreenSpace coordinates.
4) Move the camera such that it can focus on the target points at the given ScreenSpace coordinates

We can perform these operations via a tag on the camera animation, which we call the CameraScreenSpaceConstraint tag. The four operations will now be discussed in greater detail.

### 1) Define the Point

To define the target point to preserve, we describe it by an entity in the ClipEnvironment and a point on that entity. The entity is defined by the RoleId. The point is defined by either:
A bone (using the boneid)
A bound and normalised coordinate to give a point on the surface
An entity transform

In certain aspects, this works similarly to standard constraints. The world position can be extracted for either of these cases.

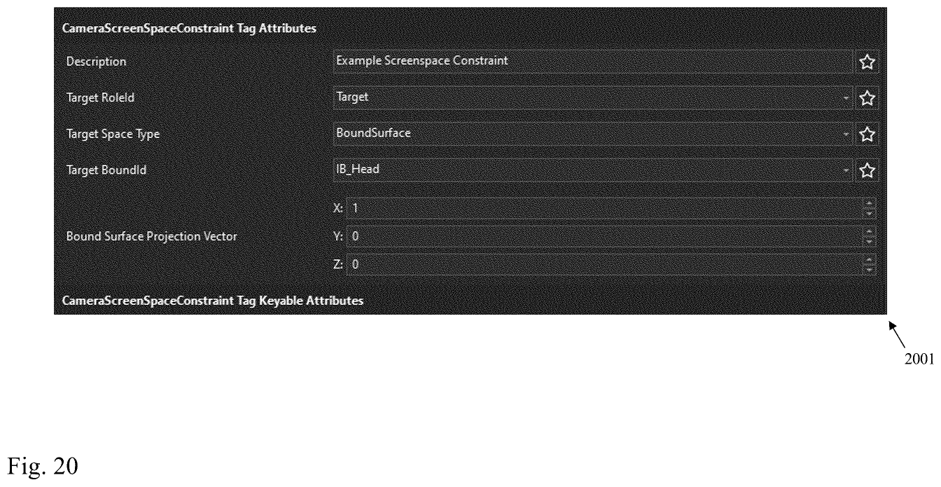

Shown in FIG. 20 is a screenshot 2001 regarding an example case where we target the Head of an Entity with the Id “Target”.

2) Calculate the ScreenSpace coordinates

For the X and Y coordinates, this is done via the projective transform from the camera matrix of the world position that is given. For the Z coordinate, this is done by projecting the vector from the camera location to the target point onto the normalised camera forward vector.

A single ScreenSpace coordinate is therefore:
[ScreenX, ScreenY, DepthZ]

### 3) Store and Retrieve the ScreenSpace Coordinates

These ScreenSpace coordinates can be stored on the CameraScreenSpaceConstraint tag. We do this by making a trajectory with a coordinate entry for each frame of the animation that the tag spans. In this way we store the ScreenSpace Coordinate alongside the Bone or Bound Id, and the RoleId.

At runtime, the camera system: a) reads any CameraScreenSpaceConstraint tags for the current frame of animation; b) reads the ScreenSpace coordinate for the current frame; and c) reads the Bone or BoundId and bound coordinate along with the RoleId of the entity.

### 4) Move the Camera to Preserve the ScreenSpace Coordinates

The camera system now has:
One or more target RoleId, Bone or Bound Id with bound coordinate, and ScreenSpace coordinates; and
An interaction group set by the camera animation code

The RoleId can be used to acquire the entity from the Interaction Group, and the Bone or BoundId can be acquired from the entity.

Preserving the ScreenSpace coordinates involves calculating the position in the world of the Bone or BoundId with bound coordinate, and adjusting the camera position so that the set of bones or bounds positions matches the requested ScreenSpace coordinates.

Calculating the position in the world can involve looking up the entity in the map of RoleIds to Entities that the camera team have registered with them, and then getting the location of the bone or bound with bound coordinate.

This world coordinate can be projected into camera coordinates using standard viewport projective transformations and the composite camera matrix. This gives a list of target locations in ScreenSpace, and the distance from the desired location in ScreenSpace.

At runtime the camera system can make different choices to preserve the requested coordinates (e.g., it could pan, rotate, or change field of view).

In various embodiments, the system can prioritise panning to minimise the difference in error given the specified coordinates, weighting the error by the weight given to each constraint.

### Camera Mover Constraints

Camera mover constraint functionality can include guiding the camera entity rather than merely defining what the camera looks at. This approach can prove beneficial for multiple reasons:

We do not want the camera to clip into walls, floors, ceilings, etc. This can be achieved by limiting the movement of the actual camera transform to be outside of known barriers.

We can desire to pass the camera through a space. For example, for a shot where the camera moves through a window or a door, the camera is to consistently move in this way, even when the entities being framed by the camera vary (or the environment varies).

What the camera is framing can sometimes be effectively represented by the location and orientation of the camera transform alone. This can be thought of as trying to keep the camera in a similar place in the scene.

In various embodiments, character mover constraints and camera mover constraints can use similar approaches for adaptation purposes as detailed below.

### Online Processing

### Interaction Groups

As referenced above, animation constraints can refer to interacting entities through generic role ids. For instance, to express a melee interaction, constraints can refer to an attacker and a defender. Here, attacker and defender identify the roles of the participants of that melee interaction in an abstract and generic way, so that the constraints are not bound to specific entities. This allows the reuse of the same constraints to handle interaction between entities with varying body sizes and proportions by assigning different entities to perform these roles. To allow this assignment, constraints can, for example, use a dictionary to look up the actual entities. Interaction groups can be the dictionaries used by the retargeting system in the game for this purpose.

From one point of view, an interaction group can be seen as a set of unique role id and entity pairs, each of which is called an interaction group member. It is queried with role ids referred by the constraints to disambiguate the entities involved in an interaction. These matching entities are then used for retargeting operations specified by the constraints. In other words, the core retargeting system discovers the interacting entities via interaction groups by querying them based on the role ids referred to in animation constraints metadata.

### Interaction Group Types

Interaction groups can be created and maintained by the code clients of the retargeting system, as these clients control which interactions will take place between which characters. There are typically two types of interaction groups retargeting system deals with: primary interaction groups and default interaction groups.

Based on the animation assets to use for the interaction, the code clients can create and fill in an optional primary interaction group matching the referred role ids of the interacting entities. The primary interaction groups are typically directly associated with the animation asset they are to disambiguate, and they are passed to the retargeting system as a pair. In this way, the retargeting system can disambiguate the generic role ids used by the constraints in that asset, by finding the matching entities in that interaction group. This avoids ambiguities such as those resulting from potential clashes of role ids, where the same role id is used to refer different entities in simultaneous interactions. Therefore, client systems have the flexibility of using the same animation assets on different simultaneous interactions.

A default interaction group is typically created for each entity to retarget. A default interaction group allows for the registration and discovery of entities which are commonly used in entity interactions. Some example members of the default interaction group are:

Self—the current entity performing retargeting

SelfGround—the ground plane underneath that entity

SelfTransport—the transportation that entity is riding in or interacting with

SelfAimTarget—the target that entity is aiming at

SelfCamera—the camera following that entity

Maintaining commonly used entities in a special interaction group in this way yields benefits including relaxing the call for adding redundant interaction group members to primary interaction groups. Under a circumstance where all necessary entities are covered by the default interaction group, the client need not create a primary interaction group for the corresponding animation assets to retarget. As such, primary interaction groups can be considered to be optional. For instance, in case of a self interaction where all constraints refer to the Self role id, no primary interaction group is required, as Self is a member of the default interaction group.

The default interaction group can be used as a secondary dictionary when disambiguating role ids. In other words, given a role id to query, first the primary interaction group is queried, if there is one. If there is no match for the role id, then the default interaction group is used.

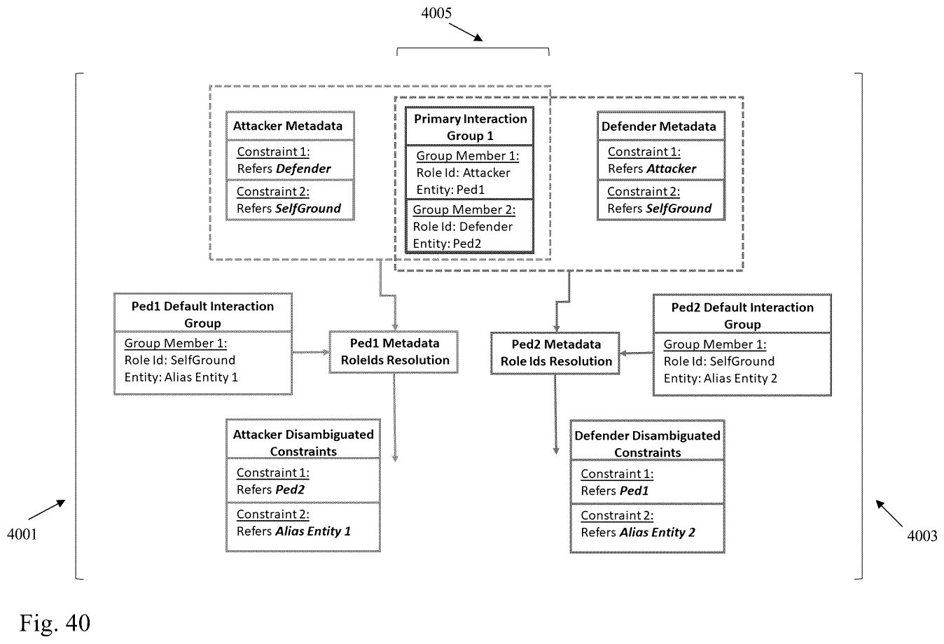

Shown in FIG. 40 is a role id resolution flow for two characters (ped1 and ped2) for a melee example where ped 1 attacks ped 2. The flow for ped 1 is on the left side of the figure highlighted in light grey (4001). The flow for ped2 is on the right side of the figure and highlighted in medium grey (4003). The primary interaction group, which is shared between the two characters, is at the middle of the figure and highlighted in dark grey (4005). The Attacker metadata has two constraints which refer to Defender and SelfGround role ids, respectively. The Defender metadata has two constraints which refer to Attacker and SelfGround role ids, respectively. The dashed boxes depict the matching metadata—interaction group pairs.

Each entity holds a list of all interaction groups it is a part of, besides its default interaction group. For instance, in the example above, both Ped1 and Ped2 locally store a pointer to “Primary Interaction Group 1”. When the entities are done with that interaction group, it is removed from those local lists. Moreover, interaction groups hold a list of labels which signifies their usage. These labels make interaction groups explorable, especially for external game systems and scripts. For instance, “Melee” label can be added to “Primary Interaction Group 1”. In this way, it would be straightforward to run a high-level query to access all entities an entity is involved in a melee with.

FIG. 40 illustrates the data disambiguation flow using interaction groups on a melee example. Defender role id in “Attacker Metadata” is matched with Ped2, as querying it in “Primary Interaction Group 1” returns “Group Member 2”. SelfGround is matched with “Alias Entity 1”, as querying it in “Primary Interaction Group 1” fails, and therefore it is queried in Ped1's Default Interaction Group. Likewise, Attacker is matched with Ped1 and SelfGround is matched with “Alias Entity 2” as a result of Ped2's metadata role ids resolution.

### Interaction Group Entity Types

An interaction group is generally made up of three different types of entities:

Game Entities: These are the entities which are individually interactable, such as bipeds, vehicles, weapons and other props. These entities can have interaction bounds and a skeleton, and as such constraints can refer to these interaction bounds and bones using their unique IDs.

Alias Entities: With reference to the discussion of alias entities hereinabove, these are simple geometric primitives which allow users to retarget interactions in a flexible way.

Affordance Entities: With reference to the discussion of affordances hereinabove, these are sub-hierarchies of game entities, and/or entities whose interaction bounds are restricted and which allow the retargeting system to disambiguate affordances referred to in constraints.

### Automatic Creation of Interaction Groups Via Animscenes

As noted above, AnimScenes are in some ways parallel to Clip Environment files, but are run in the game. As also noted above, an AnimScene can provide a single timeline for animations and other events that are shared across multiple entities. In various embodiments, the game engine can use AnimScenes to play synchronised animation between peds, props, vehicles, or other events. This is used for single ped interactions with props, up to full cinematics with cameras, visual effects, and audio.

AnimScenes typically has a name associated with each entity, and that name is registered as the roleId in the interaction group. As such, in those cases the interaction group can be handled without any gameplay task intervention.

### Runtime Solver

The retargeting solver is responsible, for instance, for adapting poses of characters to preserve the semantics of ongoing interactions. This is done by, for example, fulfilling the demands of animation constraints based on the state of the interacting entities, and surroundings provided by the interaction groups. This goal brings about several challenges, such as:
Validation of animation constraints and their mapping to new characters and surroundings
Ensuring temporal continuity
Arbitration of conflicting constraints and pose deformation
Scheduling pose adaptations based on explored dependencies between characters
The runtime solver functionality discussed herein addresses challenges including these.

### Arbitration and Pose Adaptation

In some embodiments, it is not always sufficient to satisfy all given animation constraints on a character simultaneously. Such satisfaction is likely not possible, for instance, when many animation clip assets blend simultaneously where hundreds of constraints affect different body parts with different requests. There is typically call for the retargeting system to understand the intention behind every constraint (or most constraints), and to generate a solution without compromising the semantics of ongoing interactions. Our pose adaptation algorithm honours animation constraints by arbitrating them based on their priorities, weights and desired chains to be modified, as noted above when discussing animation constraints.

### Design Considerations

The design of the structure of the constraints solver takes into account multiple factors. These factors include:

Generalization: It is typically desirable that the same constraints solver logic be applied to all (or most) interactions (e.g., from swimming to driving). It is further typically desirable that assets and constraints (e.g., all assets and constraints) be able to blend with each other when they are appropriately set up by animators.

Flexibility: Game design and development is an evolving process, and the solver architecture should typically be easily adaptable to support new features without having to solve intricate theoretical problems. From the production perspective, solving constraints can be viewed as not a math problem, but rather as a part of a tool which needs to serve to the purpose of the production without hampering the work of other teams.

Performance: It is typically desirable that the solver be fast, thereby allowing the adaptation on, say, hundreds of characters simultaneously.

Control: It is typically desirable that the solver not behave like a black box. Instead, it is typically desirable that the solver: a) be easy to explain (e.g., to clients and developers working with it); and b) be intuitive.

Maintenance: It is typically desirable that the logic of the solver be clean, and that the solution steps be easy to follow (e.g., for the developer team).

Workflow: It is typically desirable that the solver should not limit the capabilities of animators and they need to be able to apply traditional techniques.

Our constraints solver works with the same types of constraints and with the same authoring, irrespective of ongoing interactions, thereby generalising its use. We refrain from the use of numerical optimization frameworks which solve systems of equations by performing predefined convergence steps repetitively, as extending them to support new features typically requires major efforts. Instead, we make use of a well-defined flow of solve operations with adaptable internal components which allows the use of analytical techniques internally. This yields benefits including giving us the flexibility of fast prototyping and of supporting new features. Moreover, our analytical algorithms are more performant, at least as they do not make use of repetitive steps. This yields predictable solver outcomes which provide the users with intuitive control of their workflow. This encourages the constructive feedback and the proactive reporting of any issues which can be addressed by the developers which facilitates maintenance. Moreover, our solver supports traditional animation techniques such as layering animations which allows users to interact with the system without compromising their existing workflow.

### Solver Overview

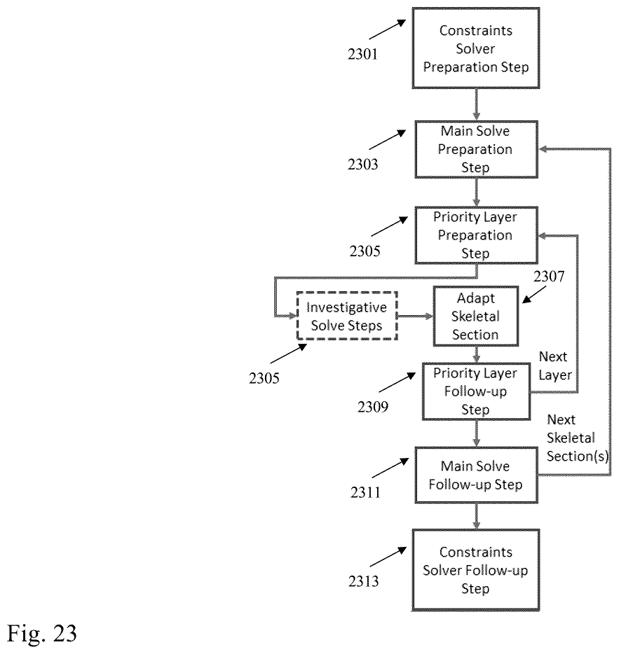

FIG. 23 illustrates the flow of our pose adaptation algorithm. The pose adaptation starts with the constraints solver preparation step where the solver stores data based on the input pose of the character. For instance, we copy the local bone transforms of the input pose so that they can be used to revert temporary pose changes done as a part of the solve process. We adjust the poses of skeletal sections progressing from the root of the skeletal hierarchy towards the extremities. In general, a skeletal section is either a chain of bones, or a single animatable bone. Adaptation of each such skeleton section or group of skeletal sections is handled within main solve steps. When the main solve step of a skeletal section is complete, the descendant parts are adapted based on the fixed pose of their ancestors. On the other hand, adaptation of an ancestor skeletal section typically involves the desired pose knowledge of the descendant sections. Therefore, our pose adaptation algorithm carries out intermediate investigative solve steps on their subtrees to be able to decide the pose of a section (FIG. 23, dashed boxes). When the pose adaptation is complete, a constraints solver follow-up step takes place which allows the solver to store necessary temporal state data as explained hereinbelow.

FIG. 23 provides a pose adaptation algorithm flow overview. In priority layers solve, investigative solve steps can take place (dashed box) to allow the pose arbitration of the skeletal section to adapt. Each main solve step is composed of preparation, priority layers solve and follow-up steps. Each priority layers solve step sequentially deals with constraint priority layers from the lowest priority to highest priority, and each layer solve has its own internal preparation, adaptation and follow-up steps. When all priority layers are handled for a skeletal section, a follow-up step takes place prior to continuing with the next main solve step. When all skeletal sections are processed, the algorithm is finalized with the constraints solver follow-up step.

As such, the flow of FIG. 23 includes constraints solver preparation step 2301, main solve preparation step 2303, and priority layer preparation step 2305. Further as such, the flow of FIG. 23 includes investigative solve steps 2305, adapt skeletal section step 2307, priority layer follow-up step 2309, main solve follow-up step 2311, and constraints solver follow-up step 2313.

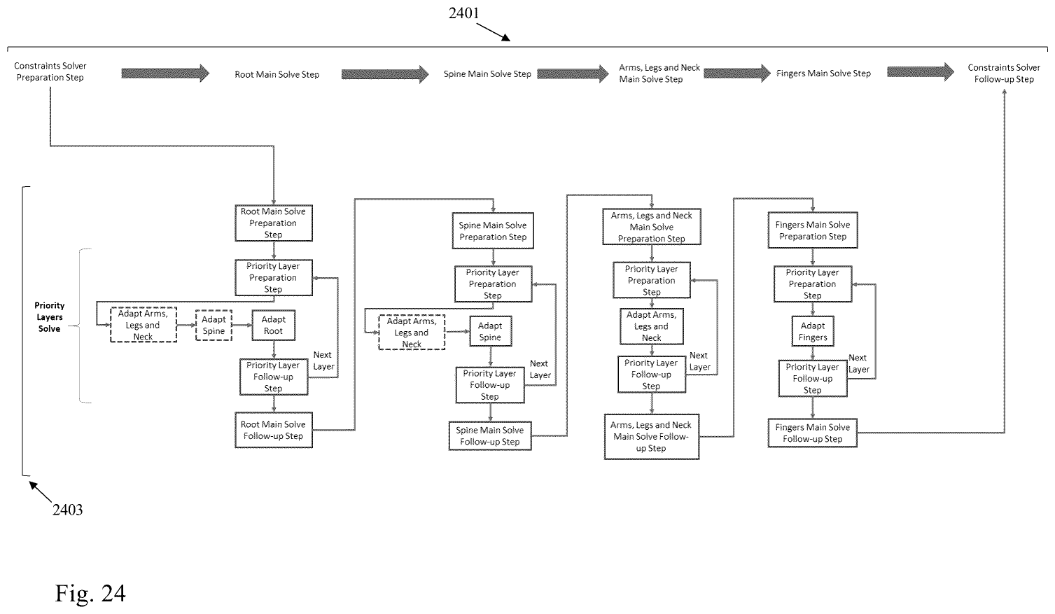

Our pose adaptation algorithm is generic and can be used to deal with different skeletal structures. FIG. 24 summarizes how it proceeds with a human-like character which is composed of root, spine, legs, arms and fingers skeletal sections. The pose adaptation starts from the root of the character and sequentially continues towards the extremities of the character processing spine, legs/arms/neck and the fingers. Note that legs, arms and neck of the character are typically processed at the same step, so that any cyclic constraints in between can be dealt with. Small skeletal sections, such as fingers, can be skipped in investigative solve steps for performance reasons, as their contributions are usually insignificant to their ancestor skeletal sections.

According to the pose adaptation flow overview of FIG. 24, the top row 2401 illustrates the flow and order of main solve steps among skeletal sections. The bottom row 2403 demonstrates the flow within and in between the main solve steps.

Investigative solve steps involve approximate pose adaptations performed to help the main solve steps. They take place as a part of the priority layers solve as detailed herein. They allow the solver to arbitrate the contribution of different skeletal sections for the resolution of given constraints. As an example, assume that a character is given a hand position constraint which is to use the whole skeleton chain from the hand till the root of the character. Without investigative solve, the character moves its root to align the hand position with its target. However, investigative solve steps allow root to discover the available redundancy on other skeletal sections respecting their range of motion constrained by joint limits, and therefore its potential over-contribution to the satisfaction of that constraint is prevented. As such, benefits including allows our solver to achieve more natural poses can result.

As the pose of skeletal sections are adapted from proximal ones towards the extremities, the constraints to affect descendant chains are provided with the opportunity of exploiting available redundancies. For instance, in case a higher priority constraint conflicts the use of root, a lower priority foot position constraint can still be able to adapt the pose of the corresponding leg to fulfil its duty.

As discussed hereinabove in connection with constraint types, each constraint stores the information of the desired skeletal chain to be modified. Based on this, the participation of a constraint to a solve step is determined. For instance, a left hand constraint whose desired skeletal chain contains spine and the root sections typically only makes use of root and spine adaptations. It would typically not be used for any left arm adaptation, even if the constraint controls the state of the left hand. Our architecture also allows the use of bespoke solvers or solver behaviours. Bespoke adaptation behaviours can be achieved through labels stored in constraints queried by the constraints solver. An example of this is the use of shoulder joint dislocation to stabilize the arm pose when holding a weapon, while the character is in first person camera view where the shoulder joint is visibility is insignificant. This enables the use of a degree of freedom in character's body which is not exploited otherwise.

Each main solve step is typically composed of three sub-steps:

A preparation step, where the pose algorithm caches the state of necessary body parts before any pose deformation is applied to the corresponding skeletal section. For instance, the transformation of last bone of the spine chain can be stored before the spine adaptation takes place to distribute its rotational displacement among several descendant bones to avoid skinning artefacts.

A priority layers solve step where pose adaptation takes place. The constraints are tackled layer by layer sequentially, based on their priority values from, for instance, the lowest priority to the highest one. The priority layers solve is detailed below.

A follow-up step that allows the solver to revert any temporary changes applied to other body parts, particularly as a result of investigative solve steps. Hence, the same set of constraints are typically not applied to same body parts repetitively which would typically result in undesired artefacts.

### Priority Layers Solve

Each constraint typically stores a priority value for discrete arbitration purposes, as discussed hereinabove in connection with constraint priorities for discrete arbitration. The constraints are grouped in priorities which are solved sequentially by the pose adaptation algorithm, starting from the lowest priority layer towards highest priority layer. This allows constraints with higher priorities to impact the outcome pose more than those with lower priorities. Note that this way of processing priorities is different than conventional prioritized constraint solving frameworks, commonly used by robotics and animation communities. According to these conventional prioritized constraint solving frameworks, priorities are processed from highest to lowest, where each layer solve “locks” certain degrees of freedom so that lower priority constraints cannot impact the resolution of higher priority constraints. Various reasons for our choice will now be discussed.

Firstly, following our approach of starting from the lowest priority layer towards highest priority layer is a good fit for animation authoring purposes, where animators typically layer animations on top of each other without constraining the application of next layers based on previous layers. This approach of animators is well supported by our framework. Likewise, applying additive animation constraints turns into a trivial problem with our approach, whereas it is an intricate problem for the conventional approach where priorities are processed from highest to lowest.

Secondly, handling constraint priorities according to our approach results in performance advantages. In other prioritized constraints solving frameworks, solutions are searched for repetitively in linearized space through the use of null space projection operations. These null space projection operations incur significant computation costs and are not achievable in real time, at least at the scale of the problem we address. To the extent that the view is taken that, according to our approach, the application of a lower priority layer adaptation can conflict with the solution of a higher priority since it can possibly bring the body pose to a state that a higher priority layer solve cannot efficiently restore from, the following is noted. Even such a circumstance would not, on the balance, be problematic, at least as our approach gives priorities a new meaning closer to animation layers, which is easy for animators to grasp. Moreover, as other approaches deal with that issue in linearized space, there is no guarantee that in highly non-linearized spaces that assumption holds.

Our priority layers solve involves three steps: a preparation step, a pose adaptation, and a follow-up step.

### Priority Layer Solve Preparation Step

The preparation step is mainly responsible for arbitrating the convergence behaviour of the constraints prior to the pose adaptation.

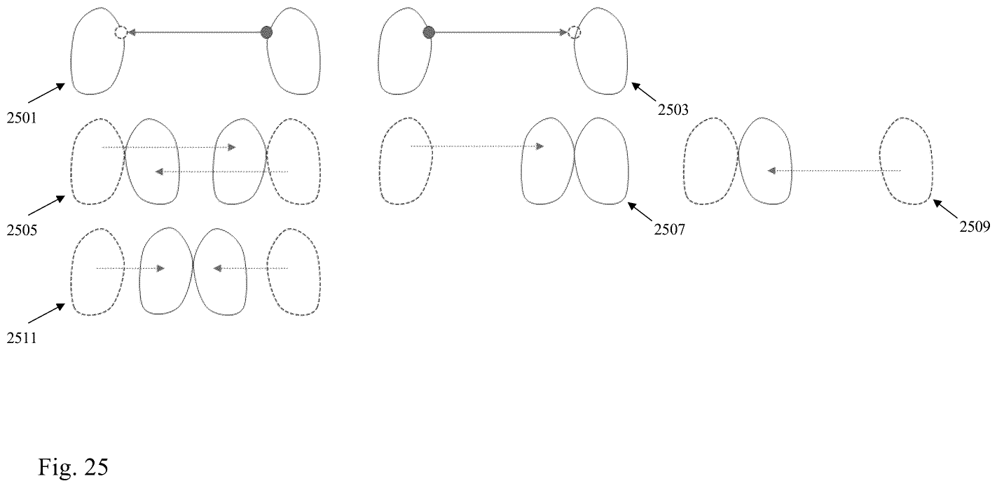

In an aspect, the preparation step arbitrates between cyclic constraints (i.e., the constraints which are linked to each other with cyclic dependencies). Such cyclic constraints arise, for example, in interactions such as hands clapping. Here, the left hand is brought onto the right hand, and the right hand is brought onto the left hand, with the two actions occurring simultaneously. This clapping interaction is different than bringing an end effector onto an immobile goal. In particular, the next states of both hands are predicted, and then the pose adaptation of both arms can be done accordingly. This process is illustrated in FIG. 25.

FIG. 25 depicts cyclic constraints between left and right hands. Turning to 2501, shown is the position constraint which depicts the end effector position on the right hand with its goal position on the left hand. Turning to 2503, shown is the position constraint which depicts the end effector position on the left hand with its goal position on the right hand. Then, turning to 2505, if those two constraints are solved simultaneously without arbitration, both hands overshoot and cross each other. Turning to 2507, if the left arm pose were deformed before the right arm pose, then only the left hand would be displaced. Turning to 2509, if the right arm pose were deformed prior to the left arm pose, then only the right the hand would be moved. Then, turning to 2511, shown is the desired behaviour where both arm poses are adapted independently based on arbitrated goals decided in priority solve preparation step.

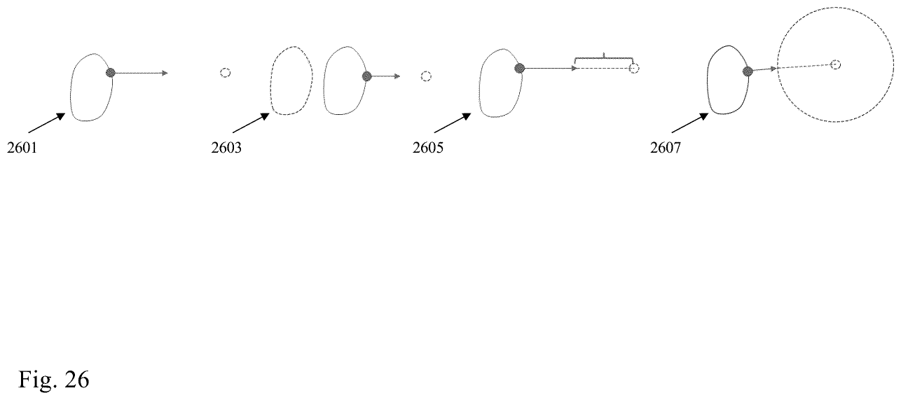

In another aspect, the preparation step includes determining the desired error values of the constraints, based on their activation values. Prior to any pose adaptation done within the same priority layer, constraint goals are recomputed based on their desired error values. This prevents the constraints from over-converging as a result of investigative solve steps on partially activated constraints. This can be especially useful for seamless pose transitions during times when constraints are blending in and out. Otherwise, overconvergence would quickly bring end effectors to their near-satisfied states, and then later in the blend the convergence rate would slow down, which results in “hesitation” artefacts. As an example, if we consider the root solve of a semi-activated left hand constraint which recruits all the bones from the hand till the root, to determine the desired contribution of the root we first do an investigative left arm and spine solves, respectively. If the constraint goal is recomputed based on the constraint activation before every investigative solve—in other words if every solve operation tackles half of the residual error—after the adaptation of three skeletal sections it is possible to reduce the constraint error to 12.5% (0.5×0.5×0.5) of the initial error, whereas the desired error is 50% for a semi-activated constraint. Instead, the error value corresponding to 50% of the initial error is stored in the constraint in the preparation step, and then constraint's convergence is limited by each pose deformation operation. This operation is illustrated in FIG. 26.

FIG. 26 depicts desired error based constraint activation. Turning to 2601, shown is the initial state of a half-activated left hand constraint where a filled sphere depicts the end effector, and a dashed sphere depicts the goal if the constraint was fully active. The error shows the desired displacement of the end effector to fulfil the constraint's demand. Turning to 2603, shown is the phenomenon that, if the end effector is moved as desired, keeping that constraint half active would result in an over satisfaction of this constraint. In other words, follow up solves stiffen the constraints. Then, turning to 2605, instead of doing every individual solve using activation values to blend, we store the desired error value of the constraint using the initial configuration. Turning to 2607, introducing that desired error value as a convergence limitation keeps the end effector around a spherical surface and prevents the over-satisfaction of the constraint.

### Main Priority Layer Solve Step

The main priority solve step is where pose adaptation takes place. The pose of the character is deformed to satisfy a given set of constraints sharing the same skeletal section. It is noted that there can be multiple inverse or forward kinematics solvers working on the same skeletal section, operating on overlapping parts. Each such solver is activated based on the activation values of the constraints which request them, and their instantaneous goals are arbitrated based on the target values calibrated in the preparation step. The resulting pose deformations of each such solver are blended together.

The main priority solve step starts with the investigate solve steps. The approximate poses obtained from investigations allow the solver to measure the contributions that descendant body parts can make to the resolution of the constraints. Based on these measurements, the solver decides how much the pose of the actual skeletal section is to be deformed, and the deformation is applied accordingly. During these operations, over-convergence behaviour is prevented because of the target error values computed in the preparation step.

### Running a Single Solver on a Given Skeletal Section

A solver can be run: a) if there are active constraints overlapping the corresponding skeletal section; or b) if an enabling condition given by the labels is satisfied. The activation value of the solver is determined by the maximum bone activation. The maximum bone activation is computed by the sum of the activation values of constraints which use that bone as an end effector. This approach avoids the aggregation of activation values of partially activated constraints controlling descendant bones. For instance, suppose that there are two half-activated constraints, one controlling the left hand and one controlling the right hand. Suppose further that the two half-activated constraints demand to make use of arm and spine chains. This results in the partial activation of each arm chain. However, both constraints share the spine chain. If we were to sum the constraint activations of both constraints, the spine chain would blend in too quickly, and artefacts would typically result. As such, according to our approach the maximum of bone activation values are used, thereby coordinating the spine and arm movements.

On the other hand, the use of maximum activation value of the constraints controlling the same bone as an end effector does not result in the expected behaviour. For instance, consider a case where two animation assets are blended with partial weights, each of which contains a fully activated right hand constraint. Here, the blend weight of the assets limits the activation value of the constraints, thereby which resulting in the constraints solver receiving two partially activated constraints. If the solver is activated with the maximum of those values, the solver would never get fully activated. Instead, the sum of these activation values is used to compute the bone activation values.

Before running each solver, the internal states of constraints are updated based on the current pose of the character. This allows for updating:
parent transform of the attachment props, which are attached to a bone of the character, such as a weapon which is to be aimed at a particular target through retargeting constraints.
poses of interaction bounds and script driven bones, which are referred from constraints for which AnimScript is run on those bounds and bones; the updating can be on demand.
dynamic offset values for constraints, which can be updated if the constraint end effector or goal has coordinates which are to be recomputed dynamically in the game. For instance, projection coordinates, axis coordinates, and region constraints (discussed in greater detail hereinbelow) are typically recomputed every time the pose of the bounds or bones they depend on changes.
dynamic constraint activation values for region constraints, as region constraints handling typically calls for special attention (see also hereinbelow).

The constraints attached to the bones are arbitrated in two steps.

First, a weighted average of constraints' end effectors and goals is typically computed for each constraint type separately, where the weights are given by the activation values of the constraints. In other words: a) position constraints are blended with position constraints; b) orientation constraints are blended with orientation constraints; and c) aim constraints are blended with aim constraints. Note that special care is typically taken for additive constraints, as they can either be applied to the outcome of the blend operation, or to the current state of their end effectors and then blended like any other constraint. We leave this choice to the owner of the constraint, and support both operations.

Second, when the constraint blend operations for each type are completed, their results are merged. Merging position and orientation constraints without conflicting each other is typically feasible, as they typically impact distinct degrees of freedom. Said differently, it is typically possible to satisfy both a position and orientation constraint simultaneously. We blend the outcome of aim constraints on top of the merged outcome of the position and orientation constraints blend. It is noted that although this blend can be done in a more mathematically sound way, such an approach would typically require solving computationally costly optimization problems. For this reason, we typically instead implement the computations of this blend logic in an efficient way that achieves predictable outcomes. In line with this, it is noted that, in practice, it is typically rare that position, orientation and aim constraints blend altogether on the same bone, as animators typically rather prefer to layer aim constraints by assigning different priorities to them. The outcome bone transforms are then fed into the corresponding chain or bone solvers to compute the desired pose. The joint limits are applied to the resulting pose to ensure that biomechanical limits are respected.

### Attachment Props

Attachment props are items attached to the skeleton of characters. As just some examples, such attachment props can include: a) held items such as weapons, mobile phones, and cups; and b) wearables items such as glasses and hats. These items are attached to special bones of characters, called attachment helper bones. These helper bones are children of core skeleton bones with respect to which they can be animated freely. For instance, a character can spin a handgun around its index finger because of an animated attachment helper bone parented to the hand of the character.

Retargeting can be performed with respect to attachment props. In particular, the retargeting of attachment props can consider cases including:
1) The character uses the prop to interact with itself or other entities. For instance, a cup could be brought to the mouth of the holding character, or a handgun could be pointed at a target.
2) The character interacts with the prop. For instance, when reloading a weapon the spare hand of the character could interact with the weapon to perform the necessary actions.
3) The attachment offsets are adapted based on based on surface contacts. For instance, without retargeting a handgun whose attachment offsets were designed for a small character will not fit to the hand of a bigger character with thicker palms.

Prior to handling these cases, we compute the pose of the attachment prop (e.g., weapon) based on its attachment relationship, as the pose of the attachment helper bones change based on their parent transforms. Further, this is redone when the pose of the parent transform changes.

Using the above-discussed parented constraints, the first above case can be handled in a straightforward fashion. In particular, the constraint can be set up to control an end effector on the prop with a skeletal chain to be modified on the holding character, based on the current pose of the prop. The second above case can be handled through a constraint whose goal is set on the attachment prop.

The third above case can be handled by adjusting the attachment helper bone offsets to bring the props to their designated surface contacts. For this, a constraint is set up where:
the end effector is on the prop,
its parent space origin is on the corresponding interaction bound matching the contact surface, and
the skeletal chain operates on the attachment helper bone.

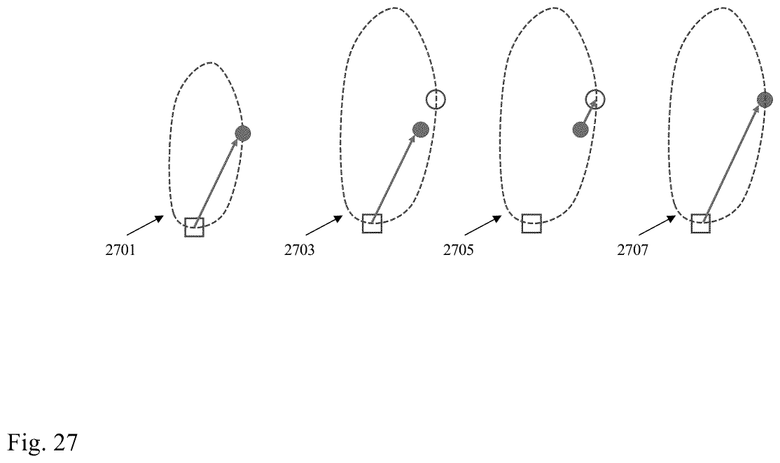

Therefore, the relationship between the surface of the prop and the body surface of the character can be expressed as a constraint. And, by modifying the transform of the attachment helper bone, this relationship can be preserved during retargeting operations. This is explained in FIG. 27 on an example case.

FIG. 27 depicts attachment bone offset fixup for the left hand. The dashed overlay is the hand surface, the square is the left hand bone centre of rotation, the filled circle is the controlled end effector, and the empty circle is the desired position of attachment point on the hand surface. Turning to 2701, shown is that the point from which the prop is going to be attached is offset with the attachment helper bone with respect to the parent hand bone. Turning to 2703, shown is that preserving the original attachment helper bone offset results in penetration of the controlled attachment point. Then, turning to 2705, shown is that there is call for the helper bone offset to be corrected to bring the end effector to its desired surface position on the hand surface. Turning to 2707, shown is that this additional offset is applied to the helper bone, and the end effector is aligned with its desired goal position on the hand surface.

The attachment helper bone solves typically take place within the solves of their corresponding skeletal section, and they are treated just like any other solver acting on that skeletal section. For instance, the solve for an attachment helper bone parented to the left hand of the character can take place when the left arm skeletal section of the character is processed. Therefore, attachment constraints are typically subject to the same arbitration operations, where they can be prioritized and the constraint blend weights applied in the same way within the main priority layer solve step. After computing the blended desired bone transform of the attachment helper bone, the attachment bone offset is applied.

### Region Constraints

As noted above, region constraints define a boundary and a valid side. They are used for relaxing the satisfaction conditions of a constraint, and therefore more freedom can be given to body pose to satisfy other constraints without compromising the intent of the region constraint. For this purpose, a region constraint is typically enabled only if the end effector is at the invalid side of the region. In this way, the end effector is ensured to be within the region. The constraint is disabled when the end effector is already at the valid side of the region; therefore it does not impact the resolution of other constraints.

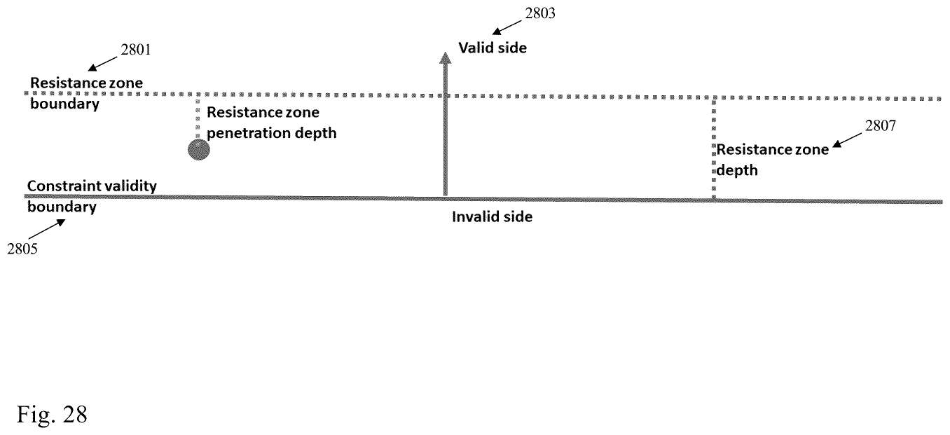

We treat the goals of region constraints akin to projection coordinates when the end effector is at the invalid side of the region (recall above discussion of projection coordinates), and the constraint becomes fully activated. Special care can be taken when handling a constraint for circumstances where the constraint transits in between valid and invalid states. As this is a binary operation, changing the constraint activation of the constraint from zero to one (or vice versa) can result in sudden pose changes and artefacts when the constraint is to blend with others. Turning to FIG. 28, to avoid this we progressively activate or deactivate region constraints. In particular, we define a resistance zone 2801 within the valid side 2803 of the region neighbouring the validity boundary of the constraint 2805. The activation value of the constraint is increased in proportion to its depth within the resistance zone 2807. When the end effector is within the resistance zone 2801, the goal of the constraint is set to its current position, so that the end effector resists being moved by the application of other constraints. When the constraint is invalid, its goal is set to the closest point on the surface. In this way, the continuous transition between valid and invalid states is achieved. FIG. 28 depicts progressive activation constraints within resistance zone explained on a half space constraint where the arrow points at the valid side of the constraint. The constraint is activated gradually based on the proportion of the penetration depth of the end effector to the resistance zone depth.

Note that region constraints are blended with other constraints based on the blend rules explained above. In other words, they behave the same way as other constraints apart from dealing with their state updates detailed in this section. Their seamless integration to the solver framework yields benefits including bringing about simplicity and ensuring continuity. In contrast, were multiple region constraints solved together as is done with conventional collision handling systems, a high computational expense would be incurred, and pose artefacts would arise in cases where those constraints conflicted with each other.

### Types of Chain and Bone Solvers

Our architecture allows the use of different types of chain and bone solvers, and ensures that they work in synchrony. The use of analytical solvers is encouraged for performance and predictability reasons, but we also incorporate the use of iterative and data driven approaches to handle different body parts. Iterative approaches, such as a variation of damped cyclic coordinate descent (CCD) solve, are used for sections on sections with many bones such as the spine. We make use of data driven approaches to channel the convergence to more natural poses. For instance, we compute the desired translation of the root using analytical techniques, whereas the orientation of the root is computed based on a data driven technique which allows us to arbitrate between the translation and orientation contributions of the root. The use of different types of chain and bone solvers used for biped hierarchies in our implementation is summarized in the below table.

TABLE 7
Type of chain and bone solvers our system uses for
different skeletal sections on biped hierarchies.

| | Analytical | Iterative | Data Driven |
|---|---|---|---|
| Root | ✓ | | ✓ |
| Spine | | ✓ | ✓ |
| Arms | ✓ | | |
| Legs | ✓ | | |
| Neck | | ✓ | ✓ |
| Fingers | ✓ | | |

### Priority Layer Solve Follow-Up Step

The priority layer solve follow-up step allows constraints to store relevant information based on the current pose of the character. This step also allows these constraints to transmit that knowledge to later stages of the solve so that that various aspects of earlier operations can be preserved. There are two main use cases of this: deferred pose constraints and observer constraints.

Deferred pose constraints are used to ensure that an assumption when solving a constraint is not broken by a lower priority constraint solve taking place in a descendant skeletal section adaptation. These constraints can be automatically injected by the solvers themselves to avoid the violation of these assumptions. For instance, a higher priority parented constraint can be set up to bring the right hand of a character onto a specific position by only using the root of the character. When this constraint is resolved in its associated priority layer of root adaptation phase, the poses of the bones between the root and the right hand of the character are assumed to be fixed. Otherwise, for instance, a lower priority right hand position constraint which is allowed to use the right arm of the character can modify the arm pose, and as a result the satisfaction of the higher priority constraint could be violated. To prevent this from happening, when the former (higher priority) constraint is resolved, deferred pose constraints are added so that the bone transformations between the distal bone of the chain and the end effector can be arbitrated with other constraints.

Observer constraints are special constraints which allow a constraint to: a) listen to the animated input body pose or the partially retargeted body pose of the character as a result of a priority layer solve of a particular skeletal section; and b) subsequently demand back the stored aspect of the pose at a later stage of the solve operation, by arbitrating with other constraints in the same priority layer. This is useful, for example, to counter the impact of pose changes introduced by ascendant chains. For instance, weapon recoiling retargeting can be layered by animators using three groups of constraints, placed in three priorities from lowest to highest:
Constraints for sweeping to aim at the target
Additive constraints for recoiling behaviour
Countering arms to bring hands to their states after the first priority layer
To achieve this, the animators can make use of observer constraints to observe, for example, the hand states achieved after the first priority layer solve, and then constrain the hands using those states at the third priority layer solve.

### Adaptation of Entity Movers and Camera Trajectories

An entity mover is typically the root node in the hierarchy of a given character. It constitutes, in an aspect, a coordinate system origin for each animation that is played back on a character. For instance, if a human-like character is on a standing animation and the character starts to walk, the walk start animation is played relative to the position and orientation of the mover in the game. The entity mover is also used for maintaining a basic cylindrical physics collider in the game which prevents entities from passing through surfaces. In this way, as just some examples, a walking character stays above the ground underneath and/or cannot run through walls that it bumps into.

Proper adaptation of entity movers in the game can be useful for several reasons. For instance, in order to reproduce an interaction between two entities in the game using the same entities based on the authored animation assets, there is typically call that the entity movers be aligned with the same relative position and orientation. Otherwise, playing back individual animations in the game can result in alignment issues in the interaction. When size and proportion changes are introduced to the entities with respect to their authored animation assets, this problem can become more complicated. For example, in an interaction where a character enters a vehicle, there is typically call that the door of the vehicle ends right in front of the character before the entry action takes place. This involves the adaptation of the entity mover to align the vehicle door with respect to the placement of the entering character, so that the same asset can be used with small and big vehicles. Likewise, the state of the mover impacts the state of the basic physics collider in the game. Where size and proportion changes are applied to the entity, there is call that the mover be adapted accordingly so that the surface contact of that entity with the others can be preserved. As an illustration, when a cup is placed on a table surface, there is typically call to preserve: a) the contact between the bottom of the cup and the surface top of the table (e.g., in case of changes to the cup and table dimensions); and b) different placement configurations with position and orientation variations.

Moreover, as an example imagine a case where a character is to enter a vehicle where the door of the vehicle is to end up right in front of the character before the entry action takes place. In this case the retargeting system supports animation constraints for adaptation of entity movers, as well. Animation constraints express the relationship of mover with respect to other entities, and their body parts and those constraints are used for adapting the transform of a mover. Generally speaking, the mover constraints follow a slightly different path than other animation constraints, as the update of the state of the mover does not typically take place as a part of a blend tree during animation update phases. The dedicated label “Mover” (or a differently named label) can, in various embodiments, be used to distinguish the mover constraints from the other animation constraints used for pose adaptation. Therefore, the constraints to impact the state of the mover can easily be accessed by querying those with that label.

We treat an entity mover as a rigid body with position and orientation degrees of freedom. Therefore position, orientation and aim constraints can be arbitrated akin to other rigid bodies, as discussed above in connection with the running of a single solver on a given skeletal section. Accordingly, retargeting of the entity mover can be simplified, as the mover can be handled as an ordinary skeletal section, with the main difference being it having its own separate retargeting solve rather, than being a part of the full body pose adaptation. Hence, mover retargeting can, in aspects, be viewed as a special solve operation with a single skeletal chain without any investigative solves. In other words as a simplified version of the full body solve discussed hereinabove.

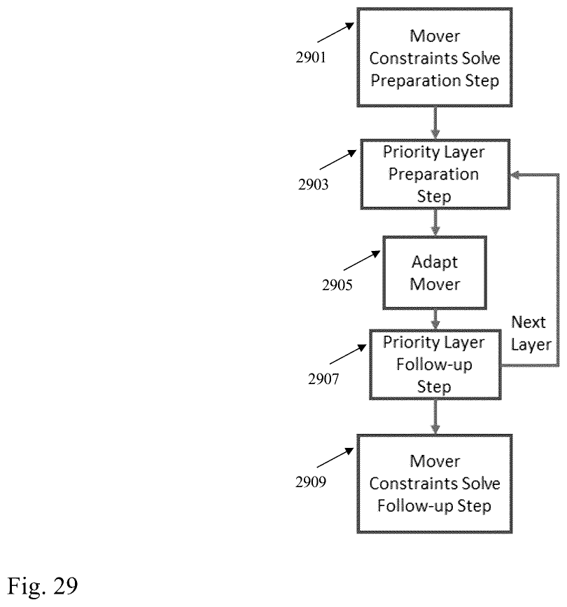

FIG. 29 summarizes the mover retargeting operations. The pose adaptation starts with the mover constraints solve preparation step where one-off operations such as organizing the constraints by priority layers are performed. Here also the initial state of the mover can be restored if there are observer constraints. As mover retargeting solve typically does not take other skeletal sections into account, the main solve preparation step can be skipped, and the solver can continue with the priority layers solve where each priority layer is tackled sequentially (or most priority layers are tackled sequentially) starting from the lowest priority and continuing with higher priority ones as discussed hereinabove in connection with priority layers solve. The constraints which are arbitrated in priority layer preparation step are honoured by computing the desired transformation of the mover. After adapting the mover, the priority layer follow-up step takes place where the observer constraints are allowed to cache the current state of the mover. In that step, the deferred pose constraints are typically skipped, as only a single rigid body transform is adapted with the mover retargeting solve. Accordingly, the flow of FIG. 29 includes mover constraints solve preparation step 2901, priority layer preparation step 2903, adapt mover step 2905, priority layer follow-up step 2907, and mover constraints solve follow-up step 2909.

As such, FIG. 29 provides a mover retargeting solve overview. Mover retargeting solve can, in aspects, be viewed as a simplification of the full body pose adaptation flow presented in FIG. 24, as only the pose of the mover is adapted, and such does not require any investigative solve operations.

### Adapting Camera Mover

Mover retargeting allows for the adaptation of special entities in the game, as well. The same techniques that we use for the entity mover adaptation (or similar techniques) can be used to control the camera movement, with animation constraints expressing their desired trajectories in animation assets. This gives animators direct artistic control over the behaviour of the camera in the scene, based on varying entity sizes and the surroundings. For example, in an interaction where a camera follows the movement of a character while entering a building through a door, animation constraints can be used to channel the trajectory of the camera to pass inside the door without colliding through the walls. As another example, in scene where the camera follows a character in a driver seat, a region constraint can be used to restrict the movement of the camera in the allowed space within that vehicle, so that following a taller character's driving can be achieved without having the camera to pass through the roof of the vehicle. Camera constraints can, in various embodiments, have their own labels “Camera” (or a differently named label) which allows their querying in the asset pipeline and the game conveniently.

### Temporal Continuity

Fluid interactions can improve the quality of character movements in games. Identifying sources of potential discontinuities can aid in ensuring this fluidity. A useful source is the constraint trajectories, and how they are being followed by the end effectors of characters based on the blend weights of constraints.

Because of the way constraints trajectories are computed and mapped as discussed hereinabove, our system can act to ensure that continuous source trajectories are mapped as continuous trajectories to new geometries. These trajectories are fed as end effector targets to the pose adaptation algorithm, and the retargeted pose of the character is determined by that algorithm. The arbitration between the animated state of an end effector, and its desired state as given by the animation constraints, is determined by their temporal weights. The temporal weights are mainly affected by three factors:

The blend weight of the played instance of the container animated clip: This weight is zero when the clip is not being played, and it is one when the clip affects the pose of the character fully. This weight is controlled by the process that plays the clip, and is assumed to result in continuous values apart from intentional discontinuities such as camera cuts where the game state is reset between consecutive frames.

The instantaneous activation value of the constraints: This value is zero when the constraint is not active, and one when the constraint is fully active. The transition between zero to one (and vice versa) is controlled by the animator who authors the constraint, as discussed hereinabove in connection with constraint tag lifespan and easing. Individual activation values of constraints are assumed to change continuously during their life span with two exceptions: the beginning and end of the tag. If an animator wants a constraint to be active as soon as the container clip is being played, or if a constraint is to remain active until the end, the constraint can start or end with a non-zero activation value. However, this is not problematic, as this value is modulated by the clip weight which is assumed to be continuous.

The validity of the constraints: A constraint is considered valid, if:
everything (or nearly everything) it relies on to reproduce itself exists in either in the primary or secondary interaction group; and
it satisfies all (or nearly all) existing pre-conditions such as the LoD criteria

The validity of a constraint is a binary decision, as it is either valid or invalid. This is the primary source of temporal discontinuities, as a constraint's validity state can change suddenly. For instance, an entity can be removed from an interaction group suddenly, such in the middle of an ongoing interaction as a part of the game play. Likewise, the LoD of the retargeted character can change suddenly. This can invalidate a previously active constraint. Likewise, such actions can also suddenly activate a previously invalid constraint.

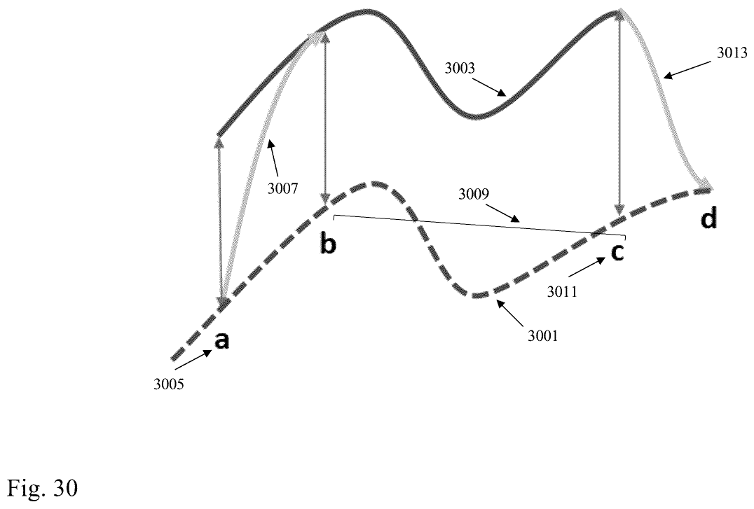

FIG. 30 summarises how the retargeting system handles the transitions between the animated state (dashed dark grey curve 3001) and the retarget state (solid dark grey curve 3003) of an end effector. When there is a gap between the animated state and the retarget state of the end effector (a, 3005), doing an immediate transition can result in a sudden jump. The retargeting system detects this and introduces an automated ease-in to gracefully blend two curves (a-b, light grey curve 3007). The constraint trajectory is continuous, and therefore it is followed as is until the end of the lifespan of the constraint (b-c, 3009). If the constraint disappears suddenly (c 3011), the end effector is eased back to the animated state (c-d, light grey curve 3013) from the last valid state of the constraint, thereby avoiding an artefact caused by an immediate state change.

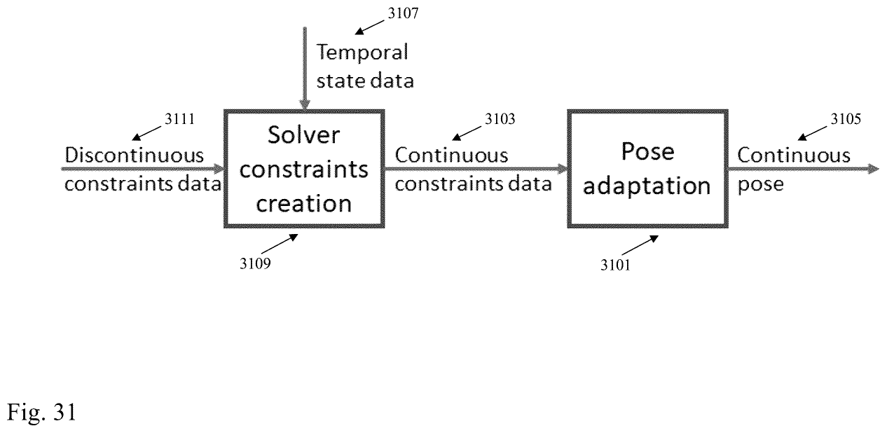

The retargeting system can account for the validity of the constraints in order to achieve continuous temporal weights and end effector targets. This is useful to provide the pose adaptation algorithm with continuous input, so that poses with temporal consistency can be produced (see FIG. 31). This is one reason why the retargeting system stores state information for each animation constraint, as therefore a continuous third blend coefficient can be computed based on the validity of a constraint. Moreover, the state of both the end effector and the goal of the constraints from the previous frame are stored. As such, the missing trajectory information can be temporarily filled while an invalid constraint is eased out.

As illustrated by FIG. 31, the pose adaptation algorithm 3101 can use continuous input 3103 to result in temporarily consistent poses 3105. We maintain temporal state data 3107 for the constraints to manage (3109) potentially discontinuous constraints data 3111 to feed the pose adaptation algorithm 3101.

### Constraints Temporal State Data

The retargeting system typically stores separate temporal state data for each animation constraint which is used for ongoing interactions. Temporal state data generally contains six components:
1) Animation constraint instance ID: a unique identifier to distinguish animation constraints which are received for the first time from the ones which have already been active in previous frames
2) Last valid blend weight: the aggregate blend weight of the constraint at the last frame it was valid
3) Last valid end effector state: the coordinates of the end effector at the last frame it was valid
4) Last valid goal state: the coordinates of the goal at the last frame it was valid
5) A flag representing the automated easing operation: either easing-in or easing-out
6) Desired duration for automated easing-in/out: the duration the easing operation is going to be completed.

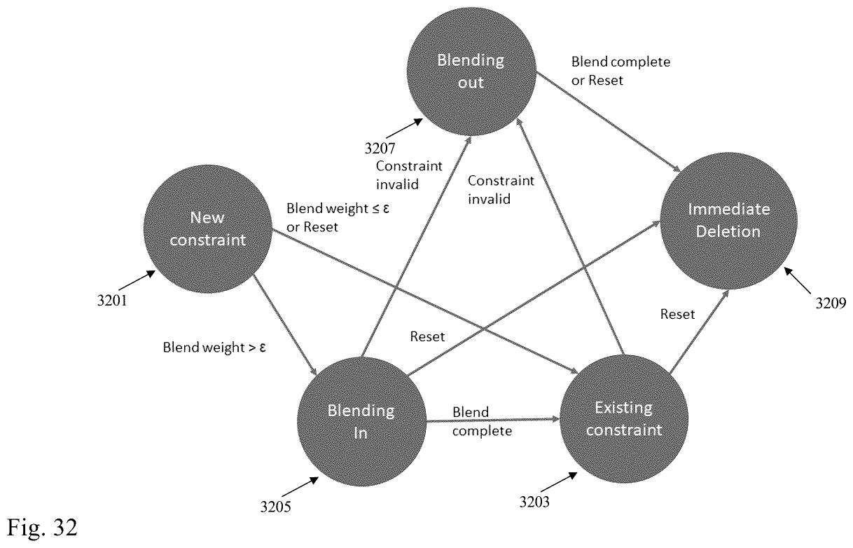

FIG. 32 summarises the constraint's state transitions for introducing continuous inputs to the constraints solver. When a new valid constraint 3201 is received for the first time, its blend weight, which is the multiplication of the blend weight of the container clip and the instantaneous activation value of the constraint, is compared to a threshold value, e. If that value is above the threshold, an ease-in operation is automatically initiated by the retargeting system for that constraint to gracefully introduce that constraint to the solver. If the value is below the threshold, the system relies on the blend weight for the continuity. If an existing constraint 3203, or a constraint which is currently being blended-in 3205 by the retargeting system, becomes invalid at any time, the retargeting system initiates a blend-out operation 3207 to ease-out its way to removal. The retargeting system introduces a new blend coefficients which is increased for blend-ins (or decreased for blend-outs) gradually. That coefficient is multiplied with the last valid blend weight of that constraint. The duration of the automated blend operations is determined automatically, but they typically do not last more than several frames in the game, for the sake of interaction fidelity. While a constraint is blending out, the last valid states of its end effector and goal are used to ensure a smooth transition to next fully valid character pose. As such FIG. 32 provides a state diagram summarising the state transitions of temporal data to provide the pose adaptation algorithm with continuous inputs.

Generally speaking, the only exception to these transitions is when a reset message is generated by client systems. This reset message indicates that a discontinuity has been introduced in the game intentionally. When this message is received, all existing constraints are typically sent to immediate deletion 3209 so that they are not fed to the pose adaptation algorithm anymore. Furthermore, all new valid constraints are typically immediately considered to be existing constraints so that an unintentional delay to the operation of the constraints are not introduced.

### Interaction Islands

The constraints solver framework can be used to handle the constraints of a single character. Further, the constraints solver framework can be applied to multicharacter interaction contexts. The constraints solver has capabilities including being able to sequentially processes skeletal sections by honouring different priority layers. Due to capabilities such as these, benefits including but not limited to arbitrating the constraints impacting different body parts even for complex interactions, and achieving natural retargeting results can accrue.

Now discussed are techniques for generalising constraints solver methodology to multicharacter interaction contexts. Here, animation system problems that are handled include:

Solving scheduling operations for multicharacter interaction can be a difficult problem, as each character runs its own blend tree which also carries out other operations than retargeting. There is call to synchronize the order of operations among these trees so that they carry out multicharacter interaction retargeting at the same time. Here, it is observed that the information of entities interacting with each other is conventionally not available to animation systems automatically. However, such information can be available according to the functionality discussed herein. For instance, animation constraints can allow interactions (e.g., all interactions) to be expressed in a uniform way, and interaction groups can be used as a dictionary to look up the role ids referred from animation constraints.

Handling the simultaneous pose adaptation of interacting characters typically calls for arbitrating the animation constraints of all interacting characters simultaneously.

There is typically call to convey aspects (e.g., important aspects) of multicharacter interaction to downstream animation system operations that are carried out in individual blend trees. In particular, such conveyance can help ensure that enforced arbitration outcomes are not violated by consecutive pose deformation operations.

The use of interaction islands allows us to tackle challenges such as these. Interaction islands can, as just some examples, act as a core of our scheduling and simultaneous pose deformation techniques, and can be used to explain how their outcome is utilized within individual blend trees of the character.

### Interaction Islands and Solve Scheduling

An interaction island is a union of all characters whose pose deformations are dependent on each other. These dependencies are explored through animation constraints, as each constraint creates a dependency between the one it is attached to and the other entities referred from that constraint. These dependencies between entities are transitive. For instance, if characterA depends on characterB and characterB depends on characterC, this also means that characterA and characterC are also dependent, and they become a part of the same interaction island.

Interaction islands are typically computed in two steps. First, each entity makes a list of other entities exploring all its animation constraints. This operation is carried out in parallel. Then, those lists with overlapping entities are merged to form the islands. This is in some aspects similar to computing connected components of a graph where the vertices are the entities, and the edges are determined by animation constraints.

It is noted that it is possible that an entity is not a part of any interaction islands. For example, this is the case when the constraint has only self interaction and environment interaction. When this is the case, multicharacter interaction solve steps are typically not pursued, and only the retargeting pose deformation techniques discussed hereinbelow are used.

It is also noted that interaction islands differ from interaction groups, which rather allow the characters to disambiguate the entities referred from constraint tags. While a primary interaction group is associated with a single interaction and its corresponding participants, an interaction island considers all the interaction a character takes place simultaneously. Therefore, an interaction island can contain the members of multiple interaction groups depending on constraints set between them.

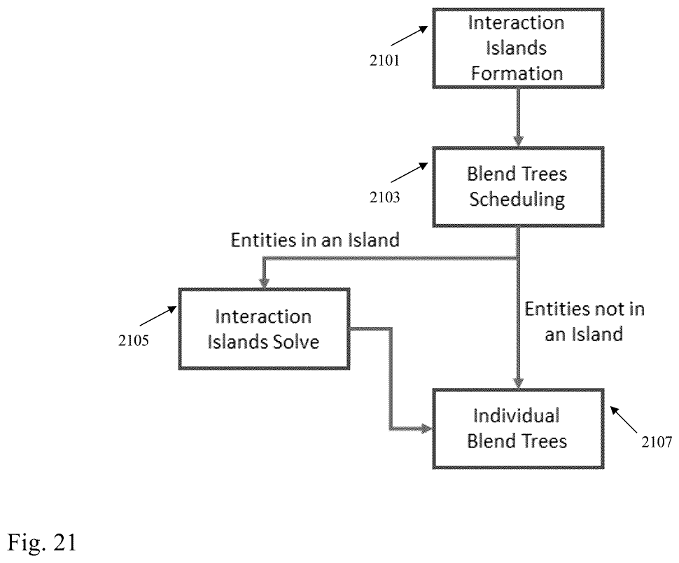

Interaction islands are used to schedule entity blend trees as summarized in FIG. 21. Due to the dependency between the poses of the entities within the same interaction island, the animation constraints of these entities and the resulting pose deformation operations typically are arbitrated altogether. To address this, an interaction island solve is scheduled prior to the individual blend trees of the interaction island entities.

FIG. 21 depicts scheduling interaction islands solve and individual blend trees. After interaction islands are formed 2101, the entities which are a part of an interaction island are scheduled 2103 to have a simultaneous constraints solve operation 2105. The outcome of these solves is taken into account when individual blend trees 2107 of these entities are run. Entities not belonging to an interaction island skip the island solve step.

### Simultaneous Pose Adaptation for Multi Character Interaction

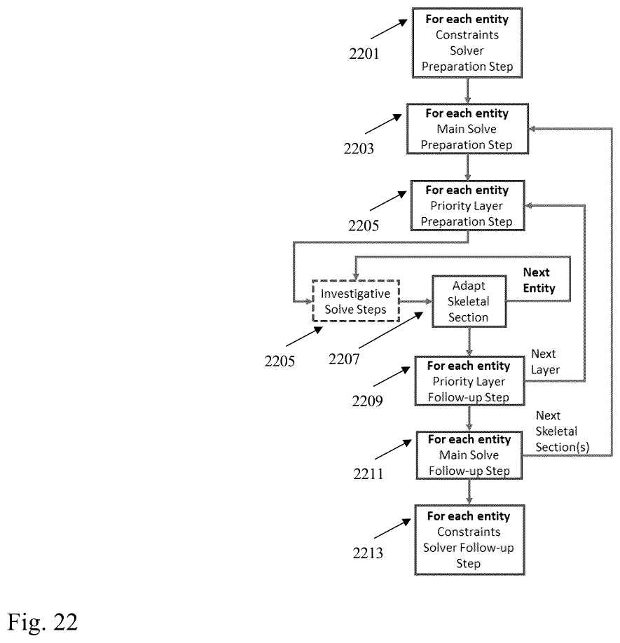

Pose adaptations of entities belonging to the same interaction island are typically performed simultaneously. The simultaneous pose adaptation algorithm is an extension to individual solve algorithm discussed hereinbelow. An overview of the multi character pose adaptation algorithm is presented in FIG. 22. FIG. 22 depicts an Interaction Island solve overview. The differences with respect to FIG. 23 are highlighted with bold characters. As such, the flow of FIG. 22 includes for each entity constraints solver preparation step 2201, for each entity main solve preparation step 2203, and for each entity priority layer preparation step 2205. Further as such, the flow of FIG. 22 includes investigative solve steps 2205, adapt skeletal section step 2207, for each entity priority layer follow-up step 2209, for each entity main solve follow-up step 2211, and for each entity constraints solver follow-up step 2213.

A constraints solver preparation step takes place based on the input poses of all the characters. In this step the constraint priority layers together with the desired skeletal sections from the constraints of all characters are merged to schedule the priority layer solve steps for all characters. This is used to initiate the same priority layer solve on the same skeletal section on all characters simultaneously. For instance, two characters with constraints affecting their spine with the priority/subpriority PrimaryInteraction/High have their spine solve for that layer at the same time. In other words, the constraint priorities have a global meaning, they are not only locally meaningful to the constrained character. Having a global priority system in this way allows the animators to layer animation constraints between characters so that complicated interactions can be expressed in a consistent way and the dependency between the pose adaptations can be reflected in the authoring process. This is explained via the following table in a grapple interaction case.

TABLE 8

| Priority | | Impacted | |
|---|---|---|---|
| layer | | skeletal | |
| order | Description of Constraints | section | Dependency |
| 1 | Character1 looks at a point | Character1's | — |
| | in world | neck | |
| 2 | Character2's left hand holds | Character2's | Character1's |
| | the neck of Character1 | left arm | neck |
| 3 | Character1's left hand holds | Character1's | Character2's |
| | left arm of Character2 | left arm | left arm |
| 4 | Character2's right hand holds | Character2' | Character1' |
| | the left arm of Character1 | right arm | left arm |

TABLE 8 shows a constraints priority layer ordering example for a grapple example where character2 holds the neck of character1 and at the same time they hold each other's arms. The first column lists the priority layer ordering of constraints. The second column presents a short description of the constraints, while third and fourth columns explain character's skeletal section whose pose is to be impacted and the dependency of that pose change, respectively. In this interaction, character1 has two constraints, a lower priority look at constraint which changes the neck and head poses of the character, and a higher priority constraint which modifies its left arm pose. Character2 has a lower priority constraint which impacts its left arm pose, and a higher priority constraint which adapts its right arm pose. Based on the dependency between the pose changes of different body parts, first neck pose of character1 needs to change so that the left arm of character2 could be adapted to hold it. Then, character1's left arm pose needs to change to be able to grab the left arm of character2 prior to the right hand of character2 being brought onto the left arm of character1. If character1 and character2 priorities were ordered independently, these pose changes typically could not be layered in a systematic way. As in our system the priority of the constraints have a global meaning, these pose adaptations can take place with the intended order of operations.

Like in individual solve, the poses of the characters are all processed starting from their roots towards their extremities. The same skeletal section and the same priority of all characters are processed at the same time. When entering a new priority layer solve, the convergence behaviour of constraints are arbitrated in a priority layer preparation step using the techniques described below. In this case, the solver caches the current pose of all characters, and the following skeletal section adaptation takes place based on these cached poses. In this way cyclic constraints on different characters with the same priority affecting the same skeletal section can be coordinated. This allows the handling of an interaction like handshake of two characters akin to the clapping example explained below in connection with a priority layer preparation step. In other words, the pose adaptation of the same skeletal section solve can be performed in parallel on all interacting entities.

### Coordinating Interaction Islands Solve with Individual Blend Trees Using Cross Constraints

Multi character interaction solve allows the simultaneous pose adaptation of (as many as) all interacting entities. However, the adapted poses that result from interaction island solve are typically not immediately reflected on the characters, as the pose changes are to be carried out within the corresponding blend tree of each entity. Therefore, there is call for ways to inform the blend tree nodes within which retargeting operations take place, in order to result in consistent poses with the interaction islands solve. There are two main problems to tackle there.

First, there is call for the characters to access the same pose of other characters at every priority layer step as they accessed in the interaction island solve (or at many of those steps). This is called for to result in the same outcome in their individual solves. Otherwise, any inconsistency could potentially break the layered arbitration logic. To handle this, we cache the pose of the other character body parts referred from the constraints at every priority layer preparation step of the interaction island solve (or at many of those steps). These cached poses are used by the constraints in solve operations taking place in individual blend trees. Hence, in the individual solve step taking place after an interaction island solve, instead of accessing the actual pose of other characters, their cached poses which vary as a result of the interaction island solve steps are used.

Second, there is call to constrain the pose of the characters whose body poses are cached to respect these assumptions of other characters. For this purpose we make use of cross constraints. Cross constraints are constraints added from one character to another to ensure that an assumption about the pose of another character is introduced as a constraint to the other one. These cross constraints can be arbitrated and solved analogously to any other constraints in the individual solve. Where a higher priority constraint conflicts with the cross constraints, they can be compromised during the individual solve. However, if that is not the case, cross constraints can ensure that the assumptions made during the interaction island solve are preserved during the individual blend trees.

Cross constraints are added between characters at the constraints solver preparation step. At this step, we explore the dependencies of the constraints to the body parts of another character. And, for each such dependency a cross constraint with the same priority and weight of the original constraint is added to the other character. These constraints refer to the cached poses of these body parts stored in priority layer preparation step as explained above.

### Injection and Modification of Constraints from Gameplay Clients

The retargeting system is mainly data driven through the constraints authored by the animators which are stored as constraint tags within animation clips metadata. Clients in gameplay trigger the use of these constraints in the game by playing those assets. However, the use of those data driven constraints are not always sufficient. It is useful for these clients to be able to add new constraints in the game procedurally, and/or to modify or block a subset of constraints depending on interaction circumstances in the game.

### Constraint Requests and Handles

Procedurally adding new constraints is useful to retarget repetitive interactions where asset authoring for every variation would be cumbersome. Constraints impacting locomotion behaviour are an example of this. In an aspect, we leverage retargeting constraints created in the game based on dynamic aspects of locomotion. In this way we can, as examples: a) prevent artefacts such as foot sliding; and b) prevent penetration between the arms and the torsos of characters induced by character body thickness and proportion variations. Similarly, other blend tree nodes which would like to ensure the adjustment of various aspects of the character pose can express these intentions in terms of animation retargeting constraints. In this way their requests can be arbitrated with other constraints so as to adapt the pose of the character accordingly.

Those constraints are typically managed through the same animation constraints tag metadata that animation clip containers make use of Therefore, from the point of view of the retargeting system, arbitration of constraints coming from clips and those created in the game do not differ. On the other hand, constraints authored for clips can benefit from our tools which facilitate the authoring process for the animators. For instance, animator users can be encouraged to enter valid input through the use of dynamically generated user interfaces which are aware of the dependencies between the attributes stored in a flat data structure. It can be potentially error prone and overwhelming to expect the code clients to modify the metadata directly. Therefore, we make use of abstraction levels which help the code side clients express the constraints they want to add in valid forms. In this way, the user need not know anything about the underlying structure of the animation constraints metadata format.

The retargeting system typically makes use of two abstractions to distinguish the creation and the maintenance of the constraints. The user first creates a constraint request and submits it to the retargeting system. A constraint request is a higher-level data structure which wraps the underlying metadata which is held in flat form. The constraint request determines the parts of the constraints which are to be set once, and not changed unless it is allowed by the corresponding constraint handle. A constraint request typically holds four main components, examples of which are provided below:
1) A description containing general information about the constraint, such as interaction group, ease in and ease out duration, and priority and maximum weight of the constraint when it is fully eased in. Moreover, users can add labels to describe the intent of the constraint to request. An example of the creation of a description is presented in the following code block:

Retarget::ConstraintRequestDescription description;
description.SetInteractionGroup(interactionGroup);
description.SetEaseIn(blendInDuration);
description.SetEaseOut(blendOutDuration);
description.SetPriority(kPriorityPrimaryInteraction); // optional
description.SetMaxWeight(1.0f) //optional
description.AddLabel(Retarget::Labels::NodeIds::PreRender); / / The
user can add any number of labels to the description

2) An end effector for the controlled frame on the entity to retarget:

// Creation of an end effector to control the left toe bone
Retarget::PositionEndEffectorBoneLocal
effector(fwAnimId::SKEL_L _TOE0);

3) A goal for the constraint which is satisfied when the end effector is aligned with it:

// Creation of a goal position to bring the end effector to a world
position
Retarget::PositionGoalWorld positionGoal(positionVector);

4) A bone id which indicates the deepest bone on the skeletal chain which can be used for pose adaptation

These main components are used as arguments to create a constraint request which is passed to the retargeting system.

// Creation of a position constraint request from the components
introduced above
crId chainDeepestBone = fwAnimId::SKEL_ROOT;
Retarget::PositionConstraintRequest request(description, effector,
chainDeepestBone, goal);

We provide the users with different constraint request types for different constraint types. Each constraint type typically has its own dedicated end effector and goal types which channel the users to form valid constraint metadata.

When the request is submitted, the retargeting system automatically converts the request to the corresponding valid metadata format, and returns a constraint handle to the user. A constraint handle is a persistent data structure which typically allows only the operations the user can perform to be carried out. These are mainly operations for modifying: a) constraint end effector and goal offsets; and b) constraint weights, so that their values can be changed during the lifespan of the constraint for adaptation purposes. However, in general the user is not permitted to modify properties (e.g., the priority of the constraint) after the constraint is requested. The user stores a copy of the constraint handle, and when the held handle is released the corresponding constraint is eased-out automatically by the retargeting system. The example code snippet below presents the submission of a constraint request to the retargeting component on the corresponding entity to obtain a constraint handle with which allowed operations can be performed (e.g., at every frame) to modify the state of the constraint.

Submitting a constraint request to the retargeting component to obtain a handle to the constraint:

// Access the retargeting component of the entity
ComponentRetarget* pComponentRetarget = entity−>GetCreature( )−
>GetComponent< ComponentRetarget >( );
// Request the constraint and receive a handle in return. The user
needs to store this handle for future modifications.
Retarget::ConstraintRequestHandle handle = pComponentRetarget−
>RequestConstraint(request);

The obtained handle is then used by the user to modify the offset values to update the constraint state.

The stored constraint handle is used by the user for future modifications:

// Adjusting the weight of the request
handle.SetMaxWeight(newWeight);
// Adjusting the goal of the request
handle.SetGoalOffset(newOffset);

The constraint handle is a wrapper around the constraint tag metadata. It is injected to the blend tree where the user wants it to be processed. Subsequently the corresponding constraint can be handled by the retargeting node based on the labels passed by the user.

The stored constraint handle is used by the user for future modifications:

ParameterBuffer& buffer = pNetworkPlayer−>GetExtraOutputsBuffer( );
// Inject the constraint to the buffer of the blend tree where it is going
to be processed
handle.InjectConstraint(buffer);

### Constraint Labels and Constraints Querying

Data driven constraints intervention can also be desirable based on conditions that vary in interaction circumstances in the game. For instance, another system can desire to have control (e.g., full control) of the pose of a particular body part in the game while playing animations with retargeting constraint tags. This can be the case, for instance, if an existing system interfaces with the retargeting system. The use of gestures is an example of this, where a dedicated gesture system can want to be in charge (e.g., fully in charge) of the arm postures for certain interactions. The retargeting system can provide such other systems with the ability of querying and blocking constraints (e.g., a subset of constraints). Moreover, some of the constraints can be intended to be run only when certain conditions are met in the game. For instance, to adapt the pose of a character based on the camera mode, some constraints can be only activated in the first-person view mode, or in the third person view mode.

The core retargeting system does not typically have access to such high-level information available to gameplay. Even for the available information, supporting various conditionals (e.g., supporting every required conditional) can scale poorly at the systems level (e.g., due to assigning too much responsibility to a single component). On the other hand, it can be challenging for other systems to explore the metadata carried by constraint tags and to determine the intents thereof, due to constraint tag complexity. Therefore, we beneficially to introduce intuitive ways for gameplay to listen to the intents of the constraints, check the conditions of constraints and enable and disable them accordingly. We make use of constraint labels (discussed hereinabove) for this purpose.

Labels can allow gameplay and animation teams to agree on conditionals which control the application of certain constraints. Each such conditional is typically assigned a unique label carried by constraint tags in a track (e.g., in a dedicated Labels track) so that they can be queried in the game easily. The gameplay can modify the associated blend weight of the queried tags to impact their arbitration behaviour in the game. The gameplay teams can implement and maintain called for conditions criteria without the involvement of the systems teams.

Labels are also used to determine the place where constraints can be solved in the game. These determine the blend tree and the internal retargeting node where these constraints can be arbitrated, and the pose of the character can be adapted accordingly. Moreover, various animation retargeting constraints solve operations are carried out by various external systems which are not a part of a blend tree (e.g., Movement Transition Helper or Camera external systems).

The following table lists examples of labels used for the retargeting operations.

TABLE 9
Examples of labels used for retargeting operations.

| Labels | Description |
|---|---|
| Mover | Labels indicating which external systems |
| Camera | the constraint is intended to. |
| PrePhysics_Main | Labels indicating blend tree nodes the |
| PostMovement_Primary | constraint will be used. |
| PreRender_Main | |
| IKC_ROOT | Labels indicating which body sections the |
| IKC_NEKC | constraint might modify as a part of the |
| IKC_SPINE | pose adaptation. |
| IKC_L_ARM | |
| IKC_R_HAND | |
| IKC_L_LEG | |
| IKC_R_LEG | |
| IKC_L_FOOT | |
| IKC_R_FOOT | |

### LOD

This system handles varying level-of-detail in multiple ways:

Timeslicing—supporting the processing of the system to be paused for some entities over some frames

High Precision and Standard Precision bounds—Ensuring that we can general low-precision constraints from high precision ones

Removal of less-visible constraints—Although each Constraint tag can hint at it's LOD range, the ultimate decision is up to the runtime code. Fingers and small body parts can be removed at relatively high levels of detail as they are small enough to go unnoticed

This document will now elaborate on all three ways

### Timeslicing

Timeslicing is a technique to reduce the update frequency of some entities in the game for performance reasons. It has potential implications since: 1) skipped frames increase the duration of the timestep between consecutive updates of an entity; and 2) other entities might rely on some operations to be performed during the skipped updates of a timesliced entity. Constraints support timeslicing at least by their processing being primarily non-stateful (e.g., being non-stateful aside from ease-in and ease-out). If the motiontree is not processed for a frame, the constraints themselves are typically not generated, and therefore not operated on. The next frame the motiontree is typically processed with constraints being generated, and the pose being updated as usual. As there is typically no explicit dependency on the previous frame for the constraints, we can pop the pose non-physically if required (e.g., popping the pose non-physically if the motion update rate is at 1 Hz or lower).

One potential complexity of timeslicing is dealing with cyclic constraints (e.g., a constraint that depends on the pose of a part, that depends on the pose of part of the body chain that the constraint is operating on). When this happens, if one entity in a cyclic constraint is timesliced for a frame (e.g., has its motiontree update blocked) and another is not, then we can:
Generate the cyclic constraint for the timesliced entity and then throw it away, as we will typically be unable to perform any retargeting this frame; or
Force all (or most of) the entities in the same interaction island to be timesliced or updated on the same frames as each other.

Our system has support for both, but in general option “2” is the better approach.

### High Precision and Standard Precision Bounds

Each entity typically has two bound sets, a high precision set and a lower “standard” precision set. Generating fewer constraints on the lower precision bound set is typically cheaper both in memory cost and in runtime CPU cost. However, for detailed interaction it is generally preferable to interact with the high precision bound set.

To handle lower levels of detail, a given constraint typically specifies a LOD range for which it is to be used. Animators can manually make cheaper constraints at lower LODs using these two bound sets. However, doing so can potentially be time intensive, and/or can result in mistakes and/or missed data.

Instead, our system can use heuristics on marked-up low-precision-bound-referencing constraints to automatically generate high precision constraints from the low precision ones. In particular, distance-based heuristics can be used. Here, for a given frame we take the closest high precision bound, and replace the standard precision references with the high precision ones. We can also replace the LOD markup to note that this is high LOD only. We then split the constraint if the high-precision bound differs from the previous frame's closest high-precision bound. In this way, we get a new set of constraints that typically only run in high LOD, and that target the high precision bounds.

This can yield benefits including being quicker to author, as there are fewer low-precision constraints versus the high precision ones, and therefore fewer constraints are to be marked up by the animators.

### Removal of Less Visible Constraints

Some parts of the body can be smaller and less visible than others. For example, a constraint on the spine is more likely to be seen at 100 meters camera distance than a constraint on the little finger. Accordingly, a LODing strategy that prevents processing of constraints that are not highly visible can help runtime performance without sacrificing visual fidelity.

As such, we by establish a list of body parts that are not to be processed at lower LODs. An example mapping is:

| Body Chain | Disabled at LOD |
|---|---|
| Finger* | LOD3-SLOD |
| Toe* | LOD3-SLOD |
| ForeArm* | SLOD |
| UpperArm | SLOD |

### Measuring Success of Constraints

In general, the retargeting system can handle four types of constraints:
Position
Orientation
Aim
Limb Length

Now described will be how the constraints error is computed for each constraint type. Moreover, we elaborate on the error measurements of sub types such as region constraints and the additives.

### Position Constraint Error

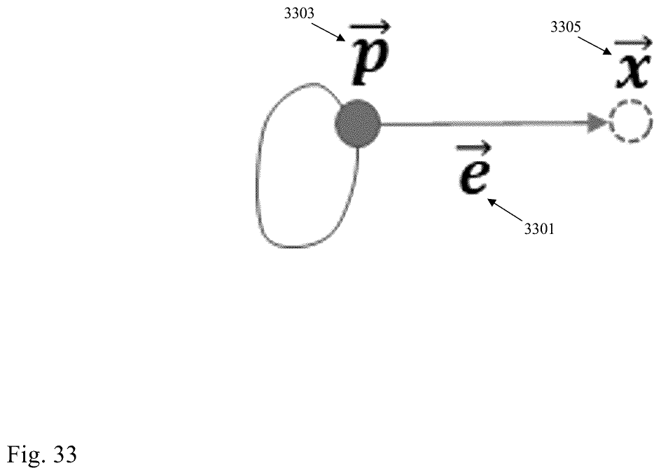

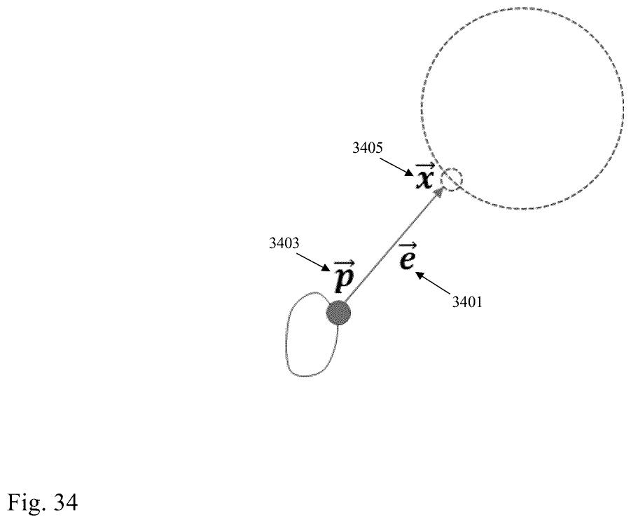

The goal of a position constraint is to bring its end effector onto its target position. Therefore, the error for a position constraint is measured through the vector connecting the end effector's position and the goal. This is illustrated in FIG. 33. The error, e 3301, is the vector connecting the end effector position, p 3303, and its goal position, x 3305.

Where the goal is expressed as a region constraint, the error is the vector connecting the end effector position to the closest valid point on the target region. If the end effector is already in the valid region, the error is a zero vector. FIG. 34 depicts error for a position region constraint. The valid region is depicted as the dashed circle. The error, e 3401, is the vector connecting the end effector position, p 3403, to the closest point on the valid region, x 3405.

For the circumstance of additive position constraints, instead of an explicit goal position, an offset vector is used as the constraints goal. The deviation between that desired offset vector and the final offset applied to the end effector is used to measure the additive error.

### Orientation Constraint Error

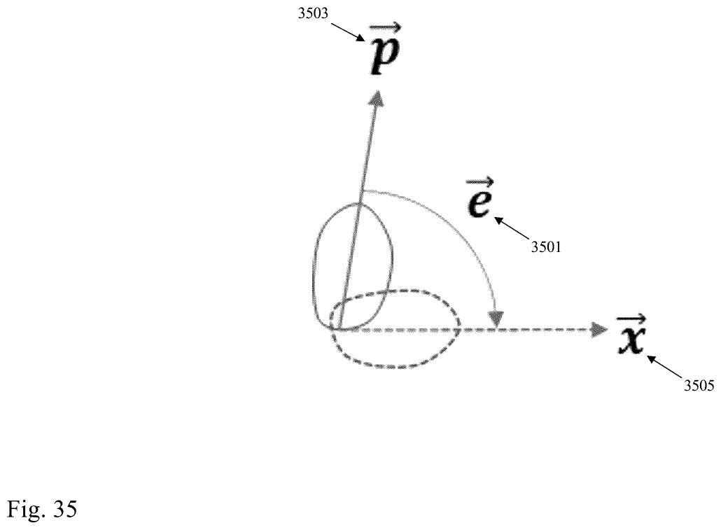

An orientation constraint is resolved when the end effector orientation is aligned with its target. Hence, the error is measured from the angular deviation between the end effector and its target. This deviation can be expressed in any orientation form, such as quaternions. FIG. 35 illustrates this. FIG. 35 depicts error for an orientation constraint. The error, e 3501, is the angular deviation between the end effector orientation, p 3503, and its goal, x 3505.

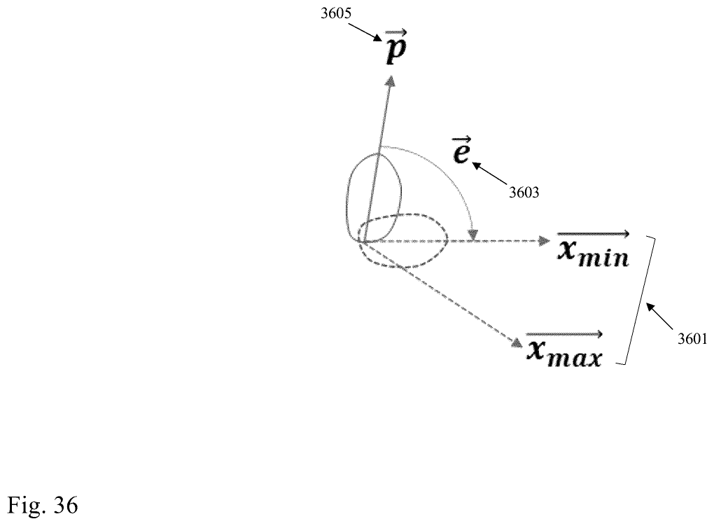

An orientation goal can be expressed as a range with minimum and maximum allowed orientations. In this case, the error is the deviation between the end effector and the closest value in the valid orientation region. This is expressed in FIG. 36. If the end effector is already in the valid region, the error is a zero rotation. FIG. 36 depicts error for an orientation region constraint. The valid region is depicted by the dashed [x_min, x_max] range 3601. The error, e 3603, is the angular deviation between the end effector orientation, p 3605, and the closest orientation on the valid region- x_min in this case.

In case of additive orientation constraints, instead of an explicit goal orientation, an offset orientation can be used as the constraints goal. The angular deviation between that desired offset orientation and the final orientation offset applied to the end effector is used to measure the additive error.

### Aim Constraint Error

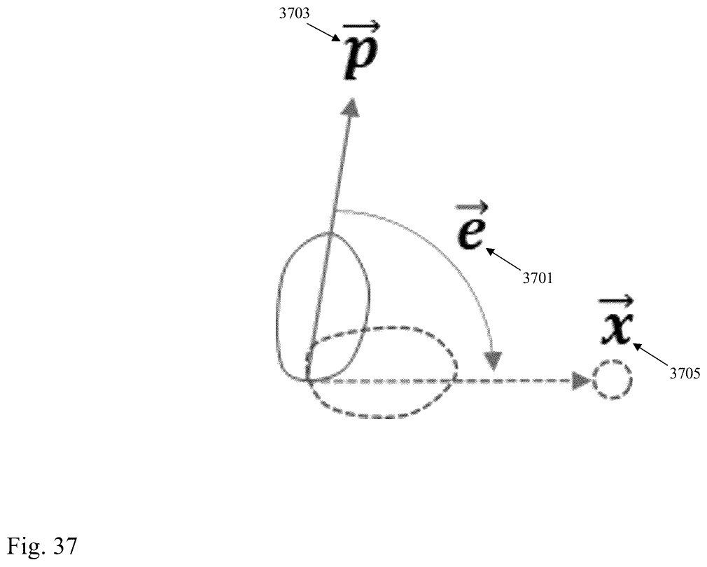

Aim constraint error is measured similarly to orientation constraint. However, in this case the angular deviation is measured with respect to the end effector's aim axis and the vector which connects the aim axis' origin and the target position. FIG. 37 illustrates this. The error, e 3701, is the angular deviation between the end effector aim axis, p 3703, and the vector which connects the aim axis' origin and the target to aim at, x 3705.

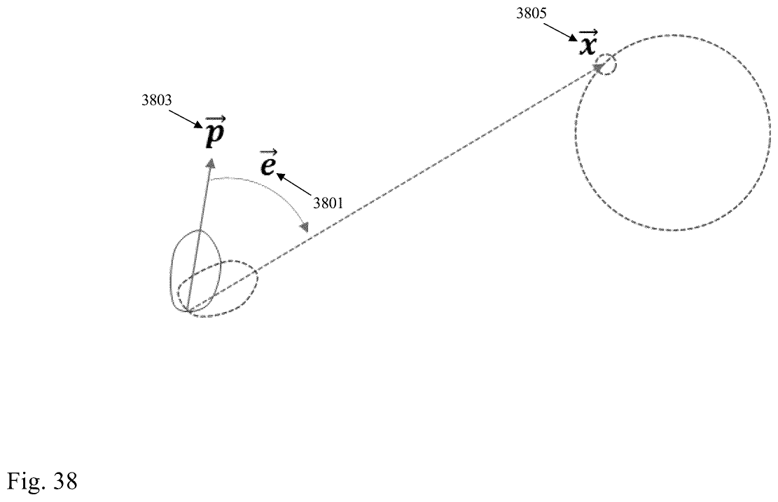

An aim goal can also be expressed as a valid region where aiming at any point in the valid region can be sufficient for the satisfaction of this constraint. As such, we measure the error as the deviation between the end effector aim axis and the vector connecting the aim axis' origin to the closest point on the region. This is expressed in FIG. 38. FIG. 38 depicts error for an aim region constraint. The valid region is depicted as the dashed circle. The error, e 3801, is the angular deviation between the aim axis, p 3803, and the vector connecting the origin of the aim axis and the closest point on the valid region, x 3805.

### Limb Length Constraint Error

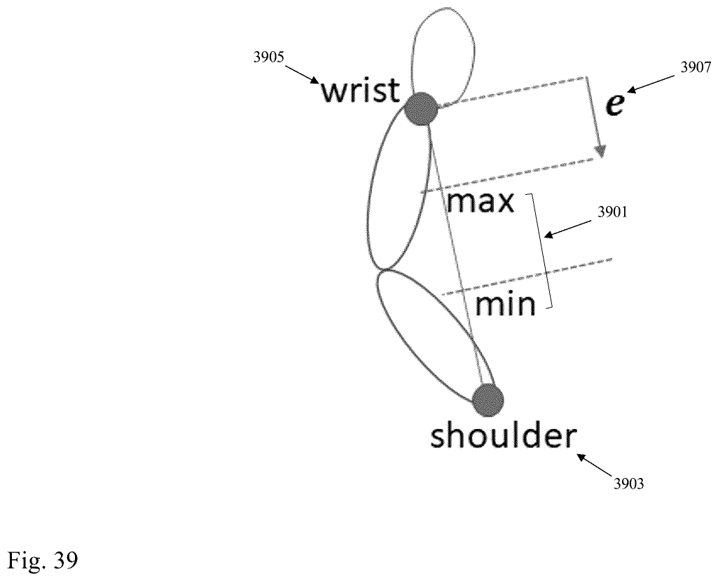

Limb length constraints can define a valid [min, max] interval for the pose of the corresponding limb to abide by. As such, the error is measured by the distance between the current limb length and the closest valid limb length value within the interval. FIG. 39 illustrates this. If the limb length is already within that interval, the error value is zero. With reference to the example of FIG. 39, it is noted that the length of the limb is given by the distance between the shoulder and the wrist for the arms, and the hip and the ankle for the legs.

As such, FIG. 39 depicts error for a limb length constraint error on an arm. The desired limb length is expressed as a [min, max] range 3901 of allowed distances to preserve between the shoulder 3903 and the wrist 3905 (or between the hip and the ankle for a leg). Error is the signed scalar which is the variation, e 3907, between the current limb length and the closest valid distance value.

### Use of Constraints Error Offsets for Non-Rigid Deformation

Constraint error values can be useful to determining the success state of the constraints. They can be used for constraint arbitration purposes when adapting skeletal section poses, as a given solver working on a skeletal section effectively tries to reduce the error values in order to satisfy the success criteria of the constraints. However, under various circumstances, the satisfaction of some constraints may not be possible with skeletal pose deformation techniques. For example, such a circumstance can be encountered in the case of conflicting constraints, or where the desired constraint goals cannot be achieved due to biomechanical limits. The constraints priorities help as a tool to arbitrate the pose deformation so as to decide on the constraints to compromise. However, artistic decision can also be taken into account to make pose adaptations through non-skeletal deformation. This can be desired, for example, to deal with things such as hair, clothes (e.g., wearable clothes like hats) and non-rigid surfaces that characters interact with but which do not necessarily follow any skeletal deformation rigidly. As an illustration, when a character sits on a car seat the pose of the character can be adjusted to adapt to the interaction. But, at the same time, the surface of the seat can also deform. As another illustration, a big, puffy hat worn by a character might not fit into the car under the circumstance where only skeletal deformation applied to that character. Here, the deformation can be applied to the hat itself to compress its volume to fit.

These relationships can be expressed with retargeting constraints that make use of interaction bounds that represent the volumes. For example, the retargeting system can evaluate the relationships of deformable objects, measure the corresponding constraint errors, and provide those error offsets as an input to scripts (e.g., scripts written by the TechArt team (or other team) responsible for the adaptation of these volumes through non-rigid deformation). In this way, these volumes are adjusted based on the desired offsets decided by the retargeting constraints.

### Testing and QA

Given the large variety in situation and dynamic adjustment of pose to the other entities in game, improved approaches for ensuring the quality of produced motion can be beneficial.

As such, according to various embodiments a Generative Body Type GameTest system is provided. This system can run a given interaction across one or more of the various body types and sizes in the game (e.g., across all the various body types and sizes in the game). The system can run in parallel or sequentially, and can show the interaction playing back with the different parameters one can see in the final game.

As noted above, AnimScenes are in some ways parallel to Clip Environment files, but are run in the game. As also noted above, an AnimScene can provide a single timeline for animations and other events that are shared across multiple entities. The functionality of the Generative Body Type GameTest system can include creating an AnimScene of the basic interaction. Once that interaction has been marked up, a GameTest can be created that references the AnimScene and that notes which entity is going to vary. A subset of the variation in that entity can be defined, or the full range of variation including: a) body shape (e.g., muscular, large, or pear shaped); b) size (e.g., 85%, 100%, or 120%); and c) base model (e.g. male, female, or child) can be stated.

The GameTest system can subsequently generate one or more tests for one or more configurations (e.g., a separate test for each configuration). Further, the GameTest system can (e.g., by default) sequentially play them back to back. Such sequential playing can, as just an example, allow for manual user validation of the situation. This can yield benefits including permitting the GameTest to be created once, and then pointed to different AnimScenes in order to test a variety of interactions in the breadth of situations under which the interaction is expected to perform well.

Analogous functionality can also be used in connection with props. In particular, the prop metadata can constrain a string denoting the archetype the prop was derived from, and therefore the class of interaction of that prop. Various props inside that same class (e.g., all props inside that same class) can be interchangeable, in that they have the same named bounds with the same meanings. The grouping of interchangeable assets becomes a trivial task thanks to interaction bounds archetypes as introduced above. Also, by including a Generative Prop Variation action in the gametest system, we can similarly replay given interaction with one or more variations of the prop (e.g., with all variations of the prop) in the AnimScene without, for example, manual work (e.g., significant manual work) by the QA or animation teams. Automation and machine learning techniques can be used to assess the test results and flag the potential failure cases to the user. In this way, manual intervention can be minimized in the QA procedures.

### Example Applications of Runtime Retargeting

The runtime retargeting approaches discussed herein can be used where there is a desire to apply a motion to a set of circumstances that differs from the set of circumstances under which the motion was established (e.g., via motion capture). As just some examples, the difference in circumstances can involve one or more of: a) variation in character; b) variation in environment; and c) variation in situation.

Variation in character can include a game character differing in body proportions from the body proportions in connection with which a motion was established (e.g., differing in body proportions from an actor whose motions were captured). The body proportion differences can include differences in bone length and in skeleton hierarchy (e.g., certain bones can be parented differently and/or missing from certain characters). Variation in environment can include a game environment differing (e.g., in terrain and/or world geometry) from the environment in connection with which a motion was established. For instance, the game environment can differ in terrain from the terrain where motions of an actor were captured. Variation in situation can include a game situation differing from the situation in connection with which a motion was established. Here, entities interacted with—including props, vehicles, and/or other characters—can vary in proportion, overall size, skeleton hierarchy, and/or relative location, as just some examples. Further as to variation in situation, there can be runtime manipulation of animation data (e.g., secondary motion and/or physics collisions can occur). As an illustration, variation in situation can involve a game situation where a character interacts with a different prop than the prop that was used by an actor when motion capture was performed.

Where these differences in circumstances are not addressed via the runtime retargeting approaches discussed herein, various visual imperfections can arise. As one example, such visual imperfections can include flawed hand contact between a game character and their environment. As another example, such visual imperfections can include intersections between a game character and their environment (e.g., where legs of a character appear to pass through a stone floor). As a further example, such visual imperfections can include hyperextended character limbs (e.g., where a character is no longer able to reach far enough to interact with a given prop without hyperextension). As an additional example, such visual imperfections can include character sliding (e.g., where a character slides around during an interaction with a given prop).

It is noted that application of the runtime retargeting approaches discussed herein can avoid, for instance, call for multiple instances of a given motion to be established (e.g., captured), so as to have an instance for each unique situation (e.g., including two instances of entering a vehicle- one for entering a limousine and one for entering a Baja bug). Various aspects of applying the runtime retargeting approaches discussed herein to variation in character, variation in environment, and variation in situation will now be discussed in greater detail. The retargeting discussed herein can address variation in character dynamically at game runtime. In this way, various benefits can be realised. For instance, on one hand actions and/or decisions made by a player can affect the appearance of a character and can allow for robust interaction. On the other hand, visual artefacts (e.g., floating contacts or clipping can be avoided.

For example, a game scenario in which a character eats an excess of food can make the character more rotund and can increase the size of the waist of the character. Continuing with the example, application of the runtime retargeting discussed herein can prevent hands of the character from penetrating through the character when a running animation that passes the hands near the character waist is applied. As another example, continuous variation in character waist size can be readily achieved using the runtime retargeting discussed herein. In contrast, such character variation can fail to be satisfactorily achieved when using existing approaches such as establishing multiple instances of an at-hand given motion. For instance, such multiple instances are unlikely to blend well, and additional main memory can be taken up by the multiple instances. Furthermore, the waist variation typically affects not only character locomotion, but also those animations that interact with the waist and/or pass near to the waist. As such, a gameplay decision of having the waist size of a character vary because of the amount of food that they eat can result in a cascade of effects when existing approaches (e.g., establishing multiple instances of an at-hand given motion) are used. For example, according to the existing approach of establishing multiple motion instances, a combinatorial multitude of additional animation instances can be required (e.g., at least one additional animation for each system interacting with the waist). As such, the use of the runtime retargeting approaches discussed herein can avoid the combinatorial problem that arises from each mechanic that changes some body proportion and/or size.

Also concerning variation in character, it is noted that existing approaches can involve intensive artist labour. For example, such existing approaches can be performed in a DCC (e.g., when a motion captured actor varies from the virtual character the animation is to be applied to). Here, an artist using this conventional DCC approach can suffer a tedious process of mapping bones from the motion captured actor skeleton to the virtual character, with some context applied to certain bones. In contrast, according to the runtime retargeting approaches discussed herein this tedium can be avoided. Further examples of using runtime retargeting to address variation in character will now be discussed.

Variation in character can include variation in size of single character. Here, as just some examples, height, build, and proportion can vary. Turning to variation in height, when conventional approaches are used visual imperfections including a) arm hyperextension when shorter characters reach for props in the environment; and b) larger characters not being able to fit into small spaces (e.g., inside a vehicle) can occur. Turning to variation in build, when conventional approaches are used character arms can be prevented from intersecting with the torso. Then, turning to variation in proportion, when conventional approaches are used it can be difficult for shorter-armed characters to maintain contact with props, vehicles, and/or other characters (e.g., with vehicle controls such as steering wheels and/or handlebars). In contrast, these visual imperfections can be prevented through use of the runtime retargeting approaches discussed herein.

Variation in character can also include male/female variation. In general, the proportions of adult men and women can vary significantly. As such, as just an illustration, having an animation authored on a male skeleton used on a female skeleton (or vice versa) can cause penetrations and/or mismatched contacts. As another illustration, having an animation authored on a male skeleton used on a female skeleton (or vice versa) can involve applying an animation authored on a longer-armed character to a shorter-armed character. Here, visual imperfections including those regarding arm crossing, face touching, and touching of hands together can occur when conventional approaches are used. Similar issues can occur where: a) an animation authored on an adolescent skeleton is used on an adult skeleton (or vice versa); b) where an animation authored on a human skeleton is used on a humanoid alien or fantasy creature skeleton (or vice versa); and c) where an animation authored on the skeleton of a less physically fit character is used on the skeleton of a more physically fit character (or vice versa). Such a situation can also arise where in-game gym use changes the physical fitness of a character. In contrast, the use of run time retargeting (e.g., to mark up contacts and avoidance areas) can prevent the aforementioned problems.

Variation in character can further include player-driven character customisation and/or creation, both in multiplayer and in single player modes. Here the use of run time retargeting can, compared to conventional approaches, allow for character proportions to vary more widely both when a character interacts with itself, and with other entities. Further, the use of run time retargeting can, compared to conventional approaches, more effectively allow for continuous variation of attributes.

Further still, variation in character can involve dynamic outfits. As just some examples, such dynamic outfits can regard hats, bulky clothing, and/or high heels. Turning to hats, in, for example, complex open-world games with a large variety of interactions, actions regarding a hat and/or a character head (e.g., touching the brim of a hat, or other interactions involving the head such as ducking down to enter a vehicle) are likely to require headwear-based adjustment in order to avoid prevent visual imperfections. However, conventional approaches are unable to satisfactorily make such adjustments. In contrast, these adjustments can be achieved using the runtime retargeting approaches discussed herein.

Turning to bulky clothing, variation in clothing size (e.g., involving larger clothing) can lead to visual imperfections including clipping that occurs in connection with self-interactions (e.g., a character patting its own belly) and/or interactions of a character with other characters (e.g., a hug between two characters). The use of the runtime retargeting discussed herein can prevent such problems (e.g., clipping). Turning to high heels, outfit variations such as the addition of high heels to a character can increase the height of the character (e.g., by 10 cm in extreme cases). As a result, various visual imperfections can occur. One such example visual imperfection regards contact issues in animations. Here, a character body can make contact with external objects. However, through the use of the runtime retargeting discussed herein, such visual imperfections can be prevented. Another such example visual imperfection regards a character reaching for a door handle, where the hand can be offset from the handle by the heel height. Here also, the use of the runtime retargeting can prevent the visual imperfection.

An additional example high heel-based visual imperfection can involve the case of a player character getting onto a motorbike, where the legs and bottom of the character are to sit on the motorbike, but will float up by the heel height. Conventional approaches such as simply moving the character down again by the heel height can fail to address the visual imperfection, such conventional approaches instead causing penetration between the foot pegs and the heels. However, a more complex markup of relationship as provided by the runtime retargeting discussed herein can successfully prevent the visual imperfection. A further example high heel-based visual imperfection can involve a cutscene that allows for dynamic player outfits and that further allows for a variety of interactions, such as one character hugging another where one or both characters may or may not wear heels. Under this circumstance the runtime retargeting discussed herein can prevent visual imperfection while conventional approaches can fail. Another example high heel-based visual imperfection can involve a character getting up from having been seated on the floor. Such a situation can introduce many compilations, such as: a) the heel height varying as the distribution of support for the weight of the character varies; and b) the call to preserve backside contact to the ground at appropriate times alongside the heel penetration to the ground. Here also conventional approaches can fail to prevent resultant visual imperfections, but such visual imperfections can be prevented via application of the runtime retargeting approaches discussed herein.

The runtime retargeting discussed herein can also address variation in environment. For example, variation in environment can occur where terrain varies. As a specific example, variation in environment can occur where motion is established (e.g., captured) on a flat surface but played on a slope. Under this circumstance, there can be call to make various choices, such as whether to orient a character to the surface, or to counter-animate parts of the character so that they remain upright in world space. The runtime retargeting approaches discussed herein can be used to make these choices.

It is noted that interaction down a slope can result in a character having to interact (e.g., reach to interact with a prop) in a further away fashion, relative to the character interacting up the slope. Application of the runtime retargeting approaches discussed herein can prevent visual imperfections that arise under the circumstance of variation in environment (e.g., where a reaching motion is captured on a flat surface and subsequently applied so as to have a character reach uphill). Also, reuse of an animation across planar slopes can lead to visual imperfections when conventional approaches are used But, such visual imperfections can be avoided by us of the runtime retargeting approaches discussed herein.

The environment where a motion is played can also be more complex than slopes. As just some examples, steps, railings, rocks, and buildings (e.g., restaurants) are environments where an animation can take place. And, where a motion to be played in such an environment differs from the environment where the motion was established, there can be call to perform adaptation in order for the motion to look natural (e.g., without visual imperfections) in the environment where it is played. The runtime retargeting approaches discussed herein can be used to perform such adaptation. Further examples of using runtime retargeting to address variation in environment will now be discussed.

Variation in environment can relate to inconsistent set dimensions (e.g., where sets are not built to meet standardized sizing). As an example, where tables, shelves, and worktops not built to set standards, props placed thereon can be at varying heights from location to location, leading to visual imperfections. As another example, props can be placed inconsistently for the sake of variety (e.g., telephones placed inconsistently on an office desk). Where set dimensions are inconsistent, such inconsistent placement can result in visual imperfections. As a further example, various apartment activities (e.g., as drinking, using a TV remote, and/or using a radio) can result in visual imperfections (e.g., hands not contacting properly) where set dimensions are inconsistent. The noted issues can be resolved through use of the runtime retargeting approaches discussed herein.

Variation in environment can also relate to seating motion scenarios (e.g., an animation of a character sitting down in a chair), such as where a seating motion is to be played with respect to different seats than a seat with respect to which the motion was established (e.g., captured). As an illustration, a seating motion captured with regard to a particular seat can be played with respect to various seats of dining booths a restaurant. Where conventional approaches are used, adaptation of a seating motion can result in visual imperfections. However, such visual imperfections can be prevented through use of the runtime retargeting approaches discussed herein.

Additional examples of variation in environment in which a motion can be played in a different environment than the environment in which it was established can include: a) a walking animation adjusted to step up onto a street kerb; b) a crawling animation adjusted to play back when moving on undulating terrain; c) an interaction animation between two characters adjusted to be played back on a slope (e.g., where an animal skinning animation is adjusted to be played back on sloped surfaces, the runtime retargeting approaches discussed herein can be used in order to maintain contact between a human and an animal, as well to preserve a perception of balance); d) a falling animation adjusted to be played back on an at-hand terrain (e.g., where the animation is to conform a pose to the terrain, but ragdoll/physics-based adjustments cannot be used); e) a recovery from a ragdoll “get-up” scenario where an animation is to be adjusted to an arbitrary environment where a ragdoll appeared; f) a weapon pickup animation adjusted to be played back on an at-hand terrain (e.g., a weapon prop that falls onto a rock can be in an arbitrary orientation and/or at an arbitrary height); g) a cowering animation (e.g., involving hands, bottom, and/or feet interacting with the ground) adjusted to be played back on a sloped, rocky, stepped, and/or confined terrain; h) a quadruped or other non-bipedal interaction animation with the ground adjusted to be played back on an at-hand terrain; i) a leaning on railing animation adjusted to be played back on railings of different heights and/or depths; j) a jumping through a window animation adjusted to be played back for windows of different heights, sizes, and/or shapes; k) a wall climbing or mantling animation adjusted to be played back on an at-hand wall; 1) a ladder interaction (e.g., climbing interaction) animation adjusted to be played back for ladders of different rung separations and/or widths; m) a door interaction (e.g., a door opening interaction) animation adjusted to be played back for doors open at arbitrary angles; and n) a melee interaction animation that involves the environment (e.g., a throwing a character through a window interaction, or a knocking a character out (“KO”) interaction using a car door) adjusted to be played back for an at-hand environment. Where conventional approaches are used, adjustments of such animations can result in visual imperfections. But, such visual imperfections can be prevented through use of the runtime retargeting approaches discussed herein.

Further still, the runtime retargeting discussed herein can address variation in situation dynamically at game runtime. Variation in situation can result in there being a diverse set of properties to adjust (e.g., as the situation in games can vary dynamically). For example, variation in situation can occur in open-world games for a cutscene, where an employed prop or weapon differs from a prop or weapon that was originally animated. As another example, variation in situation can occur in open-world games where a vehicle that is entered differs from a vehicle that was originally animated (e.g., entering a sports car, where the original animation was of entering a coupe). As further examples, variation in situation can involve dynamically manipulating pose in multiple ways, including: a) combinations of multiple animations that can be partial, full body, and/or additive; b) physics collisions with other entities in the world; c) inaccuracies in alignment to target locations; and d) secondary motion on characters (e.g., hair, clothing, and/or body parts being adjusted based on momentum). The runtime retargeting approaches discussed herein can be used to make these adjustments. Further examples of using runtime retargeting to address variation in situation will now be discussed.

Using runtime retargeting to address variation in situation can involve avoiding repetition. For instance, posture can be adjusted at runtime to avoid repetition when several characters are placed next to each other performing similar activities. Variation in situation can also relate to using different weapon types with the same animation set. As an illustration, where there is a variety of pistols with differing handles and sights, use of the runtime retargeting approaches discussed herein can allow for motion adjustment to be made so that the noted weapon type variety does not result in visual imperfections such as penetration. Adjusted motions regarding pistols with differing handles and sights can include: a) holstering; b) reloading; c) motions involving two-handed weapons; d) pickups; and e) swapping. More generally, the runtime retargeting can be used to adjust motion under various circumstances involving weapon interactions where size and/or shape variety in weapons is to be addressed.

The runtime retargeting approaches discussed herein can also be applied to variation in situation where head-relative prop interaction animations (e.g., smoking or using a mobile phone) are to be adjusted. The runtime retargeting approaches discussed herein can additionally be applied to variation in situation where vehicle hijacking animations are to be adjusted (e.g., where vehicles are of different classes and/or styles). It is noted that hijacking animation adjustment can be difficult due to factors including: a) tight interior locations where a motion to be adjusted is highly constrained by the locations of seats and controls in the vehicle; and b) variations in floor height, roof height, distance from seat to door, distance from seat to ground, and/or window position, all of which can affect animations including smash window animations. Despite these difficulties, the runtime retargeting approaches discussed herein can nevertheless avoid the emergence of visual imperfections.

As a further example, runtime retargeting can be applied to adjust an animation to contend with variation in situation where a prop that can vary is subject to a handover between characters (e.g., passing a weapon between characters). As another example runtime retargeting can be applied to adjust an animation to contend with variation in situation where a character is to pick up a motorcycle after it has fallen over. As an additional example, runtime retargeting can be applied to adjust an animation to address variation in situation regarding inconsistencies in placement and/or type of vehicle controls. As just some illustrations, such inconsistencies in vehicle control placement and/or type can regard the radio, the rear-view mirror, the stick shift, the hand brake, the foot pedals, the light switches, the door handles, the door hinges and the foot pegs. Also in this regard, it is noted that hyperextension of character arms during tight turns can be avoided via application of runtime retargeting approaches discussed herein.

As yet another example, runtime retargeting can be applied to adjust an animation to address variation in situation regarding loss of alignment (e.g., where a car is knocked out of alignment at an interaction, such as where the car is crashed into by another vehicle whilst being entered by a character). As a further example, runtime retargeting can be applied to adjust an animation to contend with variation in situation with regard to animal hunting interactions. As an illustration, skinning different sizes of deer can involve adjusting hand positions, feet positions (e.g., for step over), and/or picking up of different sized deer. Under these circumstances, runtime retargeting can be applied to adjust an animation with regard to the relative orientation and pose between the player and the deer (e.g., so that the player can smoothly enter the interaction). As another illustration, placing a dead animal on a horse can be a complex interaction. For instance, this interaction can involve variation in: a) horse body shape and/or size; b) character body shape and/or size; c) character outfit (e.g., heels), d) slain animal body shape and/or size; and/or e) shape and/or size of any additional cargo already on the horse. Here the runtime retargeting approaches discussed herein can be used to address the noted factors so as to avoid visual imperfections (e.g., clipping and/or other visual imperfections arising from the ground underneath the horse varying, such as where the horse stands upslope or downslope or in mud), and to make the interaction look natural.

### Hardware and Software

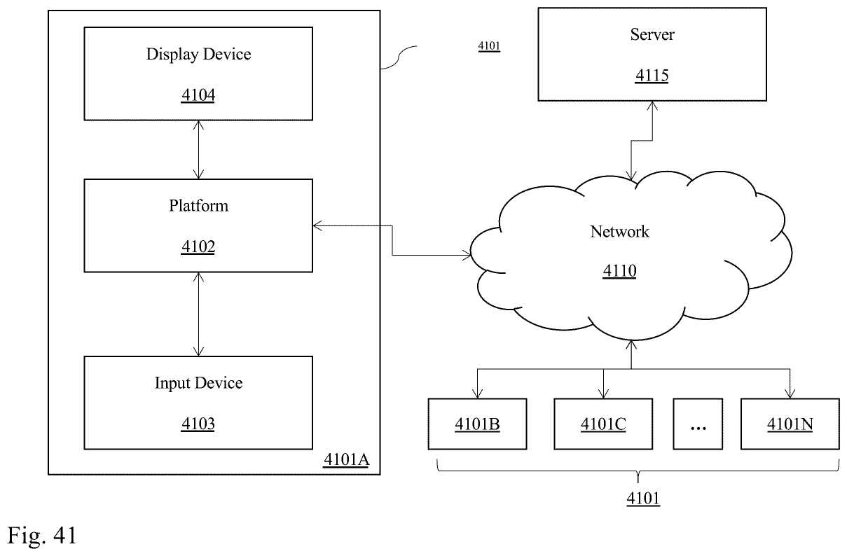

According to various embodiments, various functionality discussed herein can be performed by and/or with the help of one or more computers. Such a computer can be and/or incorporate, as just some examples, a personal computer, a server, a smartphone, a system-on-a-chip, and/or a microcontroller. Such a computer can, in various embodiments, run Linux, MacOS, Windows, or another operating system. Such a computer can also be and/or incorporate one or more processors operatively connected to one or more memory or storage units, wherein the memory or storage may contain data, algorithms, and/or program code, and the processor or processors may execute the program code and/or manipulate the program code, data, and/or algorithms. Shown in FIG. 41 is an example computer system employable in various embodiments of the present invention.

Turning to FIG. 41, the runtime retargeting system can be implemented between a network 4110 (e.g., cloud) comprising a server 4115 (e.g., a single server machine, multiple server machines, and/or a content delivery network) communicating with a plurality of player consoles 4101 (shown as any number of player consoles 4101A-4101N). A player console 4101 can be any system with a processor, memory, capability to connect to the network, and capability of executing gaming software in accordance with the disclosed embodiments. A hardware and network implementation suitable for the disclosed system is described in greater detail in commonly assigned U.S. Pat. No. 9,901,831, entitled “System and Method for Network Gaming Architecture,” incorporated herein by reference.

The player console 4101A is shown in further detail for illustration purposes only. As shown, the player console 4101 can include any number of platforms 4102 in communication with an input device 4103. For example, the platform 4102 can represent any biometrics, motion picture, video game, medical application, or multimedia platform as desired. According to one embodiment disclosed herein, the platform 4102 is a gaming platform for running game software and various components in signal communication with the gaming platform 4102, such as a dedicated game console including an XBOX One® manufactured by Microsoft Corp., PLAYSTATION 5® manufactured by Sony Corporation, and/or Switch® manufactured by Nintendo Corp. In other embodiments, the platform 4102 can also be a personal computer, laptop, tablet computer, or a handheld mobile device. One or more players can use a gaming platform to participate in a game. Multiple gaming platforms may be linked together locally (e.g., via a LAN connection), or via the network 4110 (e.g., the Internet or other communication networks).

The network 4110 can also include any number of wired data networks and/or any conventional wireless communication network, for example, radio, Wireless Fidelity (Wi-Fi), cellular, satellite, and broadcasting networks. Exemplary suitable wireless communication technologies used with the network 4110 include, but are not limited to, Global System for Mobile Communications (GSM), General Packet Radio Service (GPRS), Code Division Multiple Access (CDMA), Wideband CDMA (W-CDMA), CDMA2000, IMT Single Carrier, Enhanced Data Rates for GSM Evolution (EDGE), Long-Term Evolution (LTE), LTE Advanced, Time-Division LTE (TD-LTE), High Performance Radio Local Area Network (HiperLAN), High Performance Radio Wide Area Network (HiperWAN), High Performance Radio Metropolitan Area Network (HiperMAN), Local Multipoint Distribution Service (LMDS), Worldwide Interoperability for Microwave Access (WiMAX), ZigBee, Bluetooth, Flash Orthogonal Frequency-Division Multiplexing (Flash-OFDM), High Capacity Spatial Division Multiple Access (HC-SDMA), iBurst, Universal Mobile Telecommunications System (UMTS), UMTS Time-Division Duplexing (UMTS-TDD), Evolved High Speed Packet Access (HSPA+), Time Division Synchronous Code Division Multiple Access (TD-SCDMA), Evolution-Data Optimized (EV-DO), Digital Enhanced Cordless Telecommunications (DECT) and others.

The platform 4102 typically is electrically coupled to a display device 404. For example, the display device 4104 can be an output device for presentation of information from the platform 4102 and includes a television, a computer monitor, a head-mounted display, a broadcast reference monitor, a medical monitor, the screen on a tablet or mobile device, and so on. In some embodiments, the platform 4102 and/or the display device 4104 is in communication with an audio system (not shown) for presenting audible information.

In FIG. 41, the platform 4102 also is electrically or wirelessly coupled to one or more controllers or input devices, such as an input device 4103. In some embodiments, the input device 4103 is a game controller and includes keyboards, mice, gamepads, joysticks, directional pads, analog sticks, touch screens, and special purpose devices (e.g., steering wheels for driving games and/or light guns for shooting games). Additionally and/or alternatively, the input device 4103 includes an interactive-motion-tracking system, such the Microsoft Xbox One KINECT® device or the Sony PlayStation® 4 (or 5) Camera, for tracking the movements of a player within a 3-dimensional physical space. The input device 4103 provides data signals to the platform 4102, which processes the data and translates the player's movements on the display device 4104. The platform 4102 can also perform various calculations or operations on inputs received by the sensor and instruct the display to provide a visual representation of the inputs received as well as effects resulting from subsequent operations and calculations.

In one embodiment, the platform 4102 can be connected via the network 4110 to the server 4115 that can host, for example, multiplayer games and multimedia information (e.g., scores, rankings, tournaments, and so on). Users can access the server 4115 when the platform 4102 is online via the network 4110. Reference herein to the platform 4102 can include gaming platforms executing video game software or game software (e.g., computer program products, tangibly embodied in a computer-readable storage medium). Additionally and/or alternatively, references to the platform 4102 can also include hardware only, or a combination of hardware and/or software. In some embodiments, the platform 4102 includes hardware and/or software, such as a central processing unit, one or more audio processors, one or more graphics processors, and one or more storage devices.

In some embodiments, a selected player console 4101A-N can execute a video game that includes animation of one or more virtual players in a virtual world and at least one non-player object (NPC). NPCs can include, for example, cars, boats, aircrafts, and other vehicles in the virtual world. The virtual world can include game spaces with these NPCs and player characters that are animated using the systems and methods described herein.

The described embodiments are susceptible to various modifications and alternative forms, and specific examples thereof have been shown by way of example in the drawings and are herein described in detail. It should be understood, however, that the described embodiments are not to be limited to the particular forms or methods disclosed, but to the contrary, the present disclosure is to cover all modifications, equivalents, and alternatives.

1. A computer-implemented method, comprising:
processing, by a computing system at runtime of a videogame, one or more animation constraints, wherein said animation constraints include one or more of position constraints, orientation constraints, aim constraints, or limb length constraints;
enforcing, by the computing system at the runtime of the video game, using a runtime constraints solver, said animation constraints; and
altering, by the computing system at the runtime of the video game, at least one base animation.

2. The computer-implemented method of claim 1, further comprising:
processing, by the computing system at the runtime of the video game, one or more alias entities.

3. The computer-implemented method of claim 1, further comprising:
processing, by the computing system at the runtime of the video game, one or more interaction bounds, wherein said interaction bounds comprise three-dimensional shapes attached to one or more skeletons.

4. The computer-implemented method of claim 1, wherein said skeletons include one or more of character, prop, vehicle, or map part skeletons.

5. The computer-implemented method of claim 1, wherein the animations constraints are expressed using a constraints language.

6. The computer-implemented method of claim 1, wherein the animations constraints comprise expressed spatio-temporal relationships between interacting entities and body parts.

7. The computer-implemented method of claim 1, wherein one or more of the animations constraints refer to one or more of the interaction bounds.

8. The computer-implemented method of claim 1, further comprising:
mapping, by the computing system at the runtime of the video game, using the interaction bounds, interactions between different entities of an archetype.

9. The computer-implemented method of claim 1, wherein the interaction bounds are based on primitive shapes.

10. The computer-implemented method of claim 1, further comprising:
updating, by the computing system at the runtime of the video game, using one or more of script inputs, skeleton pose inputs, or retargeting constraint inputs, one or more of the interaction bounds.

11. The computer-implemented method of claim 1, wherein said enforcing of said animation constraints using the runtime constraints solver further comprises:
executing, by the computing system at the runtime of the video game, at least one preparation step;
executing, by the computing system at the runtime of the video game, at least one priority layers solve step; and
executing, by the computing system at the runtime of the video game, at least one follow-up step.

12. The computer-implemented method of claim 1, wherein said enforcing of said animation constraints using the runtime constraints solver further comprises:
forming, by the computing system at the runtime of the video game, one or more interaction islands, wherein said one or more interaction islands involve sets of entities that are interdependent based on one or more of the animation constraints;
executing, by the computing system at the runtime of the video game, for a plurality of said entities, at least one simultaneous constraints solve operation; and
executing, by the computing system at the runtime of the video game, based on at least one outcome of said execution of said simultaneous constraints solve operations, one or more blend trees.

13. A system, comprising:
at least one processor; and
a memory storing instructions that, when executed by the at least one processor, cause the system to perform:
processing, at runtime of a videogame, one or more animation constraints, wherein said animation constraints include one or more of position constraints, orientation constraints, aim constraints, or limb length constraints;
enforcing, at the runtime of the video game, using a runtime constraints solver, said animation constraints; and
altering, at the runtime of the video game, at least one base animation.

14. The system of claim 13, further comprising:
processing, at the runtime of the video game, one or more alias entities.

15. The system of claim 13, further comprising:
processing, at the runtime of the video game, one or more interaction bounds, wherein said interaction bounds comprise three-dimensional shapes attached to one or more skeletons.

16. The system of claim 13, further comprising:
mapping, at the runtime of the video game, using the interaction bounds, interactions between different entities of an archetype.

17. The system of claim 13, further comprising:
updating, at the runtime of the video game, using one or more of script inputs, skeleton pose inputs, or retargeting constraint inputs, one or more of the interaction bounds.

18. The system of claim 13, wherein said enforcing of said animation constraints using the runtime constraints solver further comprises:
executing, at the runtime of the video game, at least one preparation step;
executing, at the runtime of the video game, at least one priority layers solve step; and
executing, at the runtime of the video game, at least one follow-up step.

19. The system of claim 13, wherein said enforcing of said animation constraints using the runtime constraints solver further comprises:
forming, at the runtime of the video game, one or more interaction islands, wherein said one or more interaction islands involve sets of entities that are interdependent based on one or more of the animation constraints;
executing, at the runtime of the video game, for a plurality of said entities, at least one simultaneous constraints solve operation; and
executing, at the runtime of the video game, based on at least one outcome of said execution of said simultaneous constraints solve operations, one or more blend trees.

20. A non-transitory computer-readable storage medium including instructions that, when executed by at least one processor of a computing system, cause the computing system to perform a method comprising:
processing, at runtime of a videogame, one or more animation constraints, wherein said animation constraints include one or more of position constraints, orientation constraints, aim constraints, or limb length constraints;
enforcing, at the runtime of the video game, using a runtime constraints solver, said animation constraints; and
altering, at the runtime of the video game, at least one base animation.

21. The non-transitory computer-readable storage medium of claim 20, wherein the instructions, when further executed by the at least one processor of the computing system, further cause the computing system to perform:
processing, at the runtime of the video game, one or more alias entities.

22. The non-transitory computer-readable storage medium of claim 20, wherein the instructions, when further executed by the at least one processor of the computing system, further cause the computing system to perform:
processing, at the runtime of the video game, one or more interaction bounds, wherein said interaction bounds comprise three-dimensional shapes attached to one or more skeletons.

23. The non-transitory computer-readable storage medium of claim 20, wherein the instructions, when further executed by the at least one processor of the computing system, further cause the computing system to perform:
mapping, at the runtime of the video game, using the interaction bounds, interactions between different entities of an archetype.

24. The non-transitory computer-readable storage medium of claim 20, wherein the instructions, when further executed by the at least one processor of the computing system, further cause the computing system to perform:
updating, at the runtime of the video game, using one or more of script inputs, skeleton pose inputs, or retargeting constraint inputs, one or more of the interaction bounds.

25. The non-transitory computer-readable storage medium of claim 20, wherein the instructions, when further executed by the at least one processor of the computing system, further cause the computing system to perform:
executing, at the runtime of the video game, at least one preparation step;
executing, at the runtime of the video game, at least one priority layers solve step; and
executing, at the runtime of the video game, at least one follow-up step.

26. The non-transitory computer-readable storage medium of claim 20, wherein the instructions, when further executed by the at least one processor of the computing system, further cause the computing system to perform:
forming, at the runtime of the video game, one or more interaction islands, wherein said one or more interaction islands involve sets of entities that are interdependent based on one or more of the animation constraints;
executing, at the runtime of the video game, for a plurality of said entities, at least one simultaneous constraints solve operation; and
executing, at the runtime of the video game, based on at least one outcome of said execution of said simultaneous constraints solve operations, one or more blend trees.
